(19) United States
(12) Patent Application Publication
(10) Pub. No.: US 2011/0053614 A1
(43) Pub. Date: Mar. 3, 2011

(54) POSITION INFORMATION SYSTEM

(75) Inventors: Yusuke Mishina, Tokyo (JP); Atsushi Konno, Tokyo (JP); Yutaka Shimogaki, Tokyo (JP)

(73) Assignee: HITACHI, LTD., Tokyo (JP)

(21) Appl. No.: 12/865,315

(22) PCT Filed: Mar. 3, 2009
(86) PCT No.: PCT/JP2009/053969

§ 371 Date: Nov. 16, 2010

(30) Foreign Application Priority Data
Mar. 7, 2008 (JP) 2008-057168

(51) Int. Cl. H04W 24/00; G01S 3/02

(52) U.S. Cl. 455/456.6; 342/451

(57) ABSTRACT

A positioning information transmitter transmits a positioning identifier instead of directly transmitting position information. A positioning information management server stores and manages the positioning identifier and the position information while correlating them with each other. In response to a position information request with a positioning identifier, the positioning information management server converts the positioning identifier into position information according to the aforementioned correlation. Furthermore, the positioning information management server updates the positioning identifier to be transmitted from the positioning information transmitter in a certain time by using predetermined means.

### INCORPORATION BY REFERENCE

The present application claims priority from Japanese Application JP2008-057168 filed on Mar. 7, 2008, the content of which is here by incorporated by reference into this application.

### TECHNICAL FIELD

The present invention relates to position information systems including an indoor positioning system complementing Global Positioning System (GPS). In particular, the present invention relates to the configuration and operation technique of an indoor positioning system comprising: a positioning information transmitter transmitting an IMES (Indoor Messaging System) signal which is a positioning signal for indoor positioning; a mobile communication terminal including a positioning and receiving function to receive the IMES signal and further including an application client function utilizing position information; a positioning information management server for managing a correlation between the IMES signal and the position information; and an application server including an application server function utilizing the position information.

### BACKGROUND ART

Among position measurement systems using radio waves, Global Positioning System (hereinafter, referred to as GPS) may be the most widely used system. GPS is a system, which measures positional relationship between GPS satellites and a receiver by utilizing GPS positioning signals transmitted from about 30 satellites traversing earth orbits and calculates the latitude, longitude, and altitude of a current site. Because the positioning signals from the satellites are used in GPS, there is a problem that the positioning in doors or in an underground space is impossible.

The Indoor Messaging System (IMES) using the IMES signal is a positioning system which has been devised to enable the positioning indoors. Although the IMES signal employs the same message structure as that of the satellite positioning signal, the IMES signal is characterized in that the position data of a transmitter installation place is used in place of satellite orbit data (navigation message). The positioning method relying on the IMES signal reception, unlike the ordinary GPS positioning method, is an extremely simple positioning method, in which a position can be identified just by demodulating and decoding a navigation message superposed on the IMES signal. According to this method, also in various types of terminals having the existing GPS receiver or GPS receiving function, the indoor positioning is possible with an extremely small modification. Because of this high compatibility with the satellite positioning, the indoor positioning system using the IMES signal is considered promising, and the research and development are being conducted in various places. Quasi-Zenith Satellite System User Interface Specification (IS-QZSS) Draft Ver. 1.0, Nov. 30, 2007, Japan Aerospace Exploration Agency discloses this indoor positioning system.

Non-patent document 1: Quasi-Zeith Satellite System User Interface Specification (IS-QZSS) Draft Ver. 1.0, Nov. 30, 2007, Japan Aerospace Exploration Agency

### DISCLOSURE OF THE INVENTION

### Problems to be Solved by the Invention

The indoor positioning system (IMES) using the IMES signal has the following problems because it employs a positioning method, equipment, and operation method different from those of the global positioning system.

(1) A Problem in Securing the Accuracy of Positioning Information

The positioning signals of Global Positioning System (GPS) are created and transmitted by the positioning satellites provided with an atomic clock. Moreover, in the GPS positioning, position measurement is performed by receiving the positioning signals which four satellites transmit. It may be very difficult to forge these GPS signals. Moreover, it is also difficult to steal and transplant the GPS Satellite. In contrast, in IMES, the specification of the IMES signal is publicized, and the indoor positioning information transmitter transmitting this signal is preferably manufactured with a structure as simple as possible because there is also a cost requirement. Accordingly, it is possible for those of ordinary skill in the art to forge the IMES transmitter. Moreover, if an IMES transmitter having specific position information (latitude, longitude, and altitude) stored therein is stolen and is installed at another place, the IMES transmitter may continue to transmit a wrong positioning signal. As described above, as compared with the GPS signal, it is extremely difficult to secure the accuracy of the IMES signal.

(2) A Problem in Infrastructure Cost

Global Positioning System (GPS) utilizes positioning signals transmitted by the positioning satellites which the United States launched for military purposes. Accordingly, in GPS, there is no need for users to cover the equipment cost of the transmission-side infrastructure. In contrast, in IMES, the indoor positioning information transmitter transmitting the IMES signal needs to be funded and installed by private sectors. The positioning information service using IMES involves various stakeholders, such as an area owner, an infrastructure company, a mobile communication company (carrier), a service company, and a service user. Which company to pay the equipment installation and operation cost is a big issue in promoting IMES.

It is an object of the present invention to provide a position information system including an inexpensive and accurate indoor positioning system which solves the above-described problems, and promote the same.

### Means for Solving the Problems

In order to solve the above-described problems, in the present invention, a large area position identifier in conjunction with a local position identifier makes it possible to reliably recognize a position. Here, with regard to the “large area position identifier (large area position ID)” and “local position identifier (local position ID)”, the “large area” is relative to the “local area” and the local area may be “narrower” than the large area.

More specifically, the following configurations are provided. In order to secure the accuracy of position information of a position information system, the position information system manages position information in an area having a predetermined extent where installation points for a plurality of positioning information transmitters are set, the position information system comprising: the positioning information transmitter being installed at the each set installation point and transmitting a specific positioning identifier; and a positioning information management server receiving the transmitted positioning identifier and converting the same into position information representing the predetermined installation point, wherein the positioning information management server

assigns to the predetermined area a large area position identifier specific thereto,

assigns to the predetermined installation point a local position identifier specific thereto,

assigns to the positioning information transmitter a transmitter fixed identifier specific thereto,

assigns to the positioning information transmitter a transmitter variable identifier which is specific to this positioning information transmitter and is a variable value, and

stores the assigned large area identifier, local position identifier, transmitter identifier, and transmitter variable identifier into a storage device, wherein the positioning information transmitter

stores its own transmitter fixed identifier, its own transmitter variable identifier, and a large area position identifier assigned to an area in which an installation point of the transmitter itself is located, into a storage unit,

performs a transmitter variable identifier concealing process on the transmitter variable identifier to conceal the transmitter variable identifier stored therein, and generates the positioning identifier comprising the concealed variable identifier and the large area position identifier and transmits the same to the positioning information management server, wherein the positioning information management server

stores into the storage device a transmitter activation identifier management table for managing a correlation among initial values of the transmitter fixed identifier and transmitter variable identifier of the positioning information transmitter and the large area position identifier and local position identifier of an installation point,

performs a concealing process on the transmitter variable identifier and stores into the storage device a transmitter identifier management table for managing a correlation among a generated concealed variable identifier and the large area position identifier and local position identifier of an installation point,

stores into the storage device a position identifier management table for managing a correlation among the large area position identifier and local position identifier of an installation point and the position information of the installation point,

extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table, and

with regard to the converted large area position identifier and local position identifier of an installation point, converts the two position identifiers into position information with the two position identifiers as a key and with reference to the position identifier management table.

Moreover, the present invention also includes an embodiment below. A position information system comprises: a positioning information transmitter being installed at a predetermined installation point and transmitting a positioning identifier; and a positioning information management server converting this positioning identifier into position information of the predetermined installation point, wherein the positioning information management server

assigns a large area position identifier to an area in which a positioning information transmitter is installed, and stores the same, and

assigns a local position identifier to the installation point of the positioning information transmitter in this area and stores the same, wherein the positioning information transmitter

by itself performs a predetermined transmitter variable identifier concealing process to generate a concealed variable identifier from a specific transmitter variable identifier, and

transmits the concealed variable identifier and the large area position identifier to the positioning information management server.

Moreover, the present invention also includes an embodiment below. A position information system installed at a predetermined installation point comprises a positioning information transmitter transmitting a positioning identifier and a positioning information management server converting the positioning identifier into position information of the predetermined installation point, wherein the positioning information management server

assigns a large area position identifier to an area in which a positioning information transmitter is installed,

assigns a local position identifier to an installation point of the positioning information transmitter in this area,

stores the assigned large area position identifier and the local position identifier into a storage device,

stores into the storage device a transmitter identifier management table for managing a correlation among a concealed variable identifier generated by performing a predetermined transmitter variable identifier concealing process and the large area position identifier and local position identifier of an installation point,

stores into the storage device a position identifier management table for managing a correlation among the large area position identifier and local position identifier of an installation point and the position information of the installation point,

extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table, and

with regard to the converted large area position identifier and local position identifier of an installation point, converts the two position identifiers into position information with the two position identifiers as a key and with reference to the position identifier management table.

Moreover, in the above-described position information system, the transmitter variable identifier concealing process comprises the steps of:

calculating a first hash value by hashing a transmitter variable identifier stored by the positioning information transmitter, with a first hash function and further repeatedly hashing the calculated hash value with the first hash function and generating a first hash information sequence comprising a plurality of hash values obtained by this repetition;

calculating a second hash value by hashing each element of the first hash information sequence with a second hash function and generating a second hash information sequence comprising a plurality of the calculated hash values;

treating the generated second hash information sequence as a concealed variable identifier, and wherein the step of generating the positioning identifier comprises the steps of:

firstly extracting a top hash value from each element of the second hash information sequence;

combining the extracted hash value with a large area position identifier stored therein and generating the positioning identifier;

repeatedly transmitting the generated positioning identifier a predetermined first number of times at a predetermined first time interval; and

extracting a next hash value of the second hash information sequence and repeatedly performing the steps of generating and transmitting the positioning identifier as described above.

Moreover, in the above-described position information system, the predetermined transmitter identifier concealing process comprises the steps of:

assigning a unique hash sequence identifier to each element of the second hash information sequence which is generated based on the transmitter variable identifier stored by the positioning information transmitter, and generating a hash-sequence-identifier sequence comprising the assigned hash sequence identifier; and

extracting a corresponding hash sequence identifier from the generated hash-sequence-identifier sequence in extracting a hash value which is each element of the second hash-sequence-identifier sequence, and generating the positioning identifier by combining the extracted hash value and hash sequence identifier with a large area position identifier stored therein.

Moreover, in the above-described position information system, the predetermined transmitter identifier concealing process comprises the steps of:

storing a predetermined encryption processing unit, a predetermined encryption key, and a encryption key identifier uniquely assigned to the cryptographic key into the positioning information transmitter; and

combining a transmitter variable identifier, a large area position identifier, and a random number stored by the positioning information transmitter, and encrypting the combined information with the predetermined encryption key to generate a concealed variable identifier, and wherein the step of generating the positioning identifier comprises the steps of:

generating the positioning identifier by combining the generated concealed variable identifier with a large area position identifier stored by the positioning information transmitter;

repeatedly transmitting the generated positioning identifier a predetermined first number of times at a predetermined first time interval; and

generating a concealed variable identifier again by regenerating the random number, and repeatedly performing the steps of generating and transmitting the positioning identifier as described above.

Moreover, the present invention also includes an embodiment below. A position information system manages position information in an area having a predetermined extent where installation points for a plurality of positioning information transmitters are set, the position information system comprising:

the positioning information transmitter being installed at the each set installation point and transmitting a specific positioning identifier;

a mobile communication terminal provided with a positioning function including a positioning identifier receiving unit configured to receive the transmitted positioning identifier, a program execution unit configured to execute a client program of a position information application, and a wireless communication unit for mobile communications;

a mobile communication server including a wireless communication unit for mobile communication with the mobile communication terminal, and a network communication unit configured to communicate with a network;

an application server including a network communication unit configured to communicate with the network and a program execution unit configured to execute a server program of a position information application; and

a positioning information management server including a network communication unit configured to communicate with the network for receiving the transmitted positioning identifier via the mobile communication terminal provided with a positioning function and the mobile communication server, and a positioning information transmitter identifier decoding processing unit configured to convert the received positioning identifier into position information representing the predetermined installation point, wherein the positioning information management server

assigns to the predetermined area a large area position identifier specific thereto,

assigns to the predetermined installation point a local position identifier specific thereto,

assigns to the positioning information transmitter a transmitter fixed identifier specific thereto,

assigns to the positioning information transmitter a transmitter variable identifier which is specific to the transmitter and is a variable value, and

stores the assigned large area identifier, local position identifier, transmitter identifier, and transmitter variable identifier into a storage device, wherein the positioning information transmitter

stores its own transmitter fixed identifier, its own transmitter variable identifier, and a large area position identifier assigned to an area in which an installation point of the transmitter itself is located, into a storage unit,

performs a predetermined transmitter variable identifier concealing process to conceal the transmitter variable identifier stored therein, and generates the positioning identifier comprising the concealed variable identifier and the large area position identifier and transmits the same to the mobile communication terminal provided with a positioning function, wherein the mobile communication terminal provided with a positioning function

receives the transmitted positioning identifier and generates a mobile terminal positioning request to request the positioning information management server to convert the received positioning identifier into position information,

executes a client program of the stored position information application, and generates a mobile communication terminal application service request which is a request to a server program within the positioning information management server,

generates two transaction identifiers having an equal value indicating that the generated two requests were generated in the executed client program of a single position information application,

adds the generated first transaction identifier to the generated mobile terminal positioning request, and transmits the resultant request to the positioning information management server via the mobile communication server, and

adds the generated second transaction identifier to the generated mobile communication terminal application service request, and transmits the resultant request to the application server via the mobile communication server, wherein the mobile communication server

transmits the received mobile terminal positioning request to the positioning information management server, and

transmits the received mobile communication terminal application service request to the application server, wherein the positioning information management server

stores into the storage device a transmitter activation identifier management table for managing a correlation among initial values of the transmitter fixed identifier and transmitter variable identifier of the positioning information transmitter and the large area position identifier and local position identifier of an installation point,

stores into the storage device a transmitter identifier management table for managing a correlation among a concealed variable identifier generated by performing the predetermined transmitter variable identifier concealing process and the large area position identifier and local position identifier of an installation point,

stores into the storage device a position identifier management table for managing a correlation among the large area position identifier and local position identifier of an installation point and the position information of the installation point,

extracts the concealed variable identifier from the positioning identifier received from the positioning information transmitter, and converts the received positioning identifier into the large area position identifier and the local position identifier of an installation point,

with the extracted identifier as a key and with reference to the transmitter identifier management table, converts the converted large area position identifier and local position identifier of an installation point into position information, with the two position identifiers as a key and with reference to the position identifier management table, and

transmits the converted position information to the application server as a positioning server positioning response via a network, wherein the application server

receives the transmitted mobile communication terminal application service request and extracts the first transaction identifier from the received mobile communication terminal application service request,

receives the transmitted positioning server positioning response and extracts the second transaction identifier from the received positioning server positioning response and

determines whether or not the extracted first and second transaction identifiers are identical, and if these are identical, then the application server performs an application server processing, with position information included in the positioning server positioning response and generation information of a client side program included in the mobile communication terminal application service request as inputs, and transmits the executed result information to the mobile communication terminal via the mobile communication server as an application server application service response.

Moreover, the present invention also includes an embodiment below. A position information system manages position information in an area having a predetermined extent where installation points for a plurality of positioning information transmitters are set, the position information system comprising:

the positioning information transmitter being installed at the each set installation point and transmitting a specific positioning identifier;

a mobile communication terminal provided with a positioning function including a positioning identifier receiving unit configured to receive the transmitted positioning identifier, a program execution unit configured to execute a client program of a position information application, and a wireless communication unit for mobile communications;

a mobile communication server including a wireless communication unit for mobile communication with the mobile communication terminal, and a network communication unit configured to communicate with the network;

an application server including a network communication unit configured to communicate with the network and a program execution unit configured to execute a server program of a position information application; and

a positioning information management server including a network communication unit configured to communicate with the network for receiving the transmitted positioning identifier via the mobile communication terminal provided with a positioning function and the mobile communication server, and a positioning information transmitter identifier decoding unit configured to convert the received positioning identifier into position information representing the predetermined installation point, wherein the positioning information management server

assigns to the predetermined area a large area position identifier specific thereto,

assigns to the predetermined installation point a local position identifier specific thereto,

assigns to the positioning information transmitter a transmitter fixed identifier specific thereto,

assigns to the positioning information transmitter a transmitter variable identifier which is specific to the transmitter and is a variable value, and

stores the assigned large area identifier, local position identifier, transmitter identifier, and transmitter variable identifier into a storage device, wherein the positioning information transmitter

stores its own transmitter fixed identifier, its own transmitter variable identifier, and a large area position identifier assigned to an area in which an installation point of the transmitter itself is located, into a storage unit,

performs a predetermined transmitter variable identifier concealing process to conceal the transmitter variable identifier stored therein, and generates the positioning identifier comprising the concealed variable identifier and the large area position identifier and transmits the same to the mobile communication terminal provided with a positioning function, wherein the mobile communication terminal provided with a positioning function

receives the transmitted positioning identifier and generates a mobile terminal positioning request to request the positioning information management server to convert the received positioning identifier into position information,

executes a client program of the stored position information application, and generates a mobile communication terminal application service request which is a request to a server program within the positioning information management server,

adds an address of the positioning information management server to the generated mobile terminal positioning request as destination information, adds an address of the application server to the mobile communication terminal application service request as destination information, and combines these two requests and transmits the same to the mobile communication server as a single mobile communication integrated-request, wherein the mobile communication server

receives the transmitted single mobile communication integrated-request and analyzes the received integration request,

as a result of the analysis, splits the received integration request into a mobile terminal positioning request and a mobile communication terminal application service request,

generate two transaction identifiers having an equal value indicating that the split two requests were generated in the executed client program of a single position information application,

adds the first transaction identifier and an address of the positioning information management server which is destination information, to the mobile terminal positioning request which is one of the split results, and transmits the resultant request to the positioning information management server, and

adds the second transaction identifier and an address of the application server which is destination information, to the mobile communication terminal application service request which is the other one of the split results, and transmits the resultant request to the application server, wherein the positioning information management server

stores into the storage device a transmitter activation identifier management table for managing a correlation among initial values of the transmitter fixed identifier and transmitter variable identifier of the positioning information transmitter and the large area position identifier and local position identifier of an installation point,

stores into the storage device a transmitter identifier management table for managing a correlation among a concealed variable identifier generated by performing the predetermined transmitter variable identifier concealing process and the large area position identifier and local position identifier of an installation point,

stores into the storage device a position identifier management table for managing a correlation among the large area position identifier and local position identifier of an installation point and the position information of the installation point,

extracts the concealed variable identifier from the positioning identifier received from the positioning information transmitter, and converts the received positioning identifier into the large area position identifier and the local position identifier of an installation point, with the extracted identifier as a key and with reference to the transmitter identifier management table,

converts the converted large area position identifier and local position identifier of an installation point into position information, with the two position identifiers as a key and with reference to the position identifier management table, and

transmits the converted position information to the application server as a positioning server positioning response via the network, and wherein the application server

receives the transmitted mobile communication terminal application service request and extracts the first transaction identifier from the received mobile communication terminal application service request,

receives the transmitted positioning server positioning response and extracts the second transaction identifier from the received positioning server positioning response and

determines whether or not the extracted first and second transaction identifiers are identical, and if these are identical, then the application server performs an application server processing, with position information included in the positioning server positioning response and generation information of a client side program included in the mobile communication terminal application service request as inputs, and transmits the executed result information to the mobile communication terminal via the mobile communication server as an application server application service response.

Moreover, in the above-described position information system, the positioning information management server, wherein

for each of the positioning information transmitters installed at the predetermined points, a charge information record of a set of information group consisting of a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created and a charge information management table for storing the record is retained in the storage device,

performs a positioning charge process comprising the steps of:

every time the mobile terminal positioning request is received and converted and decoded into position information, searching the charge information management table, with the large area position identifier extracted through the conversion and decoding, the transmitter fixed identification number, the mobile communication company identification number, and the service company identification number as a search key; and

if there is a charge information record matching the search key, creating a charge information record wherein the number of times of positioning of the charge information record is incremented by one, and writing back the charge information record to the charge information management table;

if there is no charge information record matching the search key, newly creating the charge information record, and setting the number of times of positioning of the created charge information record to one and storing the created charge information record into the charge information management table;

reading each record of the charge information management table at a predetermined time interval;

for the each large area position identifier, summing a total of the number of times of positioning of the read record to calculate the number of times of positioning for each large area position, and applying a predetermined charge function to the calculated number of times of positioning and transmitting a positioning charge request for an area owner;

for the each mobile communication company identifier, summing a total of the number of times of positioning of the read record to calculate the number of times of positioning for each mobile communication company, and applying a predetermined charge function to the calculated number of times of positioning and transmitting a positioning charge request for a mobile communication company; and

for the each application service company identifier, summing a total of the number of times of positioning of the read record to calculate the number of times of positioning for each application service company, and applying a predetermined charge function to the calculated number of times of positioning, and transmitting a positioning charge request for a service company.

Moreover, in the above-described position information system, the predetermined transmitter variable information concealing process comprises the steps of:

calculating a third hash value by hashing a transmitter variable identifier stored by the positioning information transmitter, with a third hash function and further repeatedly hashing the calculated hash value with the third hash function and generating a third hash information sequence comprising a plurality of hash values obtained by this repetition;

extracting a top element of the third hash information sequence as a transmitter variable identifier, and hashing the extracted transmitter variable identifier with the first hash function and calculating the first hash value, and further repeatedly hashing the calculated hash value with the first hash function and generating a first hash information sequence comprising a plurality of hash values obtained by this repetition;

calculating a second hash value by hashing each element of the first hash information sequence with a second hash function and generating a second hash information sequence comprising a plurality of the calculated hash values; and

treating the generated second hash information sequence as a concealed variable identifier, wherein the step of generating the positioning identifier comprises the steps of:

firstly extracting a top hash value from each element of the second hash information sequence;

combining the extracted hash value with a large area position identifier stored therein and generating the positioning identifier;

repeatedly transmitting the generated positioning identifier a predetermined first number of times at a predetermined first time interval;

extracting a next hash value of the second hash information sequence and repeatedly performing the steps of generating and transmitting the positioning identifier,

if the step of transmitting the positioning identifier is repeated a predetermined second number of times, then extracting a next element of the third hash information sequence and treating the next element as the transmitter variable identifier, and repeatedly performing the steps of generating and transmitting the positioning identifier, wherein the positioning information management server

as with the positioning information transmitter, generates the third hash information sequence, and downloads a part of element data of the generated third hash information sequence to the mobile communication terminal provided with a positioning function, as the transmitter variable identifier, and wherein the mobile communication terminal provided with a positioning function

performs a positioning information transmitter identifier decoding process comprising the steps of:

based on the downloaded transmitter variable identifier, performing a predetermined transmitter variable identifier concealing process to generate a concealed variable identifier as with the positioning information transmitter;

storing a transmitter identifier management table for managing a correlation among the generated concealed variable identifier and the large area position identifier and local position identifier of an installation point;

storing a position identifier management table for managing a correlation among the large area position identifier and local position identifier of an installation point and position information of the installation point;

extracting a concealed variable identifier from a positioning identifier received from the positioning information transmitter;

with regard to the extracted concealed variable identifier, with reference to the transmitter identifier management table and with the identifier as a key, converting the identifier into the large area position identifier and local position identifier of an installation point; and

with regard to the converted large area position identifier and local position identifier of an installation point, with reference to the position identifier management table and with these two positioning identifiers as a key, converting these two positioning identifiers into position information.

Moreover, in the above-described position information system, the transmitter variable identifier decoding process, wherein

for each of the positioning information transmitters installed at the predetermined points, a charge information record of a set of information group consisting of a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created, and a charge information management table for storing the charge information record is stored,

comprises the steps of:

performing a positioning charging representation process comprising the steps of:

every time the mobile terminal positioning request is received and converted and decoded into position information, searching the charge information management table with the large area position identifier, the transmitter fixed identification number, the mobile communication company identification number, and the service company identification number which are extracted through the conversion and decoding, as a search key;

if there is a charge information record matching the search key, then creating a charge information record wherein the number of times of positioning of the charge information record is incremented by one, and writing back the charge information record to the charge information management table; and

if there is no charge information record matching the search key, then newly preparing the charge information record, setting the number of times of positioning of the created charge information record to one, and storing the created charge information record into the charge information management table; and

performing a positioning charge fee notification process of transmitting a content of the stored charge information management table to the positioning information management server at a predetermined time interval; wherein the positioning information management server includes a positioning charge process comprising the steps of:

summing a content of the charge information management table transmitted through the positioning charge fee notification process of the mobile communication terminal, and reading each record of the summed charge information management table at a predetermined time interval,

for the each large area position identifier, summing a total of the number of times of positioning of the read record, and calculating the number of times of positioning for each large area position, and applying a predetermined charge function to the calculated number of times of positioning, and transmitting a positioning charge request for an area owner;

for the each mobile communication company identifier, summing a total of the number of times of positioning of the read record, and calculating the number of times of positioning for each mobile communication company, and applying a predetermined charge function to the calculated number of times of positioning, and transmitting a positioning charge request for a mobile communication company; and

for the each application service company identifier, summing a total of the number of times of positioning of the read record to calculate the number of times of positioning for each application service company, and applying a predetermined charge function to the calculated number of times of positioning, and transmitting a positioning charge request for a service company.

Moreover, in the above-described position information system, in the predetermined transmitter variable information concealing process, the positioning information transmitter stores a predetermined key encryption key; and

repeats the steps of: encrypting the encryption key stored by the positioning

information transmitter, with the stored key encryption key to calculate an encryption key; and encrypting the calculated encryption key with the key encryption key, thereby generating a first encryption key sequence comprising encryption keys obtained by this repetition;

extracts a top element of the first encryption key sequence, combines a transmitter variable identifier, a large area position identifier, and a random number stored by the positioning information transmitter, and encrypts the combined information with the extracted encryption key to generate a concealed variable identifier, wherein the step of generating the positioning identifier comprises the steps of:

generating the positioning identifier by combining the generated concealed variable identifier with a large area position identifier stored by the positioning information transmitter;

repeatedly transmitting the generated positioning identifier a predetermined first number of times at a predetermined first time interval; and

generating a concealed variable identifier again by regenerating the random number, and repeatedly performing the steps of generating and transmitting the positioning identifier as described above;

if the step of transmitting the positioning identifier is repeated a predetermined second number of times, then extracting a next element of the second encryption key sequence and treating this as a transmitter variable identifier as described above, and repeatedly performing the steps of generating and transmitting the positioning identifier as described above, and wherein the positioning information management server

as with the positioning information transmitter, generates the first encryption key sequence and downloads a part of element data of the generated encryption key sequence to the mobile communication terminal provided with a positioning function, as the encryption key, wherein the mobile communication terminal provided with a positioning function

performs a positioning information transmitter identifier decoding process comprising the steps of:

storing a transmitter activation identifier management table for managing a correlation among initial values of the transmitter fixed identifier and transmitter variable identifier of the positioning information transmitter and the large area position identifier and local position identifier of an installation point;

storing a position identifier management table for managing a correlation among the large area position identifier and local position identifier of an installation point and position information of the installation point;

extracting a concealed variable identifier from a positioning identifier received from the positioning information transmitter;

decoding the extracted concealed variable identifier with the downloaded encryption key to calculate a transmitter variable identifier;

with reference to the transmitter activation identifier management table and with the calculated transmitter variable identifier as a key, converting the identifier into the large area position identifier and local position identifier of an installation point; and

with regard to the converted large area position identifier and local position identifier of an installation point, with reference to the position identifier management table and with these two positioning identifiers as a key, converting these two positioning identifiers into position information.

Moreover, in the above-described position information system, the transmitter variable identifier decoding process, which the mobile communication terminal provided with a positioning function includes, wherein

for each of the positioning information transmitters installed at the predetermined points, a charge information record of a set of information group consisting of a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created, and a charge information management table for storing the charge information record is stored,

comprises a positioning charging representation process comprising the steps of:

every time the mobile terminal positioning request is received and converted and decoded into position information, searching the charge information management table, with the large area position identifier, the transmitter fixed identification number, the mobile communication company identification number, and the service company identification number which are extracted through the conversion and decoding, as a search key;

if there is a charge information record matching the search key, then creating a charge information record wherein the number of times of positioning of the charge information record is incremented by one, and writing back the charge information record to the charge information management table; and

if there is no charge information record matching the search key, then newly creating the charge information record, and setting the number of times of positioning of the created charge information record to one, and storing the created charge information record into the charge information management table; and

further comprises the step of performing a positioning charge fee notification process of transmitting a content of the stored charge information management table to the positioning information management server at a predetermined time interval; wherein the positioning information management server

performs a positioning charge process comprising the steps of:

summing a content of the charge information management table transmitted through the positioning charge fee notification process of the mobile communication terminal, and reading each record of the summed charge information management table at a predetermined time interval,

for the each large area position identifier, summing a total of the number of times of positioning of the read record, and calculating the number of times of positioning for each large area position, and applying a predetermined charge function to the calculated number of times of positioning, and transmitting a positioning charge request for an area owner;

for the each mobile communication company identifier, summing a total of the number of times of positioning of the read record, and calculating the number of times of positioning for each mobile communication company, and applying a predetermined charge function to the calculated number of times of positioning, and transmitting a positioning charge request for a mobile communication company; and

for the each application service company identifier, summing a total of the number of times of positioning of the read record to calculate the number of times of positioning for each application service company, and applying a predetermined charge function to the calculated number of times of positioning, and transmitting a positioning charge request for a service company.

Moreover, in the above-described position information system, the positioning information management server stores a specific positioning information transmitter owning company identifier assigned to a transmitter owning company which owns, and operates or manages the positioning information transmitter, wherein

the transmitter activation identifier management table includes the assigned positioning information transmitter owning company identifier as a new data element for each record which is stored with respect to the installed positioning information transmitter, wherein

the position identifier management table includes the assigned positioning information transmitter owning company identifier as a new data element for each record which is stored with respect to the large area position identifier and local position identifier of the installation position, wherein

the positioning information transmitter includes the assigned positioning information transmitter owning company identifier as a new data element of the positioning identifier, and wherein

the positioning information management server, based on the received positioning identifier, uses the positioning information transmitter owning company identifier as a search key in searching the transmitter activation identifier management table, or based on the received positioning identifier, uses the positioning information transmitter owning company identifier as a search key in searching the transmitter identifier management table.

Moreover, in the above-described position information system, the positioning information management server

stores, for the each mobile communication terminal, a mobile communication terminal identifier management table for storing a result of a transmitter identifier decoding process, which is performed in response to a mobile terminal positioning request transmitted by the mobile communication terminal, into the storage device,

stores a record comprising a mobile communication terminal identifier, a mobile communication company identifier, a large area position identifier, a local position identifier, the positioning request occurrence time, a transmitter fixed identifier, and position information into the mobile communication terminal identifier management table, and

every time the positioning information management server receives the mobile terminal positioning request and starts a transmitter identifier decoding process, with reference to the mobile communication terminal identifier management table, and with the identifier of a mobile communication terminal which transmitted the positioning request, as a search key, the positioning information management server

obtains a decoding result of a mobile terminal positioning request, which the communication terminal issues immediately before, as search result, and extracts the positioning request occurrence time of the immediately preceding positioning request and the position information, and

compares the positioning request occurrence time, which is a result of the decoding process of the received new positioning request, with the position information, and if a change in the position information, the change being equal to or greater than a predetermined distance, is detected with a predetermined time difference, then with regard to a positioning information transmitter which transmitted a concealed variable identifier included in the received new positioning request, the positioning information management server invalidates a record in the transmitter identifier management table in which the positioning information transmitter is registered.

### EFFECTS OF THE INVENTION

Note that, the present invention also includes each device constituting the above-described position information system, a method using the each device, a method using the position information system, and a computer program for realizing the same.

According to the present invention, in a position information system, in order to secure the accuracy in positioning and also establish a cost sharing mechanism, a positioning information transmitter transmits a positioning identifier instead of directly transmitting position information. A positioning information management server stores and manages the positioning identifier and the position information while correlating them with each other. In response to a position information request with a positioning identifier, the positioning information management server converts the positioning identifier into position information according to the aforementioned correlation.

In this way, in order to convert the positioning identifier, which the positioning information transmitter transmits, into position information, the positioning identifier always goes through the positioning information management server, so that the positioning information management server can recognize which mobile communication terminal has received a positioning identifier transmitted by a positioning information terminal installed at which installation place, and for which application the conversion of the position information has been requested. As a result, according to the number of times of use of a positioning identifier, charge information can be generated so that an area owner, a mobile communication company, a mobile communication terminal user, and an application company at an installation point share and pay the installation and operation cost of the position information system.

Furthermore, the positioning identifier transmitted by a positioning information transmitter is updated in a predetermined time using a predetermined update unit, so that the positioning information management server can (for example, exclusively) convert the positioning identifier into position information. The application of an encryption technology to the predetermined update means makes it difficult for a third party to decode the positioning identifier and also makes it difficult to forge the positioning information transmitter, thus improving the security of the system.

Moreover, in the position information system, the position information is directly stored into a positioning information transmitter to secure the positioning accuracy, and moreover, in order to establish the cost sharing mechanism, the positioning information management server stores and manages a correlation between a positioning identifier and position information. In response to a position information request with a positioning identifier, the positioning information management server converts the positioning identifier into position information according to the aforementioned correlation. Furthermore, the positioning information management server updates the positioning identifier transmitted by the positioning information transmitter in a predetermined time by using a predetermined update unit, so that the positioning information management server can (for example, exclusively) convert the positioning identifier into position information.

Other objects, features, and advantages of the present invention will become apparent from the following description of the embodiments of the present invention in conjunction with the accompanying drawings.

### BRIEF DESCRIPTION OF THE DRAWINGS

FIG. 1 is a view showing a configuration of a first embodiment of a positioning system of the present application.

FIG. 2 is a view showing a configuration of a positioning information transmitter (200).

FIG. 3 is a view showing a configuration of a mobile communication terminal provided with a positioning function (300).

FIG. 4 is a view showing a configuration of a mobile communication server (400).

FIG. 5 is a view showing a configuration of an application server (500).

FIG. 6 is a view showing a process flow of a transmitter activation process (610).

FIG. 7 is a view showing a process flow of a transmitter registration process (630).

FIG. 8 is a view showing a process flow of a transmitter activation process (210).

FIG. 9 is a view showing a configuration of a first embodiment of a transmitter variable ID concealing and decoding process.

FIG. 10 is a view showing a process flow of a first embodiment of a variable ID concealing process (230).

FIG. 11 is a view showing a configuration of a second embodiment of the transmitter variable ID concealing and decoding process.

FIG. 12 is a view showing a process flow of a second embodiment of the variable ID concealing process (230).

FIG. 13 is a view showing a process flow of an application client processing (319).

FIG. 14 is a view showing a process flow of the application client processing (319).

FIG. 15 is view showing a process flow of a mobile communication server processing (411).

FIG. 16 is a view showing a process flow of an application server processing (508).

FIG. 17 is a view showing the process flow of the application server processing (508).

FIG. 18 is a view showing a process flow of a first embodiment of a transmitter ID decoding process (710).

FIG. 19 is a view showing a process flow (continuing from FIG. 18) of the first embodiment of the transmitter ID decoding process (710).

FIG. 20 is a view showing a process flow of a second embodiment of the transmitter ID decoding process (710).

FIG. 21 is a view showing the process flow (continuing from FIG. 20) of the second embodiment of the transmitter ID decoding process (710).

FIG. 22 is a view showing a configuration of a charge information management table (830).

FIG. 23 is a view showing a process flow of a positioning charge process (840).

FIG. 24 is a view showing a configuration of a third embodiment of the transmitter variable ID concealing and decoding process.

FIG. 25 is a view showing the configuration (continuing from FIG. 24) of the third embodiment of the transmitter variable ID concealing and decoding process.

FIG. 26 is a view showing a configuration of a fourth embodiment of the transmitter variable ID concealing and decoding process.

FIG. 27 is a view showing the configuration (continuing from FIG. 26) of the fourth embodiment of the transmitter variable ID concealing and decoding process.

FIG. 28 is a view showing a content of a preprocessing of a transmitter activation work.

FIG. 29 is a view showing a positioning system configuration to achieve an integration of a positioning request and an application service request.

FIG. 30 is a view showing a configuration of a method for managing a position ID for each company.

FIG. 31 is a view showing a configuration of a sixth embodiment of the transmitter variable ID concealing and decoding process.

FIG. 32 is a view showing a configuration of a seventh embodiment of the transmitter variable ID concealing and decoding process.

### BEST MODE FOR CARRYING OUT THE INVENTION

Hereinafter, each embodiment according to the present invention will be described.

### Embodiment 1

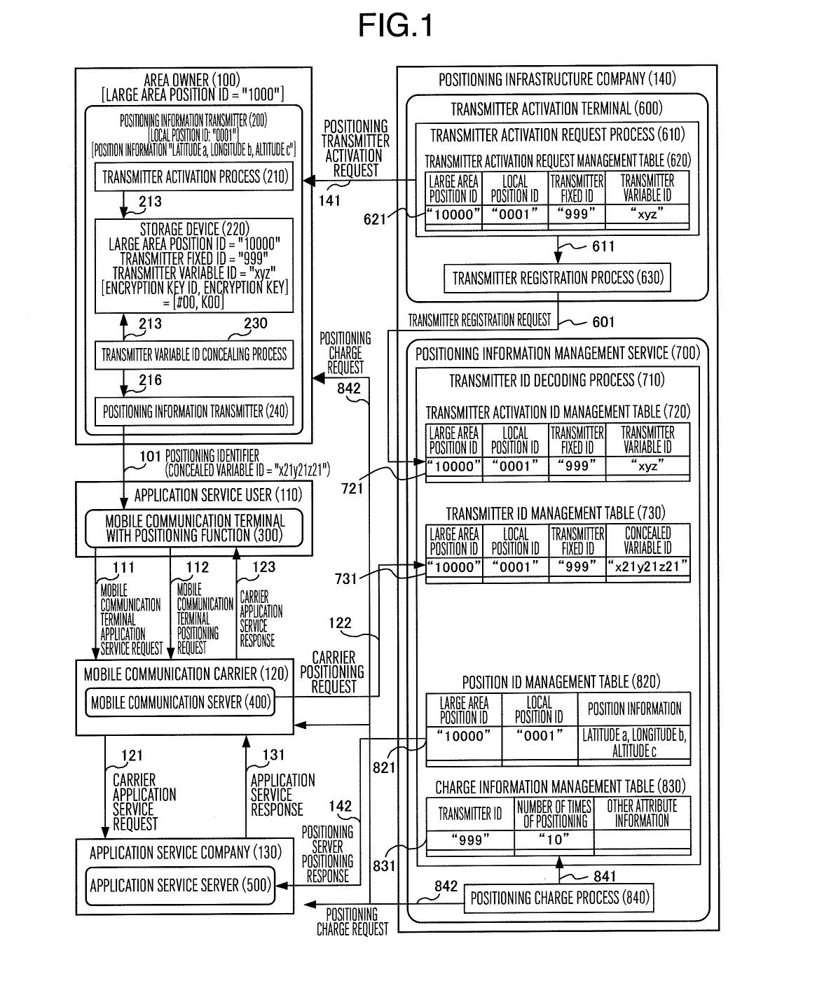

A configuration of a positioning system which is a first embodiment of the present application is shown in FIG. 1.

First, companies constituting this positioning system, and an information system owned by each company are described.

An area owner 100 owns a predetermined area which is uniquely designated by a “large area position ID”. This predetermined area refers to an area having an extent, inside which the ordinary GPS positioning is difficult. Specific examples include a building, an underground shopping center, and the like. In the predetermined area, a plurality of positioning information transmitters, such as a positioning information transmitter 200 transmitting a positioning identifier 101, are installed.

An application service user 110 is a service user who carries a mobile communication terminal provided with a positioning function 300, represented by a mobile phone, and visits the predetermined area and uses a location based service (LBS) mounted on the mobile communication terminal provided with a positioning function 300 in this area. The mobile communication terminal provided with a positioning function 300 receives a positioning identifier 101 transmitted by the positioning information transmitter 200, and performs the client side process of the LBS which is an application service utilizing the received positioning identifier. Moreover, the mobile communication terminal 300 transmits and receives a wireless communication packet to and from a mobile communication server 400 in performing the LBS.

The mobile communication carrier 120 is a company which owns and operates a mobile communication system comprising a mobile communication terminal represented by a mobile phone and a wireless communication base station. The mobile communication carrier 120 owns the mobile communication server 400. The mobile communication server 400 transmits and receives a wireless communication packet to and from the mobile communication terminal 300. Furthermore, the mobile communication server 400 includes a network interface with a backbone network, processes the transmitted and received wireless communication packet and transmits and receives data to and from the backbone network.

The application service company 130 is a service company, which makes a contract with the mobile communication carrier 120 and provides the LBS utilizing a positioning identifier to the application service user 110. The application service company 130 owns an application server 500 for performing the LBS. The application server 500 includes a network interface with the backbone network, and transmits and receives data to and from the backbone network.

A positioning infrastructure company 140 is a service company, which provides the installation and maintenance of the positioning information transmitter 200, the issuance and operation management of the positioning identifier itself, and a decoding service of the positioning identifier. The positioning infrastructure company 140 owns a transmitter activation terminal 600 and a positioning information management server 700. The transmitter activation terminal 600 includes a wired or wireless communication interface between the transmitter activation terminal 600 and the positioning information transmitter 200, and activates the positioning information transmitter 200. Furthermore, the transmitter activation terminal 600 includes a network interface with the backbone network, and transmits the result information of the activation process to the positioning information management server 700 and registers the same. The positioning information management server 700 includes a network interface with the backbone network, and transmits and receives data to and from the activation terminal 600, the mobile communication server 400, and the application server 500. The positioning information management server 700 receives a positioning request via the backbone network, decodes the received positioning identifier, and returns a response as position information.

Now the description of the companies constituting the first embodiment of the present positioning system and the information system owned by each company is completed.

Next, the installation work and operation work of the present positioning system will be described in detail in accordance with the following seven main work segments.

(1) Design and initialization work of the installation place of a positioning information transmitter

(2) Activation and installation work of a positioning information transmitter

(3) Registration work of an installed positioning information transmitter

(4) Positioning information concealing and positioning identifier transmitting work

(5) Positioning identifier reception and LBS work

(6) Positioning identifier decoding work

(7) Charge work of a positioning identifier decoding process

Note that, in the followings, for ease of description, an example of a single positioning information transmitter to be installed in a predetermined area will be mainly described. However, it is apparent that also when a plurality of positioning information transmitters are installed, the same process may be repeated with respect to the individual positioning information transmitter. The notation used in the description of the present invention is described. In the embodiments of the present invention, a notation of “$[element data variable name]” is used in representing an internal variable used in a program or an element data of an information table. Moreover, a notation of “$$[structure variable name $[element data variable name 1], $[element data variable name 2], $[element data variable name 3], . . . ]” is used in representing a structural format of internal variable comprising a combination of a plurality of element data, or structure data of an information table. Moreover, the “identifier” may be abbreviated as “ID”.

(1) Design and Initialization Work of the Installation Place of a Positioning Information Transmitter

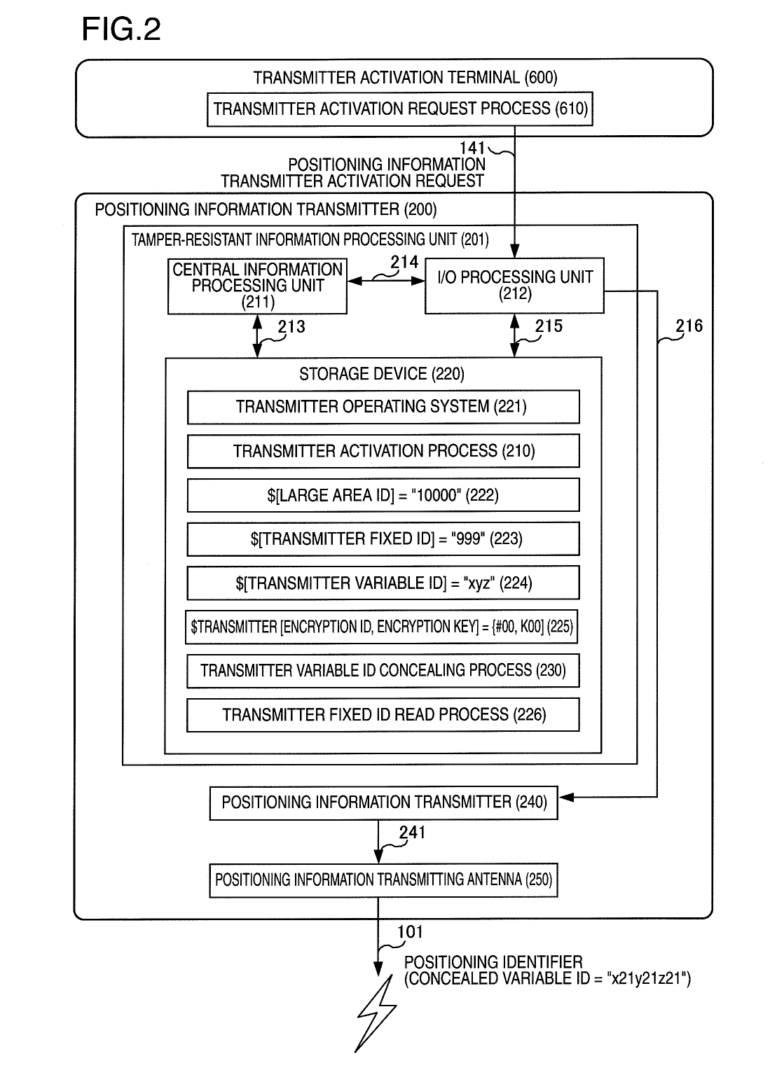

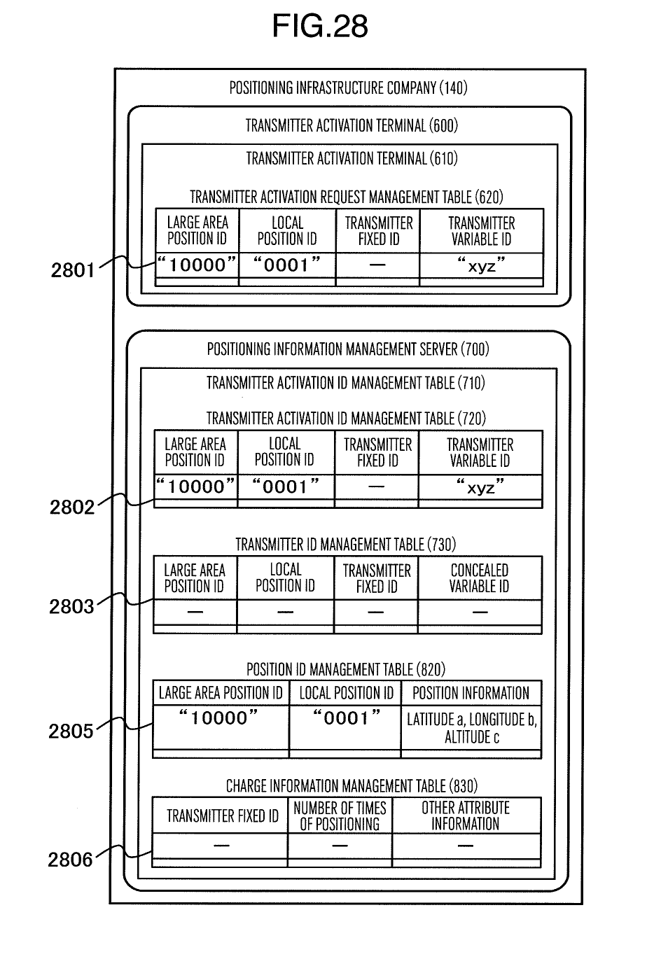

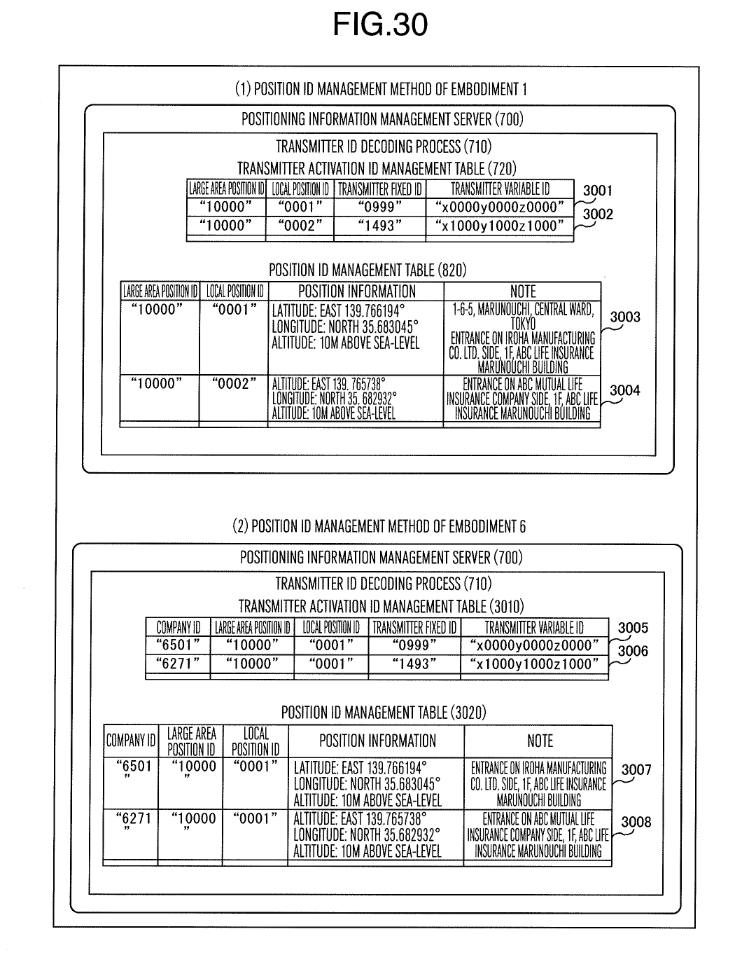

The “design and initialization work of the installation place of a positioning information transmitter” which is the first main work will be described using FIG. 1, FIG. 2, FIG. 28, and FIG. 30. In this work, information on the installation place of a positioning information transmitter is registered in the positioning information management server. Furthermore, in this work, the registered information is downloaded to the transmitter activation terminal 600 to prepare for “the activation and installation work of a positioning information transmitter” described later.

First, a method for specifying a position ID in the present invention is described with reference to FIG. 30(1). In the following, specifically, ABC Life Insurance Marunouchi Building (location: 1-6-6, Marunouchi, Center Ward, Tokyo), which is a hypothetical building, is described as an example. First, assuming that ABC Life Insurance Marunouchi Building is a predetermined area in which the above-described positioning information transmitter is installed, “10000” is assigned to a large area position ID 222. The large area position ID may be in any expression form as long as it is an information code capable of uniquely specifying a location in the national level. For example, a character string of the above-described address indicative of the location may be used. The area owner 100 is ABC Mutual Life Insurance Company. Furthermore, assume that one positioning information transmitter is installed at two places in ABC Life Insurance Marunouchi Building, respectively. Assume that ABC Life Insurance Marunouchi Building is occupied by Tokyo Head Quarters of ABC Mutual Life Insurance Company and Head Quarters of Iroha Manufacturing Co., Ltd. As the first installation place, “the entrance of Iroha Manufacturing Co., Ltd.” in the first floor on the east side of the building is selected, and is assigned with a local position ID “0001”. This installation information is represented by a record 3003 of the position ID management table (820) of FIG. 30(1). In the “position information” on the record 3003, the longitude, latitude, and altitude of an installation place which are the decoding results of the positioning identifier are given. As the second installation place, “the entrance of ABC Mutual Life Insurance Company” in the first floor on the south side of the building is selected, and is assigned with a local position ID “0002”. This installation information is represented by a record 3004 of the position ID management table (820) of FIG. 28(1).

As described above, the present invention is characterized by, as the method for specifying the ID number representing any location which is the installation place of a positioning information transmitter, a combination of a large area position ID representing the location, such as the location of a building itself, of a level where positioning is possible by GPS, and a local position ID representing a location, such as a location inside the building, of a level where positioning by GPS is difficult. Here, note that the terms “large area position ID” and “local position ID” are just the terms indicative of a relative relationship from the physical point of view. As described above, the large area position ID is an identifier for describing an area having a predetermined range of extent while the local position ID is an identifier for describing one point not having an extent inside this area. That is, it is possible to specify a plurality of local position ID's in an area assigned with a certain large area position ID, and the terms “large area” and “local area” come from this physical magnitude relationship. Now the description of the method for specifying the large area position ID and local position ID representing the installation place of a positioning information transmitter is completed.

Next, a preprocessing which should be carried out prior to the activation and installation work of a positioning information transmitter is described.

[Pre-Processing 1] Initialization Process of a Transmitter Fixed ID of a Positioning Information Transmitter

As shown in FIG. 1 and FIG. 2, with regard to the positioning information transmitter 200, a transmitter fixed ID 223 within a storage device 220 is initialized in advance. Specifically, in the description of this embodiment, the transmitter fixed ID 223 is set to “999” in advance. The transmitter fixed ID 223 can be read from the outside of the positioning information transmitter through a command interface for starting a transmitter fixed ID read process (226 in FIG. 2). However, this transmitter fixed ID read command should have been provided through a physical communication interface which is different from that of a positioning identifier transmitter 240 to be described later. As described later, this is because the present invention is characterized in that for the purpose of retaining security, the positioning information transmitter will not extensively transmit the fixed ID.

[Pre-Processing 2] Initialization Process of the Position ID Management Table

As shown in FIG. 28, with regard to the positioning information management server 700, the position ID management table 820 is initialized in advance. Specifically, in the description of this embodiment, a record 821 is stored into the position ID management table 820 in advance, and also the large area position ID(=“10000”), the local position ID(=“0001”), and the position information(=“latitude a, longitude b, an altitude c”) are set for element data constituting the record. As described in the above description of the position ID, the record 821 is a record for storing the information about the installation position of a positioning information transmitter, which means that “the position designated by the latitude, longitude, and altitude which are the position information is designated as the installation position of a positioning information transmitter, and in order to uniquely identify this installation position an information pair of the large area position ID and the local position ID is assigned.”

[Pre-Processing 3] Initialization Process of the Transmitter Activation ID Management Table 720

As shown in FIG. 28, with regard to the positioning information management server 700, the transmitter activation ID management table 720 is initialized in advance. Specifically, in the description of this embodiment, in FIG. 28, a record 2802 is stored into the transmitter activation ID management table 720 in advance, and the large area position ID(=“10000”), the local position ID(=“0001”), and the transmitter variable ID(=“xyz”) are set for element data constituting the record in advance. The record 2802 is a record for storing an initial value of the transmitter variable ID required for activation of the positioning information transmitter, which means that “a positioning information transmitter is prepared and a transmitter variable ID 224 in the storage device 220 of the positioning information transmitter is initialized by the transmitter variable ID of the record 2802, and furthermore, the positioning information transmitter is installed at an installation position designated by the information pair of the large area position ID and the local position ID.”

[Pre-Processing 4] Initialization Process of the Transmitter Activation Request Management Table 620

As shown in FIG. 28, with regard to the transmitter activation terminal 600, the transmitter activation request management table 620 is initialized in advance. Specifically, in the embodiment of the present invention, in FIG. 28, a record 2801 is stored into the transmitter activation request management table 620 in advance, and the large area position ID(=“10000”), the local position ID(=“0001”), and the transmitter variable ID(=“xyz”) are set for element data constituting the record in advance. The record 2801 is downloaded from the record 2802 of the transmitter activation ID management table in the positioning information management server 700 and is stored in advance. In the actual installation of a positioning information transmitter, a plurality of records are stored into the transmitter activation request management table 620 in advance, an installation technician selects a record corresponding to the installation place, and proceeds with the installation work through a procedure of using the stored information of this record and activating the positioning information transmitter.

In the above description, note that the “transmitter fixed ID” of the record 2801 of the transmitter activation request management table 620 and the “transmitter fixed ID” of the record 2802 of the transmitter activation ID management table 720 are not set yet. This is because the value of the “transmitter fixed ID” cannot be obtained until the positioning information transmitter installed at the actual installation place is selected and activated in “(2) activation and installation work of a positioning information transmitter” to be described later. Now the description of “(1) design and initialization work of the installation place of a positioning information transmitter” is completed.

(2) Activation and Installation Work of a Positioning Information Transmitter

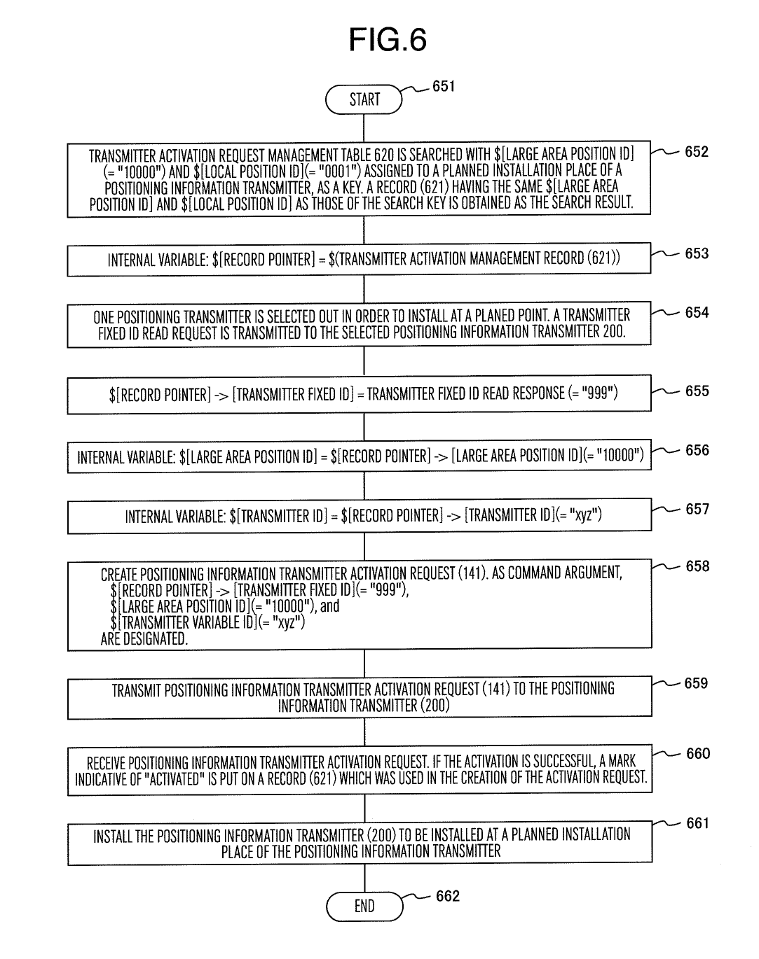

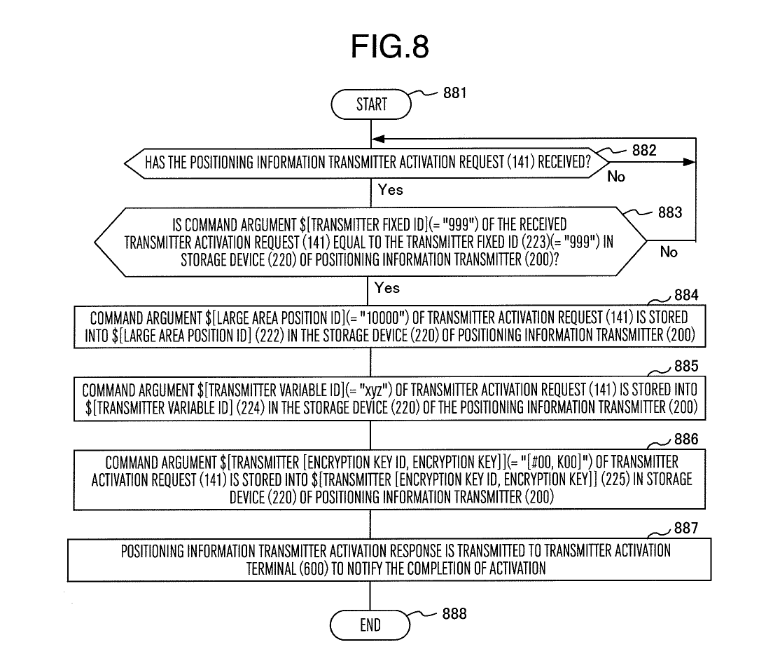

“(2) Activation and installation work of a positioning information transmitter” which is the second main work is described using FIG. 1, FIG. 2, FIG. 6, FIG. 8, and FIG. 30. In this work, the transmitter activation process 610 in the transmitter activation terminal 600 is started to activate the positioning information transmitter 200, and the activated positioning information transmitter 200 is installed at a predetermined installation position. The information about the activated and installed positioning information transmitter 200 is stored into the transmitter activation terminal 600, and is registered in the positioning information management server 700 through the “registration work of an installed positioning information transmitter” to be described later.

The sequence of the description of this work is shown below. First, the positioning information transmitter 200 on the activated side is described. Specifically, the configuration of the positioning information transmitter 200 is described with reference to FIG. 1 and FIG. 2, and then a process flow of the transmitter activation process (210 in FIG. 2) is described mainly with reference to FIG. 8 while referring to FIG. 1 and FIG. 2 as required. Next, the positioning information transmitter activation terminal 600 on the activating side is described. Specifically, the process flow of the transmitter activation request process 610 is described mainly with reference to FIG. 6 while referring to FIG. 1 and FIG. 2 as required.

First, the positioning information transmitter 200 which is a device on the activated side is described. First, the configuration of the positioning information transmitter 200 is described. The positioning information transmitter 200 comprises a tamper-resistant information processing unit (tamper-resistant micro computer chip) 201, a positioning information transmitter 240, and a positioning information transmitting antenna 250. As with an ordinary computer, the tamper-resistant information processing unit comprises a central information processing unit 211, an I/O device 212, and a storage device 220, and includes the same function as an ordinary computer. In the storage device 220, as with an ordinary computer, a transmitter operating system 221 is stored in advance. Other than this, a transmitter fixed ID read process 226, a transmitter activation process 210, and a transmitter variable ID concealing process 230 which are processing programs specific to the positioning information transmitter 200 are stored in the storage device 220 in advance. Furthermore, the large area position ID 222, the transmitter fixed ID 223, the transmitter variable ID 224, and a transmitter [encryption key ID, encryption key] 225, which are the fields for storing the ID information of the positioning information transmitter, are reserved in the storage device.

Next, the process and areas relevant to the activation work of the positioning information transmitter 200 are described. The transmitter fixed ID read process 226 is started by a command request (not illustrated) sent from the outside via the I/O device 212. In the transmitter fixed ID read process 226, the value of the transmitter fixed ID 223 in the storage device 220 is read and the read value is returned as the command response. Next, the transmitter activation process 210 is started by a positioning information transmitter activation request 141 which is a command request sent from the outside via the I/O device 212. In the transmitter activation process 210, the value of a command argument is stored into each field of the large area position ID 222, transmitter variable ID 224, and transmitter [encryption key ID, encryption key] 225 within the storage device 220 to carry out the activation process. Now the description of the configuration of the positioning information transmitter 200 is completed.

Next, the process flow of the transmitter activation process (210 in FIG. 2) is described mainly with reference to FIG. 8 while referring to FIG. 1 and FIG. 2 as required. In the positioning information transmitter 200, the transmitter operating system 221 receives the positioning information transmitter activation request 141 and starts the process by dispatching a command to the transmitter activation process 210 (Step 881). First, it is determined whether or not the positioning information transmitter activation request 141 has been received (Step 882). If the answer is “Yes”, then it is determined whether or not the command argument $[transmitter fixed ID](=“999”) of the received transmitter activation request 141 is equal to the transmitter fixed ID 223(=“999”) stored in the storage device 220 of the positioning information transmitter 200 (Step 883). This step is the verification process for determining whether or not the received transmitter activation request 141 is an activation request corresponding to the transmitter fixed ID read by the above-described “transmitter fixed ID read command”. This ensures the continuity of the “transmitter fixed ID read command” and the “transmitter activation command”. Moreover, in this embodiment, the fixed ID, which is stored in the positioning information transmitter through the preprocessing, is read in plain texts, and an activation request, which is included in the plain texts with the fixed ID as an argument, is generated, thereby assuring the continuity of the above-described two commands. However, in order to further increase the security of the activation process, a mechanism can be employed, in which the positioning information transmitter 200 stores an activating encryption key in place of the fixed ID and the transmitter activation terminal authenticates this activating encryption key.

Now, return to the description of the process flow of the transmitter activation process 210 shown in FIG. 8. Upon verification of the validity of the activation request command, the flow moves to the step of performing the main body portion of the activation process. First, the command argument $[large area position ID](=“10000”) of the transmitter activation request 141 is stored into $[large area position ID] 222 in the storage device 220 of the positioning information transmitter 200 (Step 884). Next, the command argument $[transmitter variable ID](=“xyz”) of the transmitter activation request 141 is stored into $[transmitter variable ID] 224 in the storage device 220 of the positioning information transmitter 200 (Step 885). Finally, the command argument $[transmitter [encryption key ID, encryption key]](=“[#00, K00]”) of the transmitter activation request 141 is stored into $[transmitter [encryption key ID, encryption key]] 225 in the storage device 220 of the positioning information transmitter 200 (Step 886). A positioning information transmitter activation response is transmitted to the transmitter activation terminal 600 to notify the completion of the activation (Step 887). The setting of the activation information of the positioning information transmitter 200 is now completed (Step 888). The state of the positioning information transmitter after completing the transmitter activation process as described above is shown in the storage device 220 of FIG. 1 and FIG. 2. Each ID value set in the views will be used in the transmitter variable ID concealing process 230 described later. Now the description of the process flow of the transmitter activation process 210 shown in FIG. 8 is completed. Furthermore, now the description of the positioning information transmitter 200 on the activated side is completed.

Next, the positioning information transmitter activation terminal 600 which is a device on the activating side is described. Specifically, the process flow of the transmitter activation request process 610 is described mainly with reference to FIG. 6 while referring to FIG. 1, FIG. 2, and FIG. 30 as required.

Prior to describing the transmitter activation process flow, assume that the positioning information transmitter is to be installed at a planned installation place (large area position ID(=“10000”), local position ID(=“0001”)). A worker in charge of the activation and installation of the positioning information transmitter prepares the initialized transmitter activation terminal 600 and positioning information transmitter 200 as described above. The transmitter activation request process 610 in the transmitter activation terminal 600 is started (Step 651 in FIG. 6). First, the transmitter activation request management table 620 is searched with $[large area position ID](=“10000”) and $[local position ID](=“0001”) assigned to “the entrance of Iroha Manufacturing Co., Ltd. on the first floor of ABC Life Insurance Marunouchi Building” (3003 in FIG. 30), which is the planned installation place of the positioning information transmitter, as a key. A record 621 having the same $[large area position ID] and $[local position ID] as those of the search key is obtained as a search result (Step 652). Hereinafter, in order to proceed with the creation of an activation command using the information of the record 621, the pointer address of the record 621 is substituted for an internal variable $[record pointer] (Step 653). One positioning information transmitter to be installed at the planned installation place is selected out. A transmitter fixed ID read request is transmitted from the transmitter activation terminal 600 to the selected positioning information transmitter 200 (Step 654). A transmitter fixed ID read response (=“999”) returned by the positioning information transmitter 200 is stored into a data element $[transmitter fixed ID] of a record indicated by $[record pointer] (Step 655).

As described above, in the present invention, in the stage of designing the planned installation place of a positioning information transmitter, the positioning information transmitter to be installed in this planned site is not identified in advance. Then, at the installation place, any positioning information transmitter 200 is selected out, the fixed ID of this positioning information transmitter is read, the activation process request 141 fit for this positioning information transmitter is created, and the activation process is performed. According to this method, there is no need to fixedly assign a positioning information transmitter to an installation place in advance, and the positioning information transmitter arbitrarily selected at an installation place can be activated and installed. On the other hand, there is also a method of activating a specific transmitter intended for a specific installation place in advance. With this method, an error, such as a mix-up of the positioning information transmitters, is likely to occur in the activation and installation work. In contrast, in the method of the present invention, because the positioning information transmitter is not fixedly assigned to an installation place in advance, an error, such as mixing up of the positioning information transmitters, will not occur and furthermore an improvement in the work efficiency is also obtained.

Next, return to the description of the process flow 610 of the positioning information transmitter activation process shown in FIG. 6. In the following, the preparation of an argument for creating the positioning information transmitter activation request is started. First, a value(=“10000”) of the data element $[large area position ID] of a record indicated by $[record pointer] is substituted for the internal variable: $[large area position ID] (Step 656). Next, a value(=“xyz”) of the data element $[transmitter variable ID] of the record indicated by $[record pointer] is substituted for the internal variable: $[transmitter variable ID] (Step 657). The positioning information transmitter activation request (141) is created using the data elements prepared in Steps 655 to 657. As the command argument,

$[record pointer]->[transmitter fixed ID](=“999”),

$[large area position ID](=“10000”), and

$[variable ID](=“xyz”)

are designated (Step 658). The created positioning information transmitter activation request 141 is transmitted to the positioning information transmitter 200 (Step 659). Next, the positioning information transmitter activation response is received. If the activation is successful, a mark indicative of “activated” is put on a non-illustrated data element $[activation process flag] of the record 621 used in the creation of the activation request, i.e., the record indicated by $[record pointer] (Step 660). Now the activation data is stored into the positioning information transmitter 200. Finally, the activated positioning information transmitter 200 is installed at the planned installation place of the positioning information transmitter (Step 661), and the positioning information transmitter activation process is completed (Step 662). Now the description on “(2) activation and installation of a positioning information transmitter” is completed.

(3) Registration Work of an Installed Positioning Information Transmitter

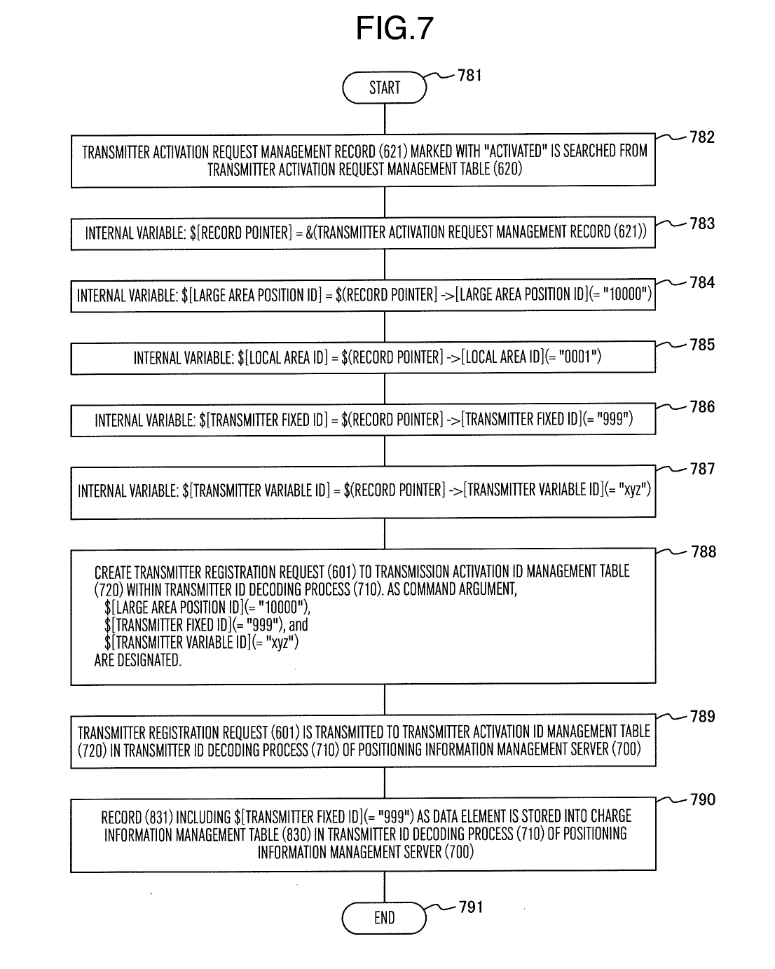

“(3) Registration work of an installed positioning information transmitter” which is the third main work is described using FIG. 1, FIG. 7, and FIG. 30. In this work, a transmitter registration process 630 in the transmitter activation terminal 600 is started, and the information on the activated and installed positioning information transmitter 200, which is stored into the transmitter activation terminal 600 as a result of performing the “activation and installation of a positioning information transmitter”, is registered in the positioning information management server 700. The registered information is used in the “positioning identifier transmission and LBS support work” described later.

A process flow of the transmitter registration process 630 to carry out this work is described mainly with reference to FIG. 7 while referring to FIG. 1 and FIG. 30 as required. The transmitter registration process 630 of the transmitter activation terminal 600 shown in FIG. 1 is started, and the process flow shown in FIG. 7 is started (Step 781). First, a transmitter activation request management record 621 which is marked with “activated” in the transmitter activation process flow 610 of FIG. 6 is searched from the transmitter activation request management table 620 (Step 782). The pointer address of the transmitter activation request management record 621 obtained as the result of this search is stored into the internal variable $[record pointer] (Step 783).

In the following, based on the activation result record which is the search result, the transmitter activation ID management table 720 of the positioning information management server 700 is searched to find out the original record of this activation result record, and ID information of the installed positioning information transmitter is stored therein. First, the data element $[large area position ID](=“10000”) of the activation result record indicated by $[record pointer] is substituted for the internal variable $[large area position ID] (Step 784). Next, the data element $[local position ID](=“0001”) of the activation result record indicated by $[record pointer]] is substituted for the internal variable $[local position ID] (Step 785). Next, the data element $[transmitter fixed ID](=“999”) of the activation result record indicated by $[record pointer] is substituted for the internal variable $[transmitter fixed ID] (Step 786). Finally, the data element $[transmitter variable ID](=“xyz”) of the activation result record indicated by $[record pointer] is substituted for the internal variable $[transmitter variable ID] (Step 787).

Based on the result information of the positioning information transmitter activation process obtained in the above, the transmitter registration request 601 to the transmitter activation ID management table 720 in the transmitter ID decoding process 710 is created. As the command argument,

$[large area position ID](=“10000”),

$[transmitter fixed ID](=“999”), and

$[transmitter variable ID](=“xyz”)

are designated (Step 788). Finally, the transmitter registration request 601 is transmitted to the transmitter activation ID management table 720 in the transmitter ID decoding process 710 of the positioning information management server 700 (Step 789). As a result of this command request, the record 721 is registered in the transmitter activation ID management table 720 of FIG. 1. If the record 721 of FIG. 1 is compared with the record 2802 of the transmitter activation ID management table 720 prior to carrying out the transmitter activation work shown in FIG. 28, then $[transmitter fixed ID] is to be determined in the record 2802 while in the record 720, “999” is already stored. The transmitter fixed ID “999” is nothing but $[transmitter fixed ID] 223 stored in the storage device 220 of the positioning information transmitter 200 which has been read via the transmitter activation terminal 600 and been set. Now, a value is set to each data element of the transmitter activation ID management table 720, so that the later-described “positioning information transmission and LBS support work” is possible. Finally, a record 831 including $[transmitter fixed ID](=“999”) as the data element is stored into the charge information management table 830 in the transmitter ID decoding process 710 of the positioning information management server 700 (Step 790).

Now the transmitter registration process 630 is completed (Step 791), and the description of “(3) registration work of an installed positioning information transmitter” is completed.

(4) Positioning Information Concealing and Positioning Identifier Transmitting Work

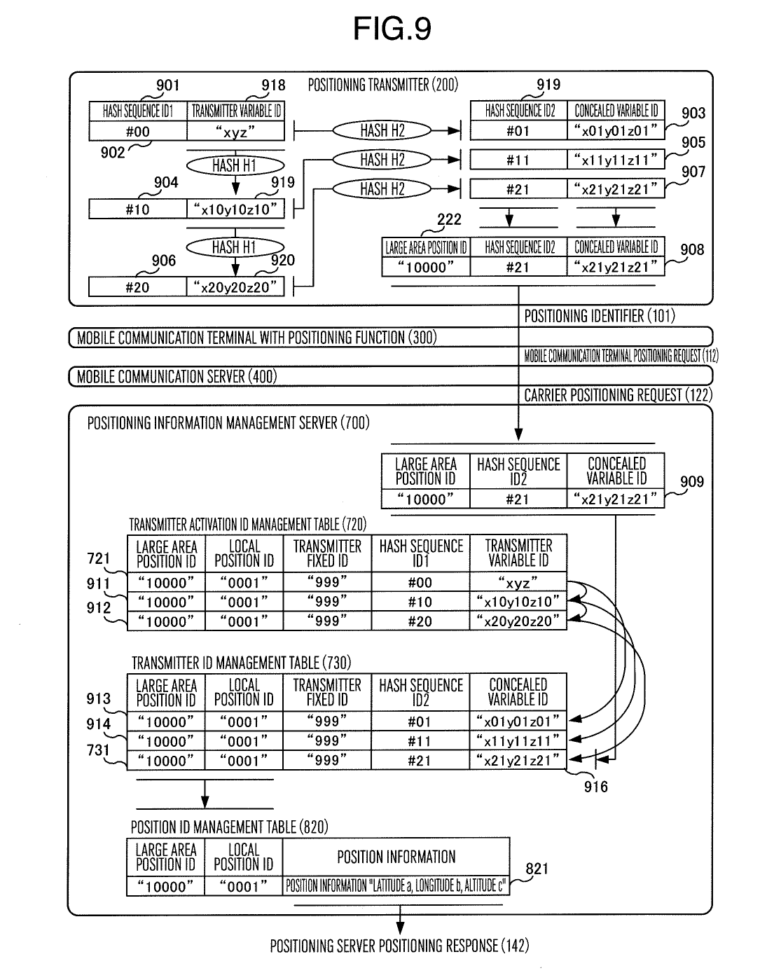

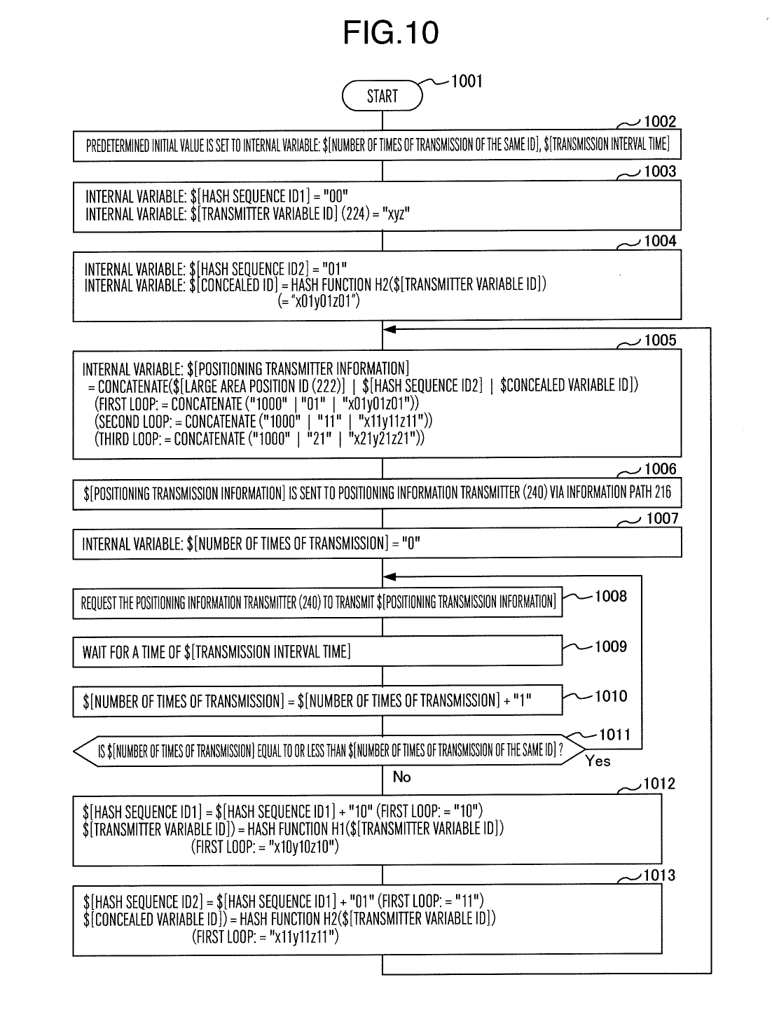

“(4) Positioning information concealing and positioning identifier transmitting work” which is the fourth main work is described using FIG. 1, FIG. 2, FIG. 9, and FIG. 10. In this work, the positioning information transmitter 200 transmits positioning information called the positioning identifier 101. The transmitted positioning identifier 101 is received by the mobile communication terminal provided with a positioning function 300, and then “(5) positioning identifier reception and LBS work” describe later is performed.

This work is described in detail. Specifically, the process flow of the variable ID concealing process (230 in FIG. 1 and FIG. 2) is described mainly with reference to FIG. 10 while referring to FIG. 9 as required. After completing the activation process, the positioning information transmitter starts the variable ID concealing process 230 in order to transmit the positioning identifier (Step 1001). First, a predetermined initial value is set to the internal variable $[number of times of transmission of the same ID] and $[transmission interval time], respectively. $[number of times of transmission of the same ID] indicates how many times the positioning information transmitter repeatedly transmits a positioning identifier with the same content, i.e., the repeat count. Moreover, $[transmission interval time] indicates a time interval in the repetition of the transmission of the positioning identifier. Next, an internal variable for storing the transmitter variable ID value is prepared. This variable ID value is generated with two hash functions H1 and H2 connected in series. First, as the storage area for a hash value in the first stage, the internal variable $[transmitter variable ID] (918 in FIG. 9) is prepared, and the initial value: $[transmitter variable ID] 224(=“xyz”) is set thereto. Furthermore, for the purpose of numbering this hash value, $[hash sequence ID1] (901) of the internal variable is prepared, and the initial value: “00” (902) is set to $[hash sequence ID1] (901) (Step 1003). Next, as the storage area for a hash value in the second stage which is generated with the hash value in the first stage as an input, an internal variable $[concealed variable ID] (903) is prepared, and an initial value: hash function H2($[transmitter variable ID])(=“x01y01z01”) is stored therein. Furthermore, for the purpose of numbering this hash value, $[hash sequence ID2] (919) of the internal variable is prepared, and the initial value: “01” is set thereto (Step 1004).

Now that the inputs to the hash functions H1 and H2 are determined, hereinafter the flow moves to the step of generating the positioning identifier. $[positioning transmission information] (908) of the internal variable is prepared, and a result data obtained by concatenating the following element data using a concatenate function Concatenate is substituted for $[positioning transmission information] (Step 1005). Concatenate($[large area position ID] (222)|$[hash sequence ID2]|$[concealed variable ID])

Specifically, in the first loop, Concatenate(“1000”|“01”|“x01y01z01”) is substituted. The generated $[positioning transmission information] (908) is sent to the positioning information transmitter 240 via an information path 216 (Step 1006).

Hereinafter, the flow moves to the actual positioning information transmission process. First, $[number of times of transmission] of the internal variable is reserved, and the initial value “0” is stored therein (Step 1007). Next, transmission of $[positioning transmission information] is requested to the positioning information transmitter 240 (Step 1008). Once this step is performed, a positioning identifier is transmitted (101). After the transmission, the system waits for a time of $[transmission interval time] (Step 1009). $[number of times of transmission] is incremented by “1” (Step 1010). It is determined whether or not $[number of times of transmission] has reached $[number of times of transmission of the same ID] (Step 1011). If not reached yet, the flow returns to Step 1008, where the transmission of the same $[positioning transmission information] is repeated. If it has reached the specified number of times of transmission, the flow proceeds to Step 1012.

In Step 1012, $[positioning transmission information] is updated for the next positioning identifier transmission. First, the hash value in the first stage is updated. Specifically, a hash value: the hash function H1($[transmitter variable ID]) 919(=“x10y10z10”) is substituted for $[transmitter variable ID] (918 in FIG. 9). Furthermore, an update value: $[hash sequence ID1]+“10”(=“10”) (904) is set to $[hash sequence ID1] (901) which is the numbering of this hash value (Step 1012). Next, as the hash value in the second stage which is generated with the hash value in the first stage as an input, the hash function H2($[transmitter variable ID])(=“x11y11z11”) is stored into $[concealed variable ID] (905). Furthermore, an update value: $[hash sequence ID1]+“01”(=“11”) (905) is set to $[hash sequence ID2] (919) which is the numbering of this hash value (Step 1013). Now that the new concealed variable ID(=“x11y11z11”) and the hash sequence ID2(=“11”) are generated, the flow returns to Step 1005 to update $[positioning transmission information]. Specifically, in the second loop, Concatenate(“1000”|“11”|“x11y11z11”) is generated as the concatenate function output, and is substituted for $[positioning transmission information] (908 in FIG. 9). Similarly, in the third loop, Concatenate(“1000”|“21”|“x21y21z21”) is generated as the concatenate function output, and is substituted for $[positioning transmission information] (908 in FIG. 9).

As described above, in this process, a routine is repeated in which the same positioning transmission information is repeatedly transmitted a certain number of times and thereafter the positioning transmission information is updated and the updated positioning transmission information is repeatedly transmitted. This update process follows a predetermined secret procedure, so that for an outside party the positioning transmission information is the concealed information which varies with time. Now the description of the variable ID concealing process 230 performed by the positioning information transmitter 200 is completed. Moreover, “(4) positioning information concealing and positioning identifier transmitting work” is completed.

(5) Positioning Identifier Reception and LBS Work

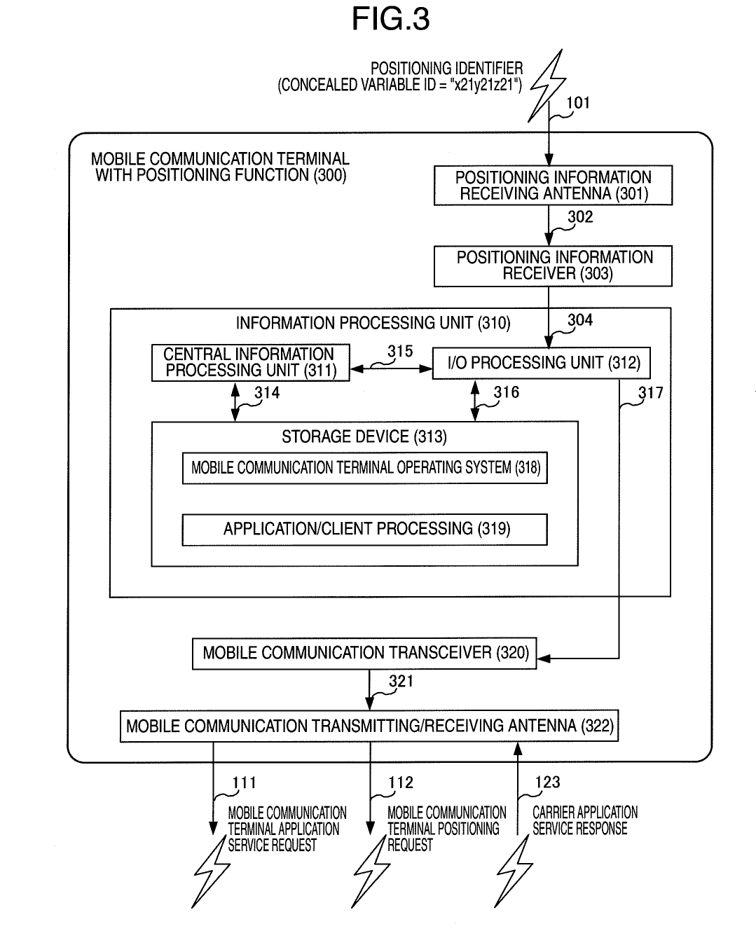

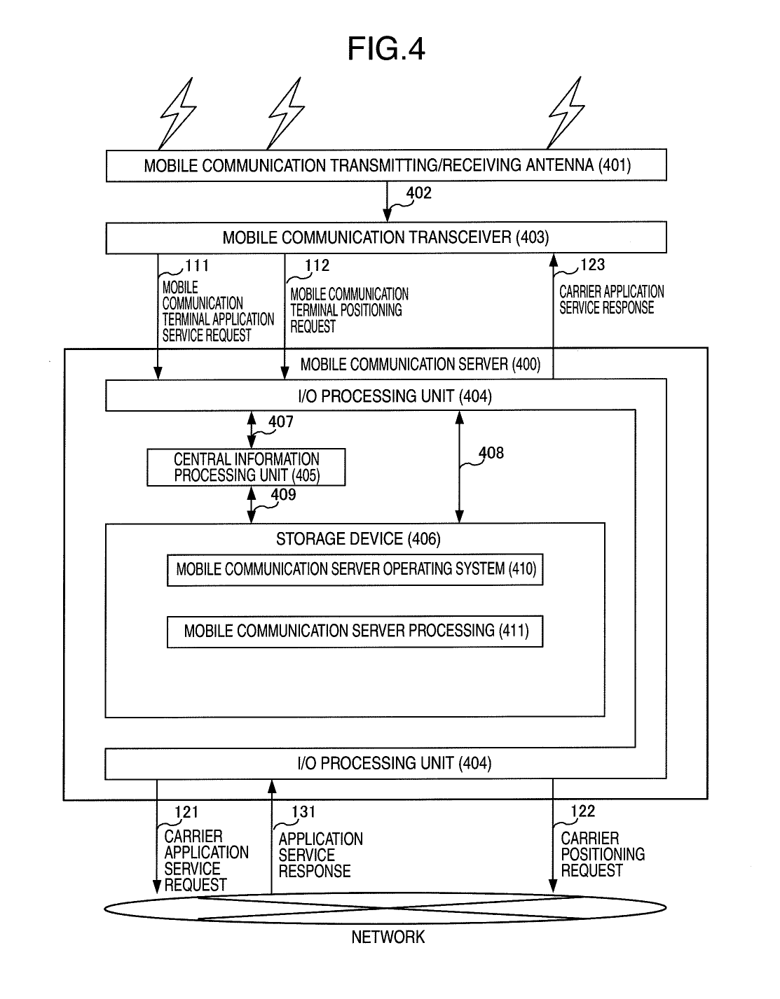

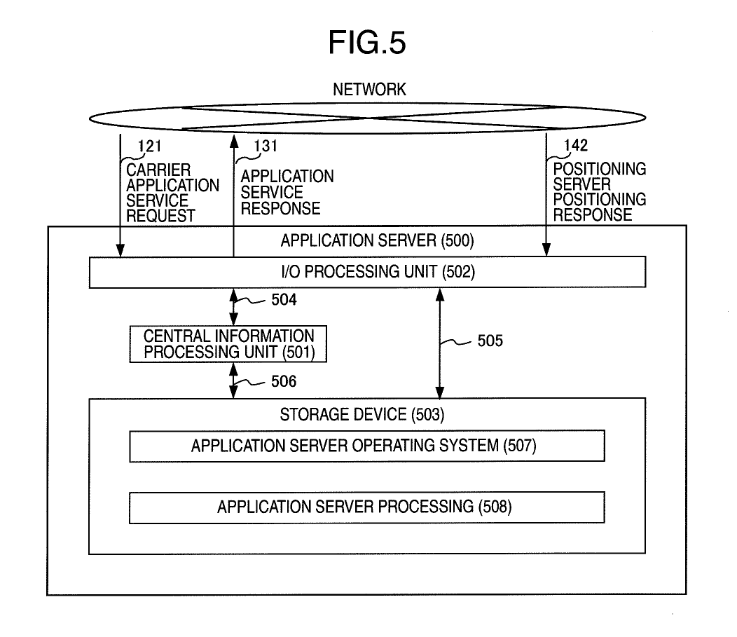

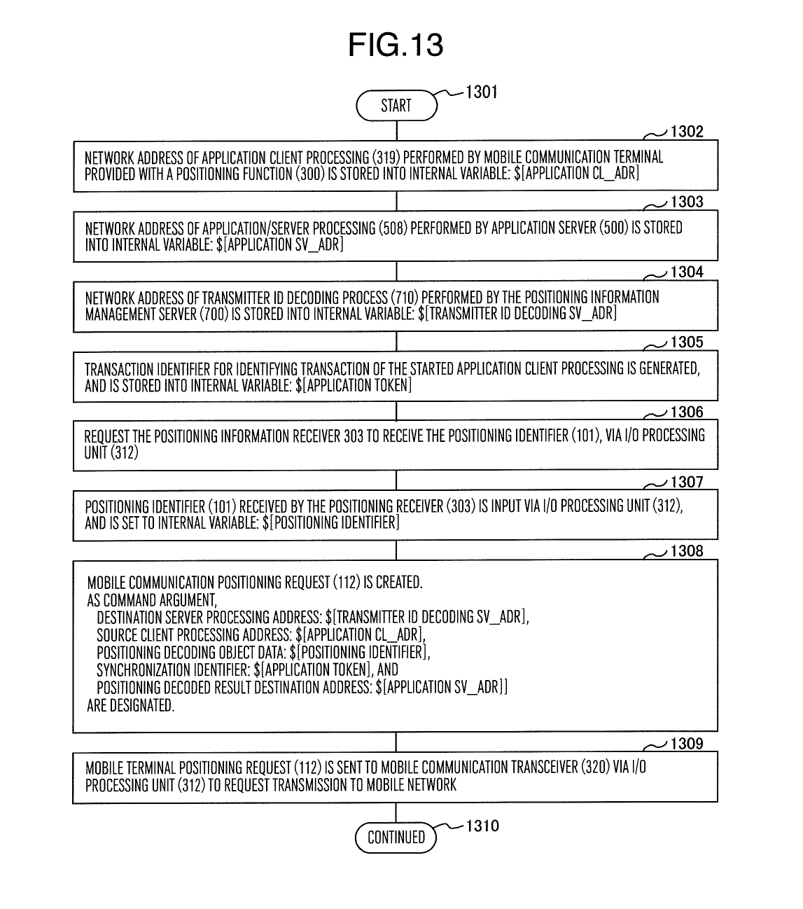

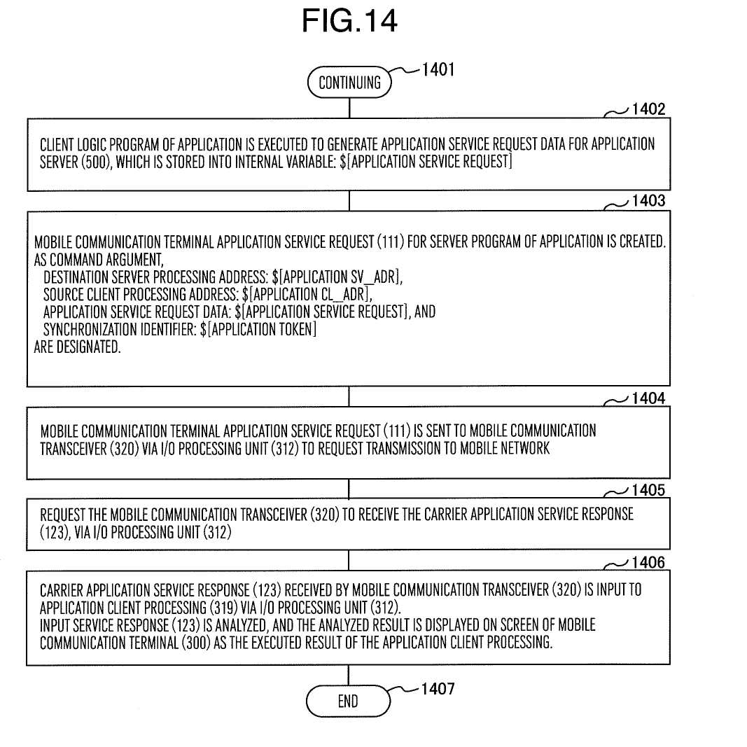

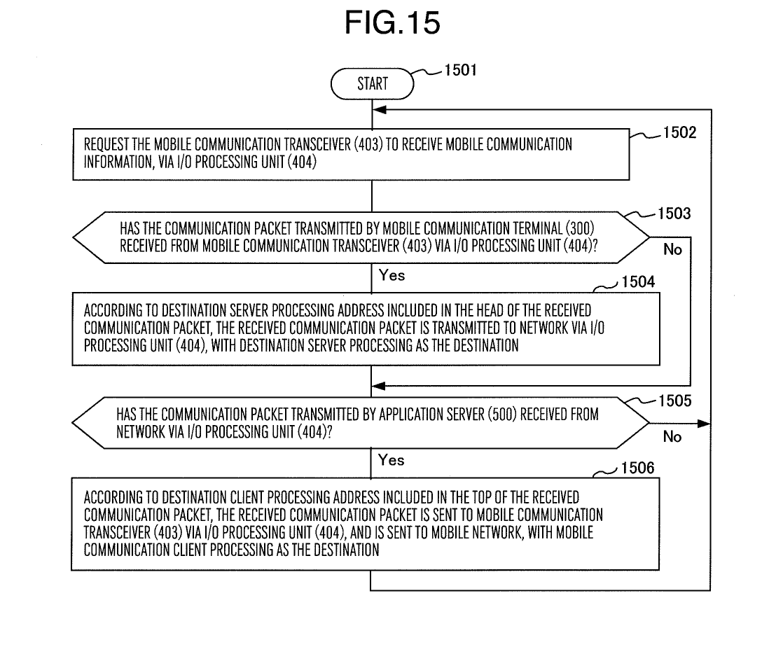

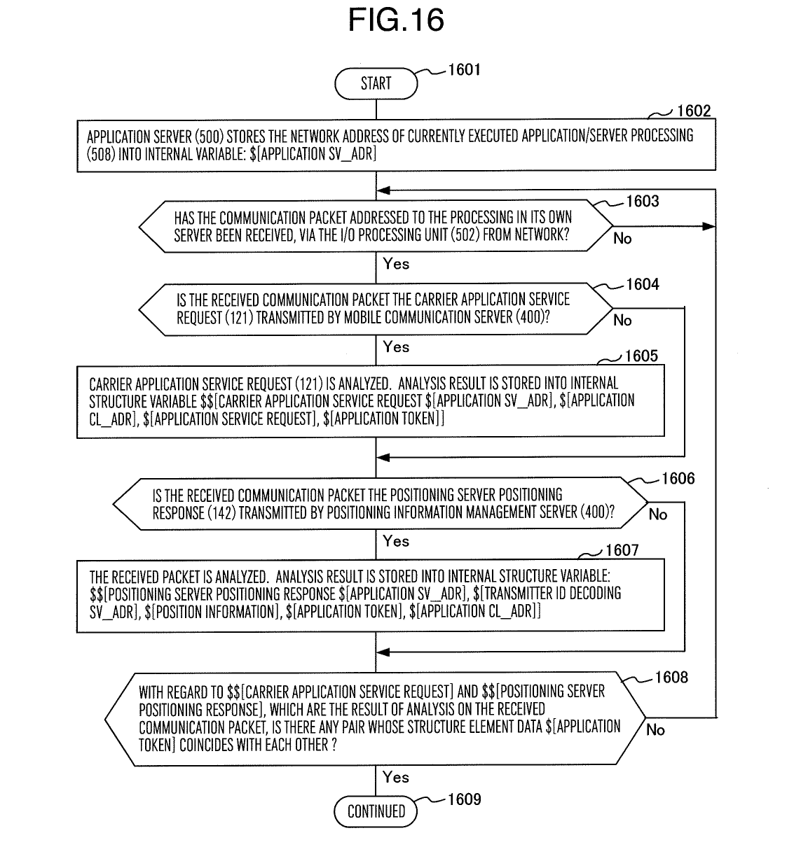

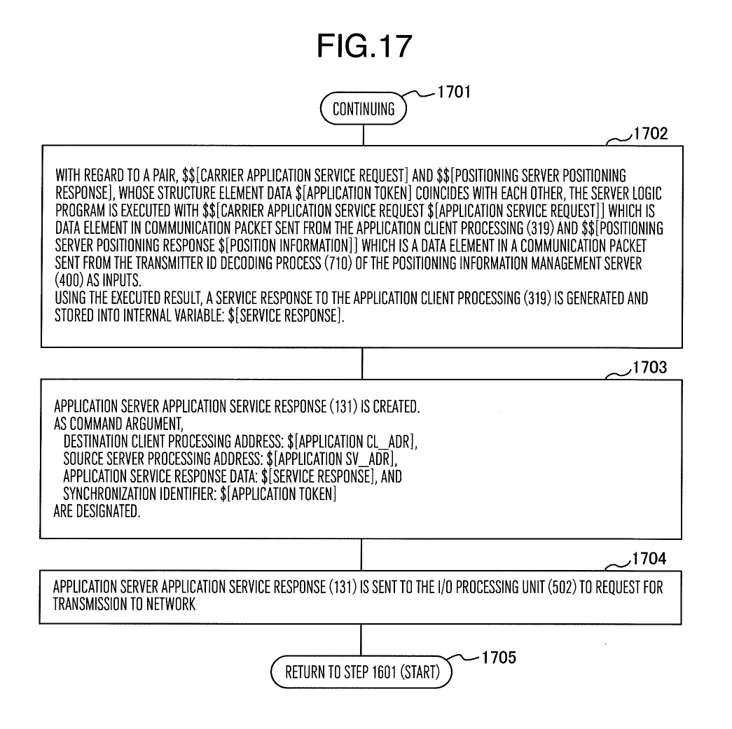

“(5) Positioning identifier reception and LBS work” which is the fifth main work is described using FIG. 1, FIG. 3, FIG. 4, FIG. 5, FIG. 9, FIG. 13, FIG. 14, FIG. 15, FIG. 16, and FIG. 17. This work extends over a plurality of system modules and is lengthy and complicated. Then, sub-works constituting this work and the works relevant to this work are enumerated with reference to FIG. 1, and while following this flow, this work is described in the units of sub-work.

Sub-Work Segments and its Sequence

[1] First, the mobile communication terminal provided with a positioning function 300 executes a client program of a positioning information service which is an application service.

[2] The mobile communication terminal 300 receives a positioning identifier transmitted by the positioning information transmitter 200.

[3] Next, the mobile communication terminal 300 transmits a mobile terminal positioning request 112, which is a request to decode the received positioning identifier 101, to the positioning information management server 700. The request 112 is converted into a carrier positioning request 122 via the mobile communication server 400, and is transmitted to the positioning information management server 700.

[4] Furthermore, a mobile communication terminal application service request 111, which is a request from the client side of the positioning information service, is converted into a carrier application service request 121 via the mobile communication server 400, and is transmitted to the application server 500.

[5] Then, the carrier positioning request 122 is subjected to a decoding process by the positioning information management server 700, is converted into position information 821, and is sent to an application service server 500 as a positioning server positioning response 142. In addition, because this sub-work is the same as the above-described main work (6), the detail will not be described in the description of this sub-work. Instead, the detail is described in the main work (6).

[6] The application service server 500 receives the carrier application service request 121 and positioning server positioning response 142 described above, performs the server side process of the position information service, and transmits the executed result to the network as an application server application service response 131.

[7] Finally the service response 131 is transmitted to the mobile communication terminal 300 as the carrier application service response via the mobile communication server 400.

Now the brief description of the sub-work is completed. In the following, each sub-work of the above [1] to [5], and [7] will be described in detail. The sub-work [6] will be described later.

[1] The sub-work, in which the mobile communication terminal provided with a positioning function 300 executes a client program of the position information service which is an application service, is described using FIG. 3, FIG. 13, and FIG. 14.

Prior to the description of the program, the configuration of the mobile communication terminal provided with a positioning function 300 is described with reference to FIG. 3. The mobile communication terminal provided with a positioning function 300 comprises mainly three sections.

The first section comprises a positioning information receiving antenna 301 and positioning information receiver 303 for receiving the positioning identifier 101 from the positioning information transmitter 200. The positioning receiver 303 is connected to an I/O processing unit 312 of the later-described information processing unit 310 via a data path 304.

The second section comprises a mobile communication transmitting/receiving antenna 322 and a mobile communication transceiver 320 for transmitting/receiving data to/from the mobile communication server 400. The mobile communication transceiver 320 is connected to the later-described I/O processing unit 312 of the information processing unit 310 via a data path 317.

The third section is the information processing unit 310 with the same function as that of an ordinary computer. The information processing unit 310, as with an ordinary computer, comprises a central processing unit 311, an I/O device 312, and a storage device 313. A mobile communication terminal operating system 318 is stored in the storage device 313 in advance as with an ordinary computer. Other than this, an application client processing 319 which is a processing program specific to the mobile communication terminal 300 is stored in the storage device 313 in advance. Now the description of the configuration of the mobile communication terminal provided with a positioning function 300 is completed.

Next, the process flow of the application client processing 319 is described with reference to FIG. 13 and FIG. 14. The client processing 319 is started, and is performed by the central processing unit 311 (Step 1301). First, a parameter group used to generate the later-described mobile communication request is initialized. The network address of the application client processing 319 performed by the mobile communication terminal provided with a positioning function 300 is stored into $[application CL_ADR] of the internal variable (Step 1302). Next, the network address of an application server processing 508 performed by the application server 500 is stored into $[application SV_ADR] of the internal variable (Step 1303). Next, the network address of a transmitter ID decoding process 710 performed by the positioning information management server 700 is stored into $[transmitter ID decoding SV_ADR] of the internal variable (Step 1304). Now the initialization process with regard to the network addresses for communication is completed.

Next, a transaction identifier for identifying transaction of the started application client processing 319 is generated, and is stored into $[application token] of the internal variable (Step 1305).

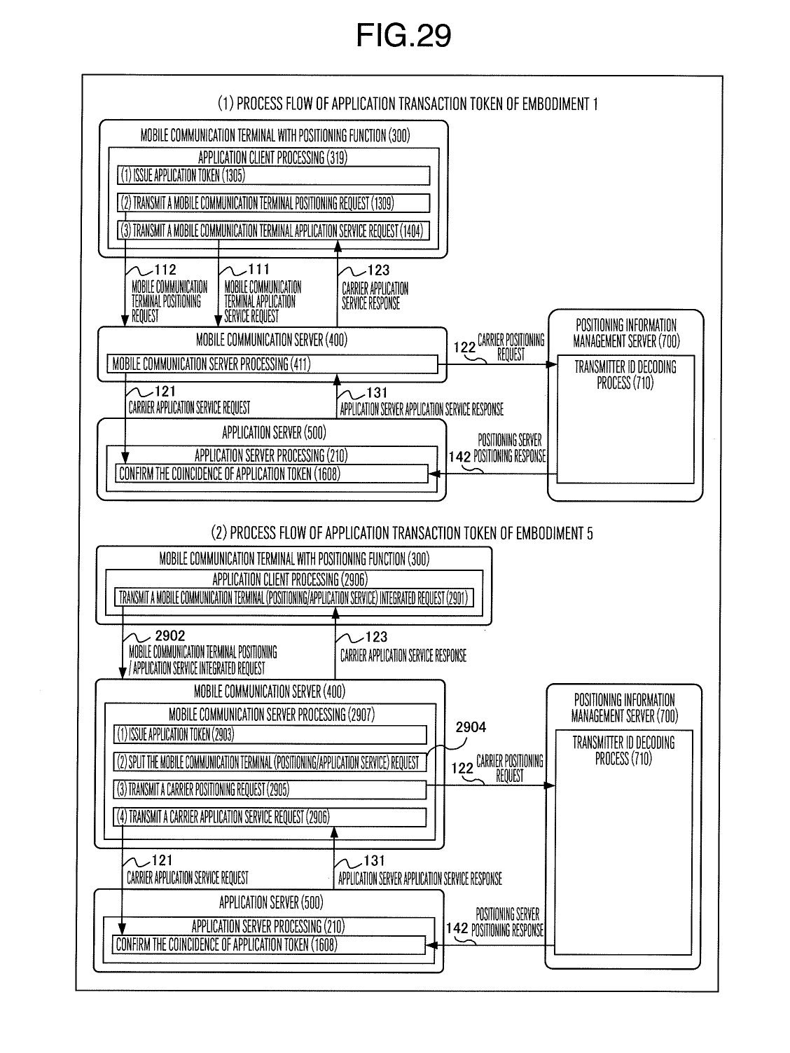

Here, the need for the transaction identifier is described using FIG. 29(1). As shown in FIG. 29, the application client processing 319 includes two main logic processings, and in each processing, one request is sent to the outside. The first processing is a mobile terminal positioning request (112 in Step 1309) which is generated by the mobile communication terminal 300 based on the positioning identifier 101 received from the positioning information transmitter 200. The request in Step 1309 is intended to acquire position information (latitude, longitude, altitude, etc.) by decoding the positioning identifier. The other processing is the application service (LBS) request (111 in Step 1404) for the application server 500 which is generated by performing a client logic program (not illustrated) of the application (LBS) utilizing the position information obtained in the above-described decoding. There is a dependency relationship between these two processings, wherein the latter application service request uses the processing result of the former positioning request. When considering these two logic processings, the simplest process flow is given as follows.

i) The mobile communication terminal 300 transmits the positioning request 112.

ii) The mobile communication server 400 converts the positioning request 112 into the carrier positioning request 122, and transmits the carrier positioning request 122 to the positioning information management server 700.

iii) The positioning information management server 700 transmits a positioning server positioning response.

iv) The mobile communication server 400 converts the positioning server positioning response into a carrier positioning response, and transmits the carrier positioning response to the mobile communication terminal 300.

v) The mobile communication terminal 300 transmits the terminal application service request 111 using the carrier positioning response.

vi) The mobile communication server 400 converts the terminal application service request 111 into the carrier application service request 121, and transmits the carrier application service request 121 to the application server 500.

vii) The application server 500 transmits the server application service response 131.

viii) The mobile communication server 400 converts the server application service response 131 into a carrier application service response 123, and transmits the carrier application service response 123 to the mobile communication terminal 300.

As shown above, in the simplest implementation, the number of times of communication between the client and the server is eight, and the data processing and communication processing of the client and server are serially performed. In contrast, in the first embodiment of the present invention shown in FIG. 29(1), the positioning server positioning response of (iii) is not sent to the mobile communication terminal 300, but is sent to the application server 500. With this, as shown in FIG. 29(1), the number of times of communication between the client and the server can be reduced to seven. Moreover, because the data processing and communication processing of the client and server can be performed in parallel, the whole processing time can be reduced. Now the description using FIG. 29(1) with regard to the need for the transaction identifier is completed.

Now, return to the description of the process flow of the application client processing 319 shown in FIG. 13.

[2] The sub-work in which the mobile communication terminal provided with a positioning function 300 receives the positioning identifier transmitted by the positioning information transmitter 200 is described using FIG. 3, FIG. 13, and FIG. 14.

First, in the application client processing 319, a request is issued via the I/O processing unit 312 to the positioning information receiver 303 to receive the positioning identifier 101 (Step 1306). Next, the positioning identifier 101 received by the positioning receiver 303 is input via the I/O processing unit 312, and is set to $[positioning identifier] of the internal variable (Step 1307). Here, in the example of FIG. 3, the concealed variable ID=“x21y21z21” is received, and is stored into $[positioning identifier].

[3] Next, the mobile communication terminal provided with a positioning function 300 transmits the mobile terminal positioning request 112, which is the request to decode the received positioning identifier 101, to the positioning information management server 700. First, the mobile terminal positioning request 112 is created. As the command argument,

destination server processing address: $[transmitter ID decoding SV_ADR],

a source client processing address: $[application CL_ADR],

a positioning decoding object data: $[positioning identifier](=“x21y21z21”),

a transaction identifier: $[application token], and

a positioning decoded result destination address: $[application SV_ADR]]

are designated (Step 1308). Next, the mobile terminal positioning request 112 is sent to the mobile communication transceiver 320 via the I/O processing unit 312 to request transmission to the mobile network (Step 1309). The mobile terminal positioning request 112 is converted into the carrier positioning request 122 and transmitted to the positioning information management server 700 via the mobile communication server 400.

Here, the configuration of the mobile communication server 400 and the process flow of a mobile communication server processing 411 are described using FIG. 4 and FIG. 15. The configuration of the mobile communication server 400 is shown in FIG. 4. The mobile communication server 400 comprises mainly two sections.

The first section is the mobile communication transmitting/receiving antenna 401 and mobile communication transceiver 403 for transmitting/receiving data to/from the mobile communication terminal 300. The mobile communication transceiver 403 is connected to the I/O processing unit 404 of the later-described mobile communication server 400 via the data paths 111, 112, and 123.

The second section is the mobile communication server 400 including the same function as that of an ordinary computer. The mobile communication server 400, as with an ordinary computer, comprises a central processing unit 405, an I/O device 404, and a storage device 406. A mobile communication server operating system 410 is stored in the storage device 406 in advance, as with an ordinary computer. Other than this, a mobile communication server processing 411 which is a processing program specific to the mobile communication server 400 is stored in the storage device 406 in advance. Now the description of the configuration of the mobile communication server 400 is completed.

Next, the process flow of the mobile communication server processing 411 is described with reference to FIG. 15. First, a request is issued via the I/O processing unit 404 to the mobile communication transceiver 403 to receive mobile communication information (Step 1502). Next, it is determined whether or not a communication packet transmitted by the mobile communication terminal 300 has been received from the mobile communication transceiver 403 via the I/O processing unit 404 (Step 1503). If the mobile communication packet has been received, the mobile communication packet processing is performed. That is, according to a destination server processing address included in the top of a received communication packet, the received communication packet is transmitted to the network via the I/O processing unit 404 with the destination server processing as the destination (Step 1504). If the mobile communication packet has not been received yet, the presence of absence of a communication packet from the network is determined. That is, it is determined whether or not the communication packet transmitted by the application server 500 has been received from the network via the I/O processing unit 404 (Step 1505). If the communication packet from the network has been received, the communication packet processing is performed. That is, according to the destination client processing address included in the top of the received communication packet, the received communication packet is sent to the mobile communication transceiver 403 via the I/O processing unit 404, and is sent to the mobile network with the mobile communication client processing as the destination (Step 1506). If the communication packet from the network has not been received yet, then the flow returns to Step 1502 and the determination of whether or not the mobile communication information has been received is repeated. As described above, the mobile communication server 400 is located between the mobile network and the ordinary backbone network, and plays a role to deliver the communication packet. Now the description of the mobile communication server 400 is completed.

Now, return to the description of the application client processing 319 shown in FIG. 13 and FIG. 14.

[4] Next, the sub-work with regard to the transmission of the mobile communication terminal application service request 111, which is a request from the client side of the position information service, is described. The process flow of the application client processing 319 continues from Step 1310 of FIG. 13 to Step 1401 of FIG. 14. First, a client logic program (not illustrated) of the application is executed to generate application service request data for the application server 500, which is stored into $[application service request] of the internal variable (Step 1402). In the next step, the mobile communication terminal application service request 111 to the server program of the application is created. As the command argument,

the destination server processing address: $[application SV_ADR],

the source client processing address: $[application CL_ADR],

the application service request data: $[application service request], and

the transaction identifier: $[application token]

are designated (Step 1403). In the next step, the created mobile communication terminal application service request 111 is sent to the mobile communication transceiver 320 via the I/O processing unit 312 to request transmission to the mobile network (Step 1404). After transmitting the mobile communication terminal application service request 111, the application client processing 319 moves to a step of waiting for a response of the application server processing 508 with respect to the request 111. Here, 6) the detailed description on the server side process (i.e., the application server processing) with respect to the mobile communication terminal application service request 111 sent to the mobile network and on the server configuration is described later, and the description of the process flow of the application client processing 319 continues.

In the application client processing 319, a request is issued via the I/O processing unit 312 to the mobile communication transceiver 320 to receive the carrier application service response 123 (Step 1405).

[7] Here, the sub-work [7] is described prior to the sub-work processings [5], [6]. The carrier application service response 123 which is the executed result of the server side process corresponding to the request is received by the mobile communication transceiver 320, and is input to the application client processing 319 via the I/O processing unit 312. In the client processing 319, the input service response 123 is analyzed, and is displayed on a screen of the mobile communication terminal 300 as the executed result of the application client processing (Step 1406). Now the process flow of the application client processing 319 is completed (Step 1407). Now the description of the process flow of the application client processing 319 with reference to FIG. 14 is completed.

[6] Next, with regard to the server side process corresponding to the mobile communication terminal application service request 111 sent to the mobile network, as described in the procedure of the sub-work [4], the configuration of the application server 500 and the process flow of the application server processing 508 are mainly described. The mobile communication terminal application service request 111 sent to the mobile network is, via the mobile communication server 400, converted into the carrier application service request 121 and sent to the backbone network, and finally received by the application server 500. The application server 500 performs the application server processing 508 with the received carrier application service request 121 (=mobile communication terminal application service request 111) as an input.

First, the configuration of the application server 500 is shown in FIG. 5. The application server 500, as with an ordinary computer, comprises a central processing unit 501, an I/O device 502, and a storage device 503. An application server operating system 507 is stored in the storage device 503 in advance, as with an ordinary computer. Other than this, the application server processing 508 which is a processing program specific to the application server 500 is stored in the storage device 503 in advance. Now the description of the configuration of the application server 500 is completed.

Next, the process flow of the application server processing 508 is described with reference to FIG. 16 and FIG. 17. When the application server process 508 is started, an initialization process is performed first (Step 1601). The application server 500 stores the network address of the application server processing 508 currently executed by the application server 500 itself into the internal variable: $[application SV_ADR] (Step 1602). Next, it is determined whether or not a communication packet addressed to the processing in its own server has been received via the I/O processing unit 502 from the network (Step 1603), and this determination is repeated until the communication packet has been received. If it has been received, the flow proceeds to Step 1604. In the next step, it is determined whether or not the received communication packet is the carrier application service request 121 transmitted by the mobile communication server 400, i.e., the mobile communication terminal application service request transmitted by the mobile communication terminal 200 (Step 1604). If the received communication packet is the carrier application service request 121, the received communication packet is analyzed (Step 1605). The analysis result is stored into the internal structure variable: $$[carrier application service request $[application SV_ADR], $[application CL_ADR], $[application service request], $[application token]]. If the received communication packet is not the carrier application service request 121, then it is determined whether or not the received communication packet is the positioning server positioning response 142 transmitted by the positioning information management server 400 (Step 1606). If it is the positioning server positioning response 142, the received packet is analyzed and the analysis result is stored into the internal structure variable: $$[positioning server positioning response $[application SV_ADR], $[transmitter ID decoding SV_ADR], $[position information], $[application token], $[application CL_ADR]] (Step 1607). If the above-describe steps have normally been proceeded, the carrier application service 121 and the positioning server positioning response 142 have been received.

As described above, in this embodiment, the application service request 111 and the positioning request 112 are transmitted in parallel from the mobile communication terminal so that the data processing and communication processing of the client and server can be performed in parallel and the whole processing time can be reduced. For this reason, in the application server processing 508, it is determined whether or not these communication packets are the communication packets generated and transmitted through the transaction of the same application client processing 319. Specifically, with regard to two types of structure internal variables, $$[carrier application service request] and $$[positioning server positioning response], which are the results of the analysis on the received communication packet, it is determined whether there is any pair whose element data $[application token] within the structure variable coincides with each other (Step 1608). If there is a coinciding structure variable, then two pieces of information, $[positioning information] and $[application service request] within these structure variables can be used to execute a server processing program logic of the application server processing (Steps 1609, 1701). Next, with regard to a pair of two structure internal variables, $$[carrier application service request] and $$[positioning server positioning response], in which a coincidence of the element data $[application token] is detected in Step 1608, the server logic program is executed, with $$[carrier application service request $[application service request]] which is a data element within the communication packet sent from the application client processing 319 and $$[positioning server positioning response $[position information]] which is a data element within the communication packet sent from the transmitter ID decoding process 710 of the positioning information management server 400 as inputs.

Furthermore, using the executed results, a service response to the application client processing 319 is generated, and the generated result is stored into $[service response] of the internal variable (Step 1702). Next, the application server application service response 131 is created. As the command argument,

the destination client processing address: $[application CL_ADR],

the source server processing address: $[application SV_ADR],

the application service response data: $[service response], and

the transaction identifier: $[application token]

are designated (Step 1703). Finally, the created application server application service response 131 is sent to the I/O processing unit 502 to request transmission to the network (Step 1704). Now that the response to one request from the application client processing is completed, the flow returns to Step 1601 to wait for the next request. Now the description of the process flow of the application server processing 508 is completed. In addition, the description on the configuration of the application server 500 and the process flow of the application server processing 508 is now completed.

Now the description on the “positioning identifier reception and LBS work” which is the fifth work is completed. Because this work extends over a plurality of system modules and is lengthy and complicated, seven sub-works constituting this work are enumerated and described in the units of sub-work.

(6) Positioning Identifier Decoding Work

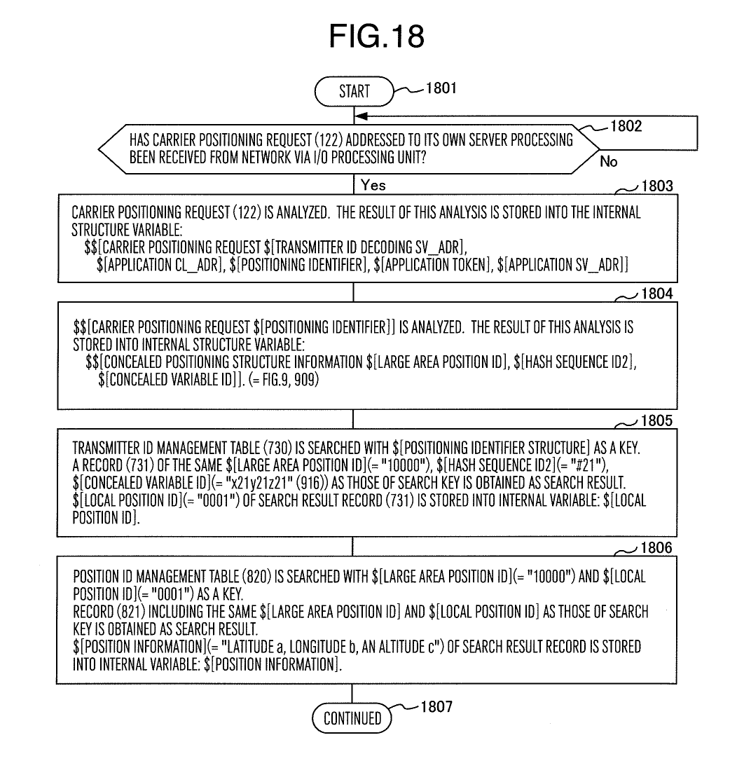

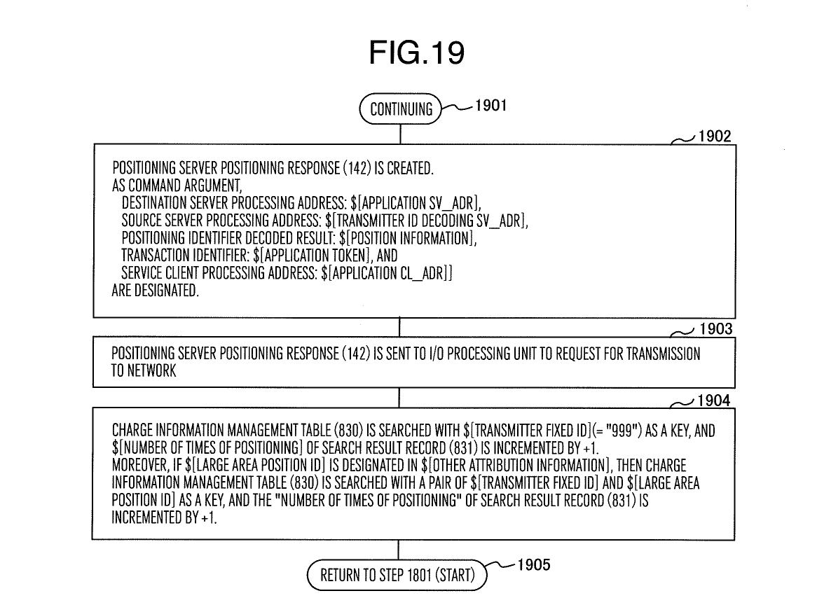

The “positioning identifier decoding work” which is the sixth main work is described using FIG. 9, FIG. 18, and FIG. 19. This work flows as follows: the positioning information management server 700 performs the positioning ID decoding process on the carrier positioning request 122, which is transmitted from the mobile communication terminal 300 and is sent via the mobile communication server 400, to generate position information which is the decoded result, and transmit the generated position information to the application server 500 as the positioning server positioning response 142.

First, in FIG. 9 (a part thereof is also illustrated in FIG. 1), the initialization state of each table of the positioning information management server 700 at a time point immediately before receiving the carrier positioning request 122 is described.

First, the record 821 of the position ID management table 820 shown in FIG. 1 or FIG. 9 is described. A value is stored into the record 821 of the position ID management table 820, in the [preprocessing 2] of “(1) design and initialization work of the installation place of a positioning information transmitter” (821 in FIG. 28).

Next, the record 721 of the transmitter activation ID management table 720 shown in FIG. 1 is described. The record 721 is the same record as the record 721 of the transmitter activation ID management table 720 of FIG. 9, and a value is stored into the [preprocessing 3] of “(1) design and initialization work of the installation place of a positioning information transmitter” (2802 in FIG. 28). However, when the [preprocessing 3] is completed, the element data “transmitter fixed ID” of the record 2802 is in a state to be determined (=“-”). This data item is set for the first time in “(3) registration work of an installed positioning information transmitter”. Specifically, in Step 788 of the transmitter registration process flow 630 of FIG. 7, $[transmitter fixed ID](=“999”) of the activated transmitter 200 is stored. As a result, the record 721 shown in FIG. 1 and FIG. 9 is determined.

Next, the rest records 911 and 912 of the transmitter activation ID management table 720 shown in FIG. 9, and the records 913, 914, and 731 of a transmitter ID management table 730 are described. These records are generated and stored by a non-illustrated initialization process in the positioning information management server 700 after the transmitter registration process 630 by the transmitter activation terminal 600 is completed. Specifically, according to the same process flow as that of the variable ID concealing process 230 in the positioning information transmitter 200, the following two hash sequences are created with the record 721 as the source, and a value is stored into each table.

i) The hash sequence ID1 and transmitter variable ID is stored into the transmitter activation ID management table 720, and

ii) The hash sequence ID2 and concealed variable ID is stored into the transmitter ID management table 730.

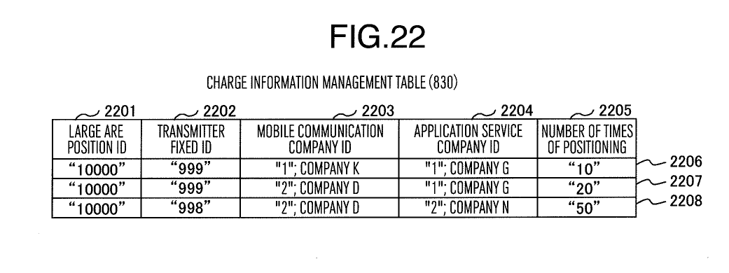

Next, the record 831 of the charge information management table 830 shown in FIG. 1 is described. The record 831 is a record corresponding to a record 2206 or 2207 of the charge information management table 830 of FIG. 22, and is stored and registered in “(3) registration work of an installed positioning information transmitter”. Specifically, in Step 790 of the transmitter registration process flow 630 of FIG. 7, the record 831 including $[transmitter fixed ID](=“999”) of the activated transmitter 200 is stored.

Now the description of the initialization state of each table of the positioning information management server 700 at a time point immediately before receiving the carrier positioning request 122 in FIG. 9 is completed.

In the following, the process flow of a positioning ID decoding process 710 in response to the carrier positioning request 122 is described with reference to FIG. 18 and FIG. 19 while referring to FIG. 9 as required. First, the positioning information management server 700 starts the transmitter ID decoding process 710 as a server service (Step 1801). First, in the transmitter ID decoding process 710, first, it is repeatedly determined whether or not the carrier positioning request 122 addressed to its own server processing has been received from the network via the I/O processing unit (Step 1802). Here, as shown in FIG. 9, the mobile communication terminal provided with a positioning function 300 receives the positioning identifier 101 transmitted by the positioning information transmitter 200. The mobile communication terminal 300 then transmits the mobile terminal positioning request 112. The mobile terminal positioning request 112 is converted into the carrier positioning request 122 via the mobile communication server 400, and reaches the positioning information management server 700. In the transmitter ID decoding process 710 of the positioning information management server 700, the received carrier positioning request 122 is analyzed. The result of this analysis is stored into the internal structure variable: $$[carrier positioning request $[transmitter ID decoding SV_ADR], $[application CL_ADR], $[positioning identifier], $[application token], $[application SV_ADR]] (Step 1803).

Furthermore, $$[carrier positioning request $[positioning identifier]] which is a data element of the internal structure variable is analyzed. The result of this analysis is stored into the internal structure variable: $$[concealed positioning structure information $[large area position ID], $[hash sequence ID2], $[concealed variable ID]] (909 in FIG. 9) (Step 1804).

Next, the transmitter ID management table (730 in FIG. 9) is searched with $[positioning identifier structure] as a key. Specifically, a record 731 having the same $[large area position ID](=“10000”), $[hash sequence ID2](=“#21”), $[concealed variable ID](=“x21y21z21” (916)] as those of the search key is obtained as the search result.

$[local position ID](=“0001”) of the search result record 731 is stored into $[local position ID] of the internal variable (Step 1805).

Next, the position ID management table 820 is searched with $[large area position ID](=“10000”) and $[local position ID](=“0001”) as a key. The record 821 having the same $[large area position ID] and $[local position ID] as those of the search key is obtained as the search result. $[position information](=“latitude a, longitude b, an altitude c”) of this search result record is stored into $[position information] of the internal variable (Step 1806). The flow continues to Step 1901 of FIG. 19 through Step 1807.

Next, the positioning server positioning response 142 is created. As the command argument,

the destination server processing address: $[application SV_ADR],

the source server processing address: $[transmitter ID decoding SV_ADR],

a positioning identifier decoded result: $[position information],

the transaction identifier: $[application token], and

a service client processing address: $[application CL_ADR]] are designated (Step 1902).

Next, the positioning server positioning response 142 is sent to the I/O processing unit to request for transmission to the network (Step 1903).

In the final Step 1904, the charge information used in (7) the positioning charge work is stored. The charge information management table 830 is searched with $[transmitter fixed ID](=“999”) (2222 in FIG. 22) as a key, and $[number of times of positioning] of the search result record 831 is incremented by +1. Moreover, if $[mobile communication company ID] 2203 or $[application service company ID] (2204) is designated in $[other attribution information] of the charge information management table 830, then the charge information management table 830 is searched with a set of information of $[transmitter fixed ID], $[mobile communication company ID], and $[application service company ID] as a key, and the “number of times of positioning” 2205 of the search result record 2206 or 2207 is incremented by +1 (Step 1904). Here, in FIG. 22, as the mobile communication company, the record 2206 or 2207 is prepared for two companies, i.e., Company K or Company D, respectively. In Embodiment 1 shown in FIG. 1, an example of a single mobile communication carrier 120 is shown.

However, as shown in FIG. 22, in cases where the positioning information management server supports a plurality of mobile communication carriers, if the number of times of positioning of a corresponding charge information management record is incremented by +1 in response to a carrier positioning request from each company, then the use state of the positioning identifier can be managed on a per carrier basis and the charging is possible.

Finally, because one transaction of the transmitter ID decoding process 710 corresponding to the carrier positioning request 122 is completed, the transmitter ID decoding process 710 returns to Step 1801 in order to wait for the next carrier positioning request (Step 1905). Now the description of the transmitter ID decoding process 710 is completed.

Now the description on “(6) positioning identifier decoding work” which is the sixth main work is completed.

(7) Charge Work of the Positioning Identifier Decoding Process

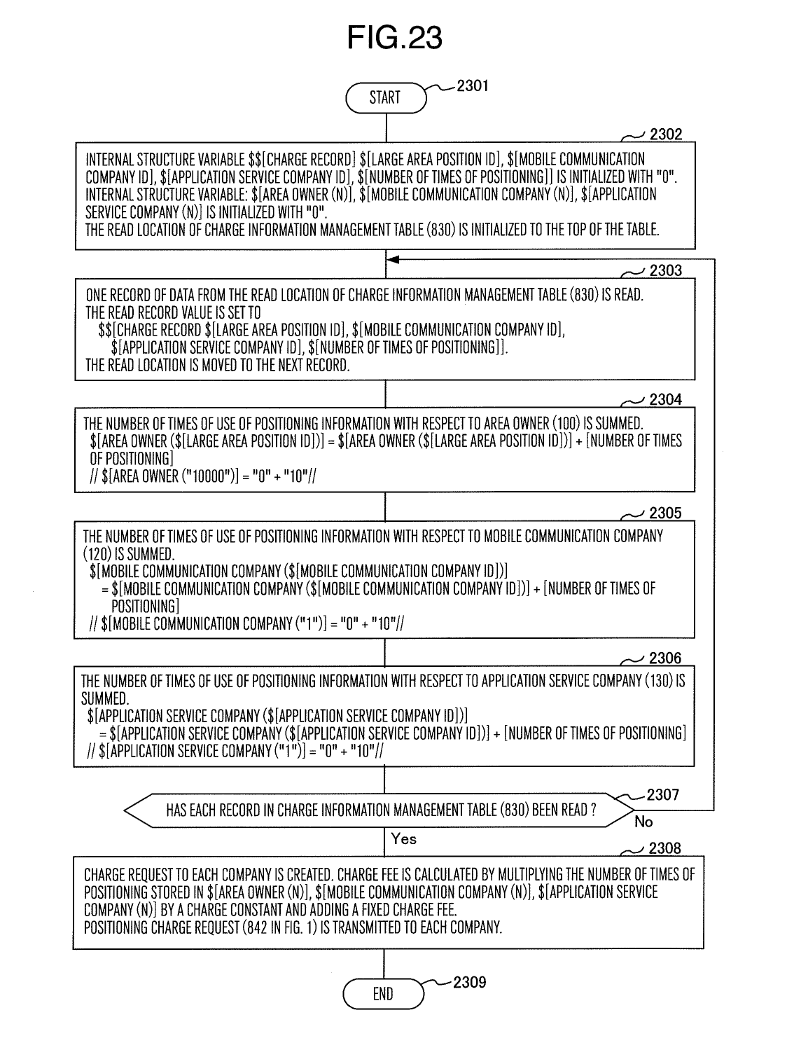

“(7) Charge work of the positioning identifier decoding process” which is the seventh main work is described with reference to FIG. 23. In this work, fair charging to each company which enjoys benefit from the positioning system is achieved with reference to the registered record of the charge information management table 830 which was prepared and registered in the decoding process in the main work (6).

This work is described in detail in accordance with the process flow of a positioning charge process 840 shown in FIG. 23. The positioning charge process 840 is started (Step 2301). In the first step, an initialization process is carried out. First, the following internal structure variable$$[charge record] is prepared:

$$[charge record $[large area position ID], $[mobile communication company ID], $[application service company ID], $[number of times of positioning]].

Each data element of the internal structure variable $$[charge record] is initialized to “0” in advance.

Furthermore, three types of internal array variables, $[area owner (N)], $[mobile communication company (N)], and $[application service company (N)] are prepared, all of which are initialized with “0”.

The read location of the charge information management table (830) is initialized to the top of the table.

Now the initialization process is completed (Step 2302) and the flow moves to the creation of charge information.

One record of data is read from a read location of the charge information management table (830). The read record value is stored into the structure variable: $$[charge record $[large area position ID], $[mobile communication company ID], $[application service company ID], $[number of times of positioning]]. The read location is moved to the next record (Step 2303).

Next, as shown below, based on the number of times of positioning of the read record, the number of times of use of positioning information with respect to the area owner 100 is summed (Step 2304).

$[area owner ($[large area position ID])]=$[owner ($[large area position ID])]+[number of times of positioning]

Specifically, when the record 2206 of FIG. 22 is read, the number of times of use of positioning information is summed and stored as follows.

$[area owner (“10000”)]=“0”+“10”

Next, as shown below, based on the number of times of positioning of the read record, the number of times of use of positioning information with respect to the mobile communication company 120 is summed (Step 2305).

$[mobile communication company ($[mobile communication company ID])]=$[mobile communication company ($[mobile communication company ID])]+[number of times of positioning]

Specifically, when the record 2206 of FIG. 22 is read, the number of times of use of positioning information is summed and stored as follows.

$[mobile communication company (“1”)]=“0”+“10”

Next, as shown below, based on the number of times of positioning of the read record, the number of times of use of positioning information with respect to the application service company 130 is summed (Step 2306).

$[application service company ($[application service company ID])]=$[application service company ($[application service company ID])]+[number of times of positioning]

Specifically, when the record 2206 of FIG. 22 is read, the number of times of use of positioning information is summed and stored as follows.

$[application service company (“1”)]=“0”+“10”

Now the summation of the number of times of use of positioning information with respect to one record of the charge information management table 830 is completed. In the next Step 2307, each record of the charge information management table 830 is read to determine whether or not the summation process has been performed. If there is any un-read record, the flows returns to Step 2303 to move to the read process of the next record. If each record has been read and the summation process is complete, the flow proceeds to the next Step 2308. In the next step, a charge request to each company is created. The charge fee is calculated by multiplying the number of times of positioning stored in $[area owner (N)], $[mobile communication company (N)], and $[application service company (N)], which are three internal array variables used for the summation of the positioning information, by a charge constant and adding a fixed charge fee. Next, the positioning charge request (842 in FIG. 1) is transmitted to each company.

Now the description of the process flow of the positioning charge process 840 is completed and the description of “(7) positioning charge work” is also completed.

Now the detailed description on the installation work and operation work of the positioning system, which is the first embodiment of the present invention, according to the above-described seven main work segments is completed.

### Embodiment 2

A positioning system which is a second embodiment of the present invention is described. The positioning system which is the second embodiment of the present invention differs from that of the first embodiment in two portions, i.e., the concealing process 230 of the transmitter variable ID of the positioning information transmitter 200 and the positioning information transmitter decoding process 710 of the positioning information management server 700. In the first embodiment, a hash function is used in the transmitter variable ID concealing process while in the second embodiment an encryption function is used to conceal the transmitter variable ID. Then, hereinafter, the feature of the second embodiment different from that of the first embodiment is described, with regard to the main works “(1) design and initialization work of the installation place of a positioning information transmitter”, “(4) positioning information concealing and positioning identifier transmitting work”, and “(6) positioning identifier decoding work” in the description of the first embodiment”.

(1) Design and Initialization Work of the Installation Place of a Positioning Information Transmitter

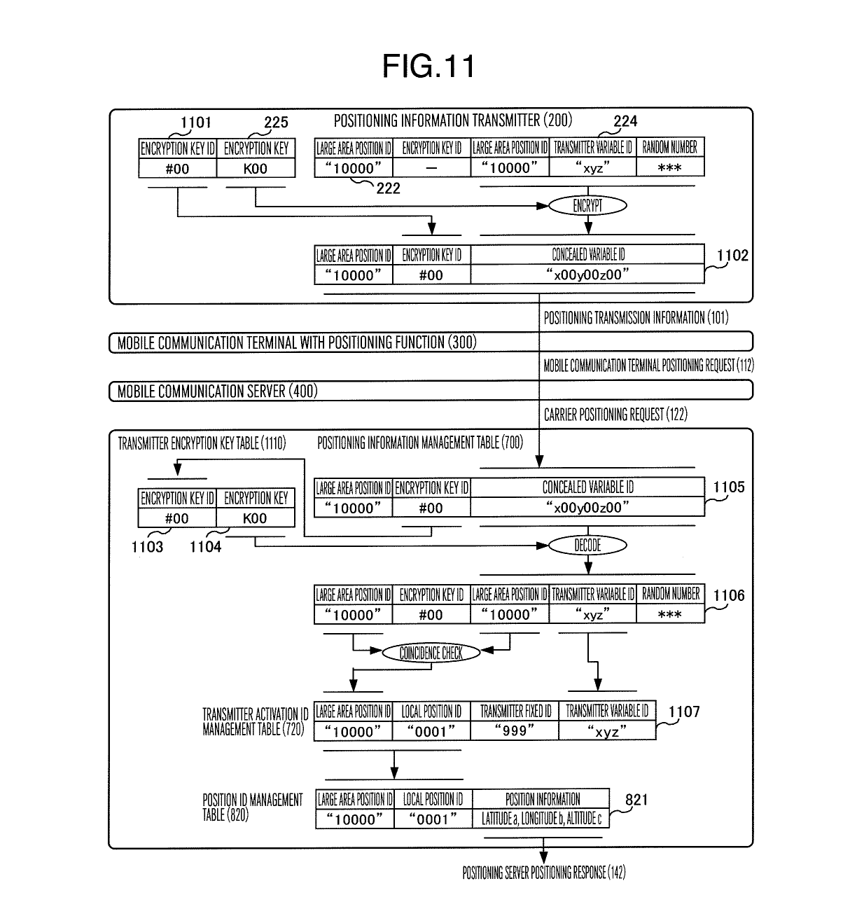

The feature in the “design and initialization work of the installation place of a positioning information transmitter” which is the first main work is described using FIG. 1 and FIG. 2. The second embodiment is characterized by a preprocessing related to the initialization of the information related to encryption.

[Pre-Processing 5] Initialization Process of $[Transmitter Encryption Key ID, Encryption Key]

$[transmitter encryption key ID, encryption key] of the positioning information transmitter 200 shown in FIG. 2 and FIG. 11 is initialized. Specifically, in the second embodiment, “00”(=#00) is set to $[encryption key ID], and “K00” is set to $[encryption key] (225 in FIG. 2 and FIG. 11). Here, the role of $[encryption key ID] is described. In preparation for cases where a plurality of positioning information transmitters use different encryption keys, $[encryption key ID] is prepared as an identification number for uniquely identifying the above-described encryption key. In the second embodiment, “00” (hereinafter, may be represented by #00) which is the identification number corresponding to the encryption key “K00” is stored into $[encryption key ID] (FIG. 11, 1101) in advance. This encryption key is used in the creation of the later-described concealed variable ID.

[Pre-Processing 6] Initialization Process of $[Encryption Key ID, Encryption Key] In the positioning information management server 700

In order to decode the positioning transmission information 101, the same information as $[transmitter encryption key ID, encryption key] set to the positioning information transmitter 200 in the [preprocessing 5] is stored into a transmitter encryption key table (1110 in FIG. 11) in the transmitter ID decoding process 710 in advance. Specifically, “00”(=#00) is stored into an encryption key ID 1103 of the positioning information transmitter encryption key table 1110, and “K00” is stored into an encryption key 1104.

(4) Positioning Information Concealing and Positioning Identifier Transmitting Work

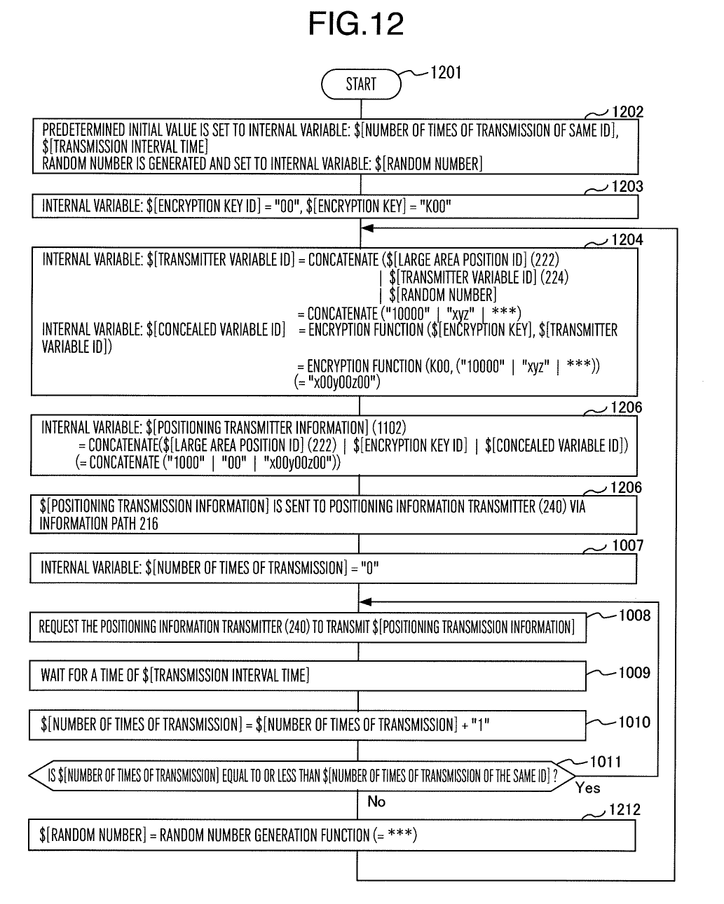

“(4) Positioning information concealing and positioning identifier transmitting work” which is the fourth main work is described using FIG. 1, FIG. 2, FIG. 11, and FIG. 12. In this work, the positioning information transmitter 200 transmits positioning information called the positioning identifier 101. The transmitted positioning identifier 101 is received by the mobile communication terminal provided with a positioning function 300, where “(5) positioning identifier reception and LBS work” is performed.

This work is described in detail. Specifically, the process flow of the variable ID concealing process (230 in FIG. 1 and FIG. 2) is described mainly with reference to FIG. 12 while referring to FIG. 11 as required. After completing the activation process, the positioning information transmitter starts the variable ID concealing process 230 in order to transmit a positioning identifier (Step 1201). First, a predetermined initial value is set to the internal variables: $[number of times of transmission of the same ID] and $[transmission interval time], respectively. Since the meaning and content of the internal variables: $[number of times of transmission of the same ID] and $[transmission interval time] are the same as those of the first embodiment, the description thereof is omitted. In the second embodiment, furthermore, an internal variable $[random number] used for the subsequent variable ID concealment is prepared and a random number value is set in advance (Step 1202).

In the next step, an internal variable $[encryption key] used for the subsequent variable ID concealment is prepared, and the encryption key “K00” initialized in the [preprocessing 5] is stored therein. Furthermore, the internal variable $[encryption key ID] (1101 in FIG. 11) for uniquely identifying the above-described encryption key is prepared, and the encryption key ID “00” (hereinafter, may be represented by #00) initialized in the [preprocessing 5] is stored therein (Step 1203).

In the second embodiment, the concealed variable ID value is generated by encrypting a combined value of $[large area position ID] (222 in FIG. 2), $[transmitter variable ID] (224 in FIG. 2), and $[random number] with $[encryption key]. Now that the encryption key is determined, the flow moves to the step of generating a positioning identifier. $[transmitter variable ID] of the internal variable is prepared, and the following element data is concatenated using the concatenate function Concatenate, and the resultant concatenated data is substituted for $[transmitter variable ID] (Step 1204).

Concatenate($[large area position ID] (222)|$[transmitter variable ID] 1 $[random number])

Here, the reason why $[random number] is concatenated is as follows. Because $[large area position ID] and $[transmitter variable ID] are fixed values, the random number is concatenated to turn the concatenated result into a variable value so that $[positioning transmission information] generated by each loop of the variable ID concealing process becomes a mutually different value. Specifically, in the first loop, Concatenate(“1000”|“xyz”|(random number)) is substituted

Furthermore, $[concealed variable ID] of the internal variable is prepared, and $[transmitter variable ID] generated by the above-described concatenate function Concatenate is encrypted with the above-described internal variable $[encryption key], and the resultant encrypted data is substituted for $[concealed variable ID] (Step 1204).

Encryption function($[encryption key], $[transmitter variable ID])

Specifically, in the first loop, the resultant value “x00y00z00” of the encryption function(“K00”, Concatenate(“1000”|“xyz”|(random number))) is substituted.

In the next step, $[positioning transmission information] (1102) of the internal variable is prepared, and a result data obtained by concatenating the following element data with a concatenate function Concatenate is substituted for $[positioning transmission information] (Step 1206).

Concatenate($[large area position ID] (222)|$[encryption key ID]|$[concealed variable ID])

Specifically, in the first loop, Concatenate(“1000”|“00”|“x01y01z01”) is substituted. The generated $[positioning transmission information] (1102) is sent to the positioning information transmitter 240 via an information path 216 (Step 1206).

Hereinafter, the flow moves to the actual positioning information transmission process, however, the description thereof is omitted because Step 1007 to Step 1011 are the same processing contents as those of the first embodiment. If the repeated determination in Step 1101 is completed, then the generated $[positioning transmission information] has been repeatedly transmitted a specified number of times.

In the next Step 1012, $[positioning transmission information] is updated for the next positioning information transmission. In the second embodiment, as described above, in order to change $[transmitter variable ID] which is the input value to the encryption function, the value of the internal variable $[random number] may be updated using an output value of a predetermined random-number-generation function (Step 1212). For the purpose of this loop processing, the flow returns to Step 1204 to execute this step, and furthermore Step 1206 is performed to update $[positioning transmission information].

Now the description of the process flow of the variable ID concealing process 230 performed by the positioning information transmitter 200 is completed, in the second embodiment. Moreover, “(4) positioning information concealing and positioning identifier transmitting work” is completed.

(6) Positioning Identifier Decoding Work

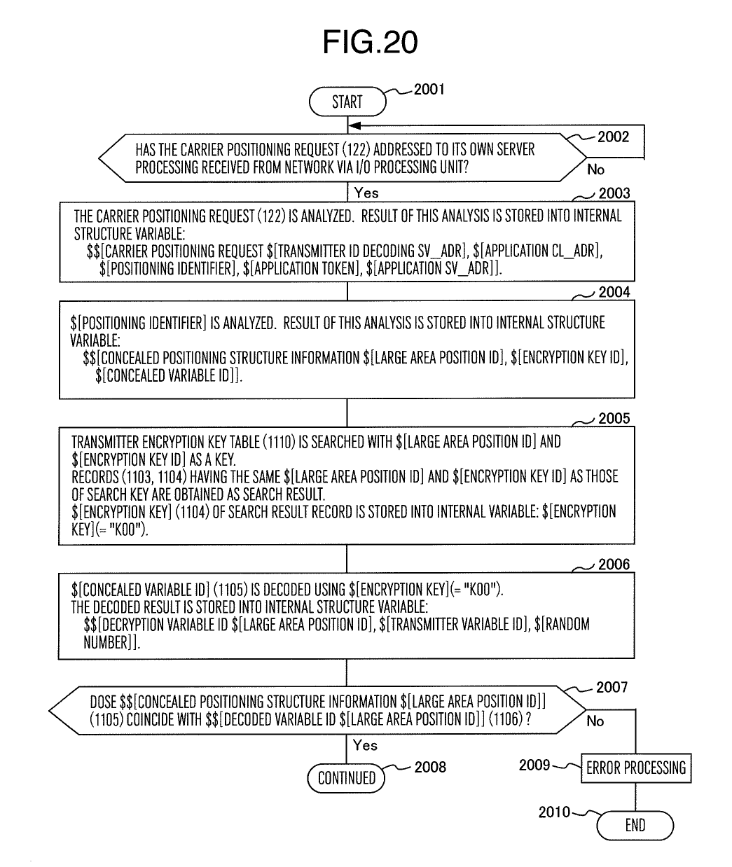

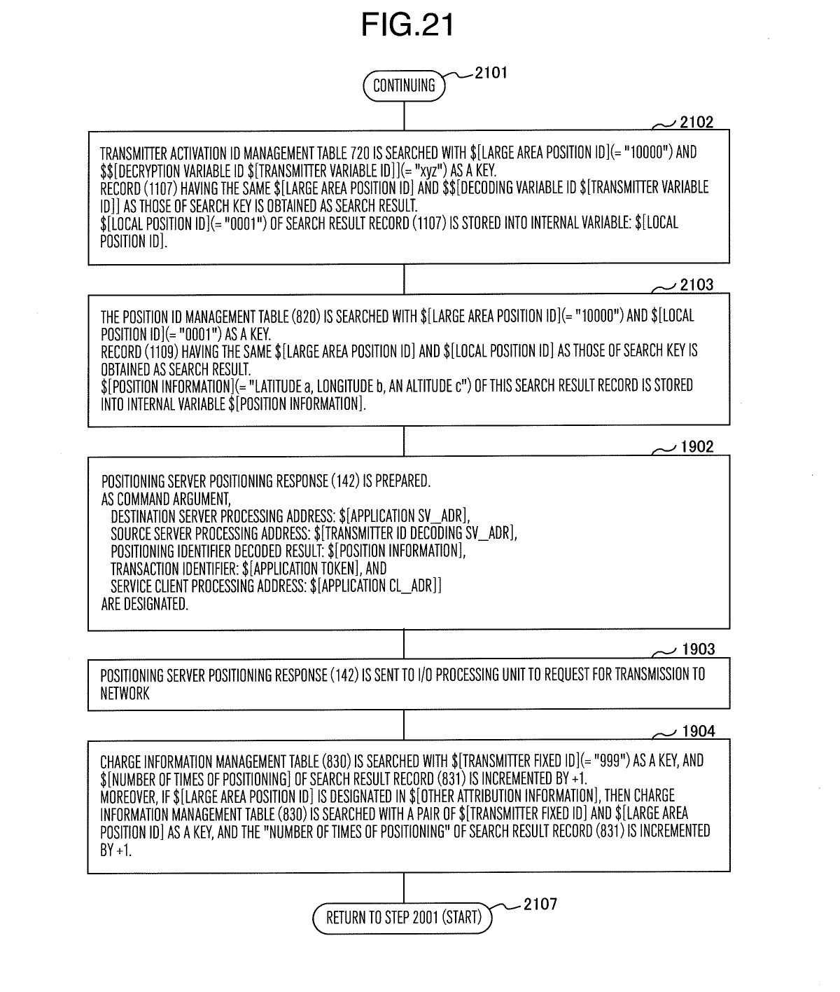

“(6) Positioning identifier decoding work” which is the sixth main work is described using FIG. 11, FIG. 20, and FIG. 21. Hereinafter, in this work, a different point from the first embodiment is described.

First, in FIG. 11 (a part thereof is also illustrated in FIG. 1), the initialization state of each table of the positioning information management server 700 at a time point immediately before receiving the carrier positioning request 122 is described.

First, the record 821 of the position ID management table 820 is the same as that of the first embodiment and therefore the description thereof is omitted.

Next, the record 721 of the transmitter activation ID management table 720 shown in FIG. 11 is described. The record 721 is the same as the record 721 shown in FIG. 1. The record 721 of FIG. 11 differs from the record 721 of FIG. 9 used in the description of the first embodiment only in that there is no data element “hash sequence ID1”. A value is stored into the [preprocessing 3] of the work: “(1) design and initialization work of the installation place of a positioning information transmitter” (2802 in FIG. 28). Moreover, when the [preprocessing 3] is completed, the element data “transmitter fixed ID” of the record 2802 is in a state to be determined (=“-”), and the relevant data item is set for the first time in the work: “(3) registration work of an installed positioning information transmitter”, and these points are the same as the first embodiment.

Now the description on the initialization state of each table of the positioning information management server 700 at a time point immediately before receiving the carrier positioning request 122 in FIG. 11 is completed.

In the following, in the second embodiment, the process flow of the positioning ID decoding process 710 for the carrier positioning request 122 is described with reference to FIG. 20 and FIG. 21 while referring to FIG. 11 as required. First, the positioning information management server 700 starts the transmitter ID decoding process 710 as a server service (Step 2001). First, the transmitter ID decoding process 710 repeatedly determines whether or not the carrier positioning request 122 addressed to its own server processing has been received from the network via the I/O processing unit (Step 2002). Upon receipt of the carrier positioning request 122, the transmitter ID decoding process 710 analyzes the received carrier positioning request 122. The result of this analysis is stored into the internal structure variable:

$$[carrier positioning request $[transmitter ID decoding SV_ADR], $[application CL_ADR], $[positioning identifier], $[application token], $[application SV_ADR]] (Step 2203).

Furthermore, $$[carrier positioning request $[positioning identifier]] which is a data element of the internal structure variable is analyzed. The result of this analysis is stored into the internal structure variable.

$$[concealed positioning structure information $[large area position ID], $[encryption key ID], $[concealed variable ID]] (1105 in FIG. 11) (Step 2204)

Next, the transmitter encryption key table (1110 in FIG. 11) is searched with $[large area position ID] and $[encryption key ID] as a key. Records (1103, 1104) having the same $[large area position ID] and $[encryption key ID] as those of the search key are obtained as the search result. Note that, in the transmitter encryption key table of FIG. 11, the indication of $[large area position ID] is omitted. $[encryption key] (1104) of the search result record is stored into the internal variable: $[encryption key](=“K00”) (Step 2005).

Next, $[concealed variable ID] (1105) is decoded using $[encryption key](=“K00”) which is the encryption key. The decoded result is stored into the internal structure variable: $$[decryption variable ID $[large area position ID], $[transmitter variable ID], $[random number]] (1106) (Step 2006).

Next, it is inspected whether or not $$[concealed positioning structure information $[large area position ID]] (1105) which is the analysis result in Step 2004 coincides with $$[decoded variable ID $[large area position ID]] (1106) which is the decoded result in Step 2006. If the both do not coincide with each other, a certain failure such as an error during transmission may have occurred and therefore an error processing (Step 2009) is carried out to finish the decoding of the received carrier positioning request (Step 2010). If the both coincide with each other, the decoding processing has been correctly performed and the flow proceeds to Step 2008 and then proceeds to Step 2101 of FIG. 21.

In the next step, considering that $$[decryption variable ID $[transmitter variable ID]] obtained in Step 2006 is the transmitter variable ID224(=“xyz”) set in the [preprocessing 3], the transmitter activation ID management table 720 is searched with $[large area position ID](=“10000”) and $$[decryption variable ID $[transmitter variable ID]](=“xyz”) as a key. As a result, the record 1107 having the same $[large area position ID] and $$[decoding variable ID $[transmitter variable ID]] as those of the search key is obtained as the search result. $[local position ID](=“0001”) of the search result record 1107 is stored into $[local position ID] of the internal variable (Step 2102). This is nothing but the position ID of a place, where the positioning information transmitter 200 having $[transmitter variable ID]](=“xyz”) stored therein as the initial value is installed.

Next, the position ID management table 820 is searched with $[large area position ID](=“10000”) and $[local position ID](=“0001”) as a key. The record 1109 having the same $[large area position ID] and $[local position ID] as those of the search key is obtained as the search result. $[position information](=“latitude a, longitude b, an altitude c”) of this search result record is stored into $[position information] of the internal variable (Step 2103).

In the below, the processing contents of Steps 1902, 1903, and 1904 of FIG. 21 are the same as those of the steps with the same number of FIG. 19 and therefore the description thereof is omitted.

Finally, since one transaction of the transmitter ID decoding process 710 corresponding to the carrier positioning request 122 has been completed, the transmitter ID decoding process 710 returns to Step 2001 in order to wait for the next carrier positioning request (Step 2107). Now the description of the second embodiment of the transmitter ID decoding process 710 is completed.

Now the description on “(6) positioning identifier decoding work” which is the sixth main work is completed.

As described hitherto, the second embodiment of the present invention has demonstrated that a method comprising the steps of: generating the positioning identifier 101 by using an encryption function in place of a hash function; and decoding the same can be realized. Now the description of the second embodiment of the present invention is completed.

### Embodiment 3

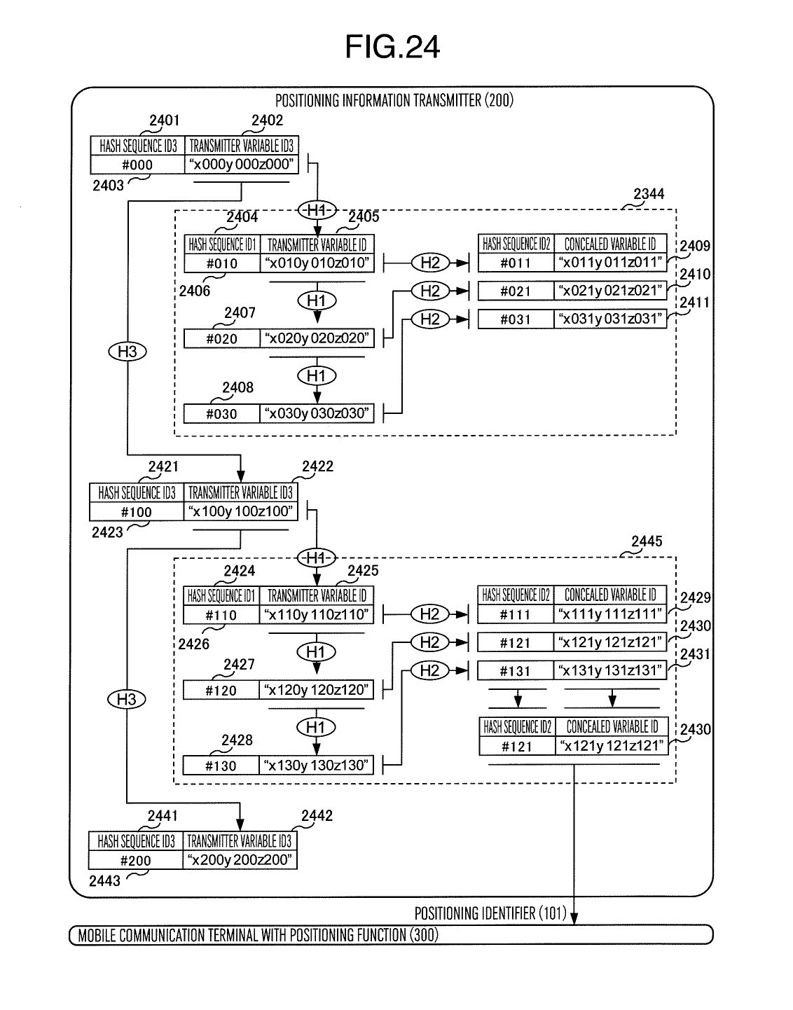

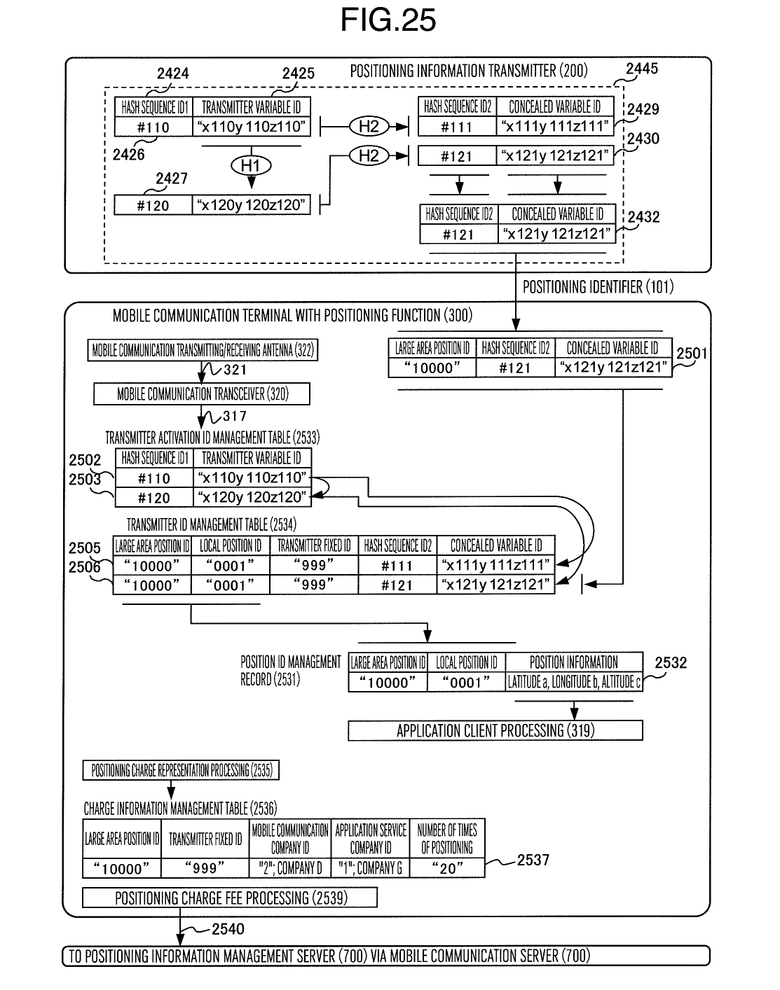

The configuration of a positioning system which is a third embodiment of the present application is described with reference to FIG. 24 and FIG. 25. The third embodiment is characterized in that the positioning system is realized which allows the mobile communication terminal 300 to decode the positioning identifier 101 even in a place where the positioning identifier 101 can be received but mobile communication is not possible (hereinafter, this state is referred to as an off-line state). In the third embodiment, with regard to the creation of a positioning identifier using a hash function and the decoding process, a method for solving the above-described problems is described following the first embodiment.

First, the basic idea of the third embodiment is described with reference to FIG. 24. FIG. 24 shows a method for generating a positioning identifier in the positioning information transmitter 200. Focus on a concealed variable ID creation module enclosed by a dotted line portion 2344. In the view, “H1” represents a “hash function 1” and “H2” represents a “hash function 2.” The inside of the dotted line 2344 is compared with the inside of the positioning information transmitter 200 illustrating the first embodiment of FIG. 9. Then, it can be seen that {hash sequence ID1, transmitter variable ID} within the dotted line 2344 of FIG. 24 uniquely corresponds to {hash sequence ID1, transmitter variable ID} of FIG. 9. Furthermore, it can be seen that {hash sequence ID2, concealed variable ID} within the dotted line 2344 of FIG. 24 also uniquely corresponds to {hash sequence ID2, concealed variable ID} of FIG. 9. From the above, it can be seen that the processing within the dotted line 2344 of FIG. 24 corresponds to the transmitter variable ID concealing process performed by one positioning information transmitter 200 in the first embodiment.

Further referring to FIG. 24, there is another dotted line portion 2445. Considering as in the foregoing, it can be seen that the processing within the dotted line 2445 also corresponds to the transmitter variable ID concealing process performed by one positioning information transmitter 200 in the first embodiment.

As apparent from the foregoing, in order for the off-line mobile communication terminal 300 to be able to decode the concealed variable ID sequences 2409, 2410, and 2411 within the dotted line portion 2344, the transmitter variable ID 2405 “x010y010z010” may be downloaded to the mobile communication terminal 300. Since the algorithm of the hash functions H1 and H2 is publicized, the mobile communication terminal 300 can generate the concealed variable ID sequences 2409, 2410, and 2411 if the transmitter variable ID 2405 has been already downloaded. Of course, not only the transmitter variable ID but other data elements constituting the record 721 of the transmitter activation ID management table 720 of FIG. 9 are also downloaded to the mobile communication terminal 300 in advance. Furthermore, the position ID management table 820 is also downloaded in advance. Then, within the mobile communication terminal 300, in accordance with the procedure shown in FIG. 9, the records 911 and 912 are generated and furthermore each record of the transmitter ID management table 730 is generated. If these three tables (720, 730, 820) are used, the off-line mobile communication terminal 300 by itself can decode the positioning identifier to obtain the position information.

However, a problem below arises here. If the positioning information transmitter 200 continues to generate the concealed variable ID sequence within the dotted line 2344, the mobile communication terminal which once downloaded the transmitter variable ID can now decode the concealed variable ID without querying the positioning information management server. This prevents the positioning information management server from recognizing the use state of the positioning information transmitter, and hinders the charge mechanism.

In order to solve this problem, as shown in FIG. 24, a third hash function 3 is introduced to configure three hash functions connected in series, thereby enabling the generation of concealed variable ID sequences of different generation sequences (in the case of FIG. 24, the generation sequence differs between in the dotted line 2344 and in the dotted line 2455). Then, the positioning information transmitter is configured to successively transmit the concealed variable ID's which are the data elements of a concealed variable ID sequence of a certain generation sequence during a fixed time and thereafter successively transmit the concealed variable ID's which are the data elements of a concealed variable ID sequence of a different generation sequence during the next fixed time. Then, a concealed variable ID sequence (for example, only this one) of a part of the generation sequences among the plurality of generation sequences is adapted to be downloaded to a mobile communication terminal With this, the mobile communication terminal downloaded with the concealed variable ID sequence can decode the concealed variable ID sequence of the downloaded generation sequence but cannot estimate a concealed variable ID sequence of the other generation sequence, so that each data of the concealed variable ID cannot be decoded.

This point is described in more detail. A relationship between the processing within the dotted line 2344 and the processing within the dotted line 2445 in FIG. 24 is investigated. A value as the result of hashing a stored value “x000y000z000” of the transmitter variable ID 2402 with the hash function 1 is the stored value “x010y010z010” of the transmitter variable ID 2405. Furthermore, a value as the result of hashing the stored value “x100y100z100” of the transmitter variable ID 2422 with the hash function 1 is the stored value “x110y110z110” of the transmitter variable ID 2425. Then, the transmitter variable ID 2402 and the transmitter variable ID 2422 are configured so that a value as the result of hashing the stored value of the transmitter variable ID 2402 with the third hash function 3 is the stored value of the transmitter variable ID 2422.

In this manner, by employing a configuration of three hash functions connected in series as shown in FIG. 24, the mobile communication terminal 300 cannot predict the transmitter variable ID 2425 “x110y110z110” even if the transmitter variable ID 2405 “x010y010z010” which is the output value of the hash function 1 in the second stage is downloaded to the mobile communication terminal 300. This is because a series of hash values 2402 “sx000y000z000”, 2422 “x100y100z100”, and 2442 “x200y200z200” generated by the hash function 3 are unknown to the mobile communication terminal 300.

Then, consider a mechanism, wherein the positioning information transmitter 200 switches the concealed variable ID sequence from the ID sequences (2409, 2410, 2411, . . . ) within the dotted line 2344 to the ID sequences (2429, 2430, 2431, . . . ) within the dotted line 2445 at a predetermined interval. With this, even if a transmitter variable ID capable of generating a part of the hash value sequences within the dotted line is downloaded to the mobile communication terminal 300, each hash value sequence generated by the positioning information transmitter 200 will not be known to the mobile communication terminal 300. That is, it is possible to provide information allowing the mobile communication terminal 300 to decode a limited range of concealed variable ID sequences only during a predetermined time. Then, the positioning information transmitter 200 invalidates the concealed variable ID sequence, which is generated based on the thus provided (publicized) information, in a predetermined time, and switches the same to other concealed variable ID sequence, whereby the restriction on the decodability within the predetermined time can be secured. Now the description on the basic idea of the third embodiment is completed.

Next, with reference to FIG. 25, a method for realizing a temporary decoding performed by the mobile communication terminal 300 is specifically described. First, the positioning information transmitter 200 continues to generate the concealed variable ID sequences (2429, 2430) within the range of the dotted line 2445 shown in FIG. 24. In FIG. 25, assume that a concealed variable ID “x121y121z121” is transmitted as the positioning identifier 101 and is received by the mobile communication terminal 300. On the other hand, assume that the mobile communication terminal 300 received a record 2502 in a transmitter activation ID management table 2533 via the mobile communication transmitting/receiving antenna 322 and the mobile communication transceiver 320, and has already stored the record 2502 therein. The mobile communication terminal 300, through the same procedure as that in the dotted line 2445 of FIG. 24, has already generated the record 2503, and records 2505 and 2506 of a transmitter ID management table 2534, with the use of the hash functions H1 and H2. If the record 2501 received from the positioning information transmitter 200 is compared with each record of the transmitter ID management table 2534, the record 2506 whose hash sequence ID2 and concealed variable ID coincide with those of the record 2501 is selected. The large area position ID and local position ID are identified from the selected record, and the position ID management record 2531 is searched with these two position ID's as a key, whereby final position information 2532 can be obtained. If the position information 2532 obtained in this manner is input to an application client 319, even the off-line mobile communication terminal 300 can carry out the LBS.

Furthermore, the use state of concealed positioning information is stored into a charge information management table 2536 through a positioning charging representation process 2535. The stored record indicative of the use state is read at a predetermined time interval through a positioning charging notification process 2539, and is sent to the positioning information management server 700 via the mobile communication server 400 while the mobile communication is online (2540).

Now the description on the concealing and decoding process of the transmitter variable ID which is the third embodiment is completed.

### Embodiment 4

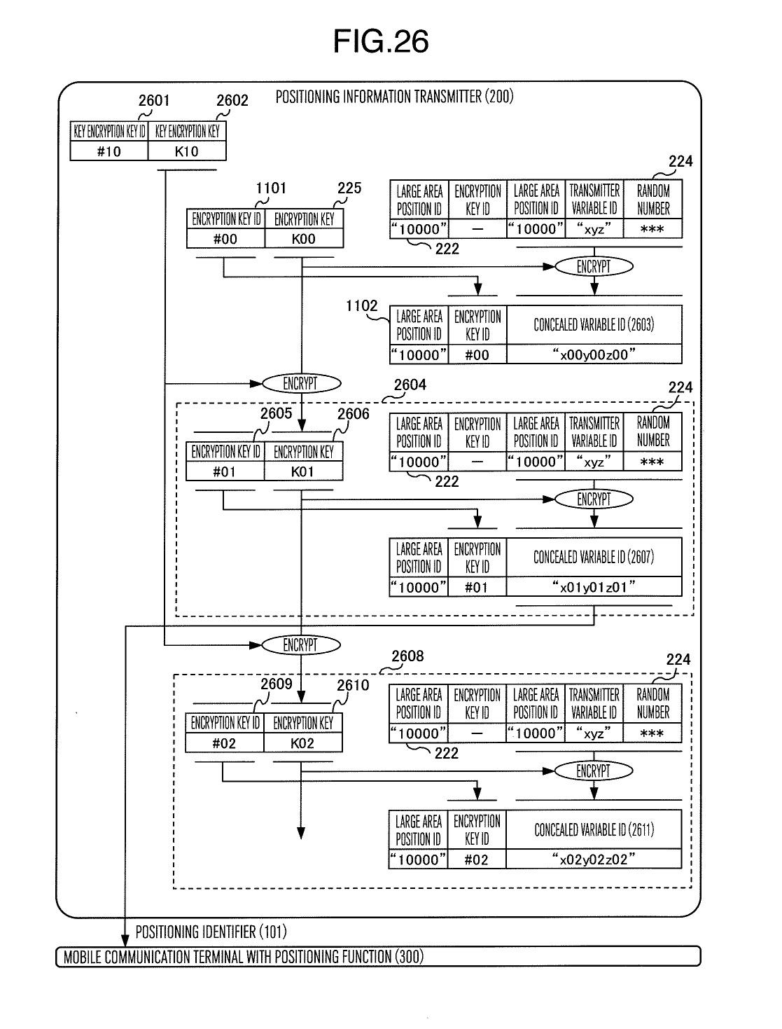

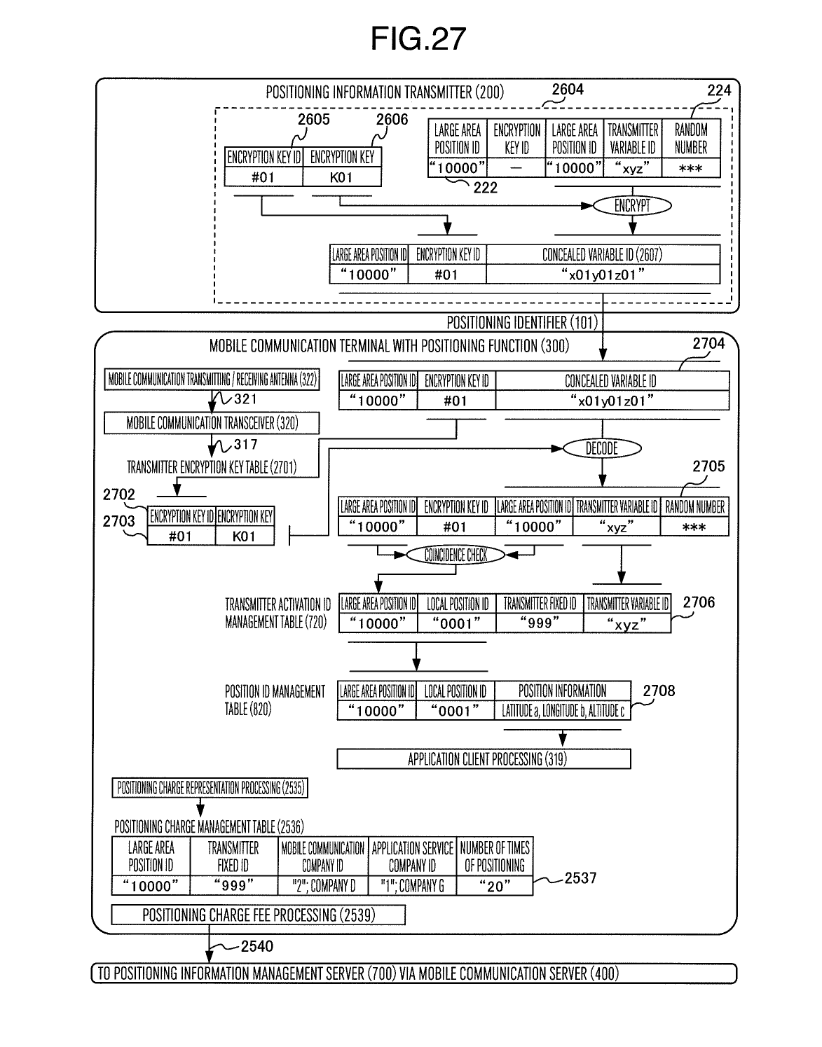

The configuration of a positioning system which is a fourth embodiment of this application is described with reference to FIG. 26 and FIG. 27. The fourth embodiment, as with the third embodiment, is characterized in that a positioning system is realized which allows the mobile communication terminal 300 to decode the positioning identifier 101 even in a place where the positioning identifier 101 can be received but mobile communication is not possible. In the fourth embodiment, with regard to the creation of a positioning identifier using an encryption function and the decoding process, a method for solving the above-described problems is described following the second embodiment.

First, the basic idea of the fourth embodiment is described with reference to FIG. 26. FIG. 26 shows a method for generating a positioning identifier in the positioning information transmitter 200. Focus on a concealed variable ID creation module enclosed by a dotted line portion 2604. The inside of the dotted line 2604 is compared with the inside of the positioning information transmitter 200 illustrating the second embodiment of FIG. 11. Then, it can be seen that {encryption key ID, encryption key} within the dotted line 2604 of FIG. 26 uniquely corresponds to {encryption key ID, encryption key} of FIG. 11. Furthermore, it can be seen that {encryption key ID, encryption key} within the dotted line 2604 of FIG. 26 also uniquely corresponds to {encryption key ID, encryption key} of FIG. 11. From the above, it can be seen that the processing within the dotted line 2604 of FIG. 26 corresponds to the transmitter variable ID concealing process performed by one positioning information transmitter 200 in the second embodiment.

Further referring to FIG. 26, there is another dotted line portion 2608. Considering as in the foregoing, the processing within the dotted line 2608 also corresponds to the transmitter variable ID concealing process performed by one positioning information transmitter 200 in the second embodiment.

As apparent from the foregoing, in order for the off-line mobile communication terminal 300 to be able to decode the concealed variable ID sequence 2607 within the dotted line portion 2604, {encryption key ID, encryption key} (2605, 2606)(=“{#01 and x01y01z01}”) may be downloaded to the mobile communication terminal 300. Since the algorithm of the encryption function is publicized, the mobile communication terminal 300 can decode the concealed variable ID 2607 if the transmitter encryption key table {encryption key ID, encryption key} (1110) has been already downloaded. Of course, not only {encryption key ID, encryption key} but other data elements constituting the record 1107 (in this record, a data element corresponding to the transmitter variable ID is the transmitter variable ID) of the transmitter activation ID management table 720 of FIG. 9 are downloaded to the mobile communication terminal 300 in advance. Furthermore, the position ID management table 820 is also downloaded in advance. If these two tables (1110, 720, 820) are used, the off-line mobile communication terminal 300 by itself can decode the positioning identifier to obtain the position information.

However, a problem arises here. If the positioning information transmitter 200 continues to generate the concealed variable ID sequence (for example, only this one) within the dotted line 2604, then the mobile communication terminal which once downloaded the transmitter encryption key table {encryption key ID, encryption key} can decode the concealed variable ID without querying the positioning information management server. In order to solve this problem, as shown in FIG. 26, the key encryption key which is the second encryption key is introduced so as to encrypt the encryption key 225 with the key encryption key, thereby enabling the generation of concealed variable ID sequences of different generation sequences (in the case of FIG. 26, the generation sequence differs between in the dotted line 2344 and in the dotted line 2455).

This content is described more specifically. A relationship between the processing within the dotted line 2604 and the processing within the dotted line 2608 in FIG. 26 is investigated. The value of a result of encrypting the stored value “K01” of an encryption key 2606 with the key encryption key “K10” is a stored value “K02” of an encryption key 2610.

By employing a configuration, in which an encryption key is encrypted with a key encryption key, as shown in FIG. 26, even if the encryption key 2606 “K01” is downloaded to the mobile communication terminal 300, the mobile communication terminal 300 cannot predict the encryption key “K02”. Because the key encryption key “K10” is unknown to the mobile communication terminal 300.

Then, consider a mechanism, wherein the positioning information transmitter 200 switches the concealed variable ID sequence from the ID sequences (2607) within the dotted line 2604 to an ID sequences (2611) within the dotted line 2608 at a predetermined interval. With this, even if an encryption key capable of generating a part of the concealed variable ID sequences within the dotted line is downloaded to the mobile communication terminal 300, each concealed variable ID sequence generated by the positioning information transmitter 200 can be concealed with respect to the mobile communication terminal 300. That is, it is possible to provide information allowing the mobile communication terminal 300 to decode a limited range of concealed variable ID sequences only during a predetermined time. Then, the positioning information transmitter 200 invalidates the concealed variable ID sequence, which is generated based on the thus provided (publicized) information, in a predetermined time, and switches the same to other concealed variable ID sequence, whereby the restriction on the decodability within the predetermined time can be secured. Now the description on the basic idea of the fourth embodiment is completed.

Next, with reference to FIG. 27, a method of realizing a temporary decoding performed by the mobile communication terminal 300 is specifically described. First, the positioning information transmitter 200 continues to generate a concealed variable ID sequence (2607) in a range of a dotted line 2604 shown in FIG. 26. In FIG. 27, assume that a concealed variable ID “x01y01z01” is transmitted as the positioning identifier 101 and is received by the mobile communication terminal 300. On the other hand, assume that the mobile communication terminal 300 received a record 2703 within a transmitter encryption key table 2701 via the mobile communication transmitting/receiving antenna 322 and the mobile communication transceiver 320 and has already stored the record 2703 therein. With regard to a record 2704 received from the positioning information transmitter 200, with the encryption key ID, which this record includes, as a key, the transmitter encryption key table 2701 is searched to read the encryption key K01. The concealed variable ID is decoded by means of the read encryption key K01. With a transmitter variable ID included in this decoded concealed variable ID as a key, the transmitter activation ID management table 720 is searched to select a record 2706. From the selected record 2706, the large area position ID and local position ID are identified, and a record 2708 of the position ID management table 820 is searched with these two position ID's as a key, whereby final position information 2706 can be obtained. If the position information 708 obtained in this manner is input to the application client 319, even the off-line mobile communication terminal 300 can carry out the LBS.

Furthermore, the use state of concealed positioning information is stored into the charge information management table 2536 by the positioning charging representation process 2535. The stored record indicative of the use state is read at a predetermined time interval in the positioning charging notification process 2539, and is sent to the positioning information management server 700 via the mobile communication server 400 while the mobile communication is online (2540).

Now the description on the concealing and decoding process of the transmitter variable ID which is the fourth embodiment is completed.

### Embodiment 5

The configuration of a positioning system which is a fifth embodiment of this application is described with reference to FIG. 29. The fifth embodiment is characterized in that by integrating the positioning request 112 and the application service request 111 transmitted from a mobile communication terminal, the transmission data amount of the mobile communication terminal can be reduced and the load of the issuance processing of the transaction identifier carried out in the application client processing 319 within the mobile communication terminal 300 can be reduced, thereby achieving a reduction in the execution time of the application service. Hereinafter, the fifth embodiment is described using FIG. 29(2).

As shown in FIG. 29(2), an application client processing 2906 has the step of transmitting the mobile terminal positioning request (Step 1309) integrated with the step of transmitting the mobile communication terminal application service request (Step 1404) of FIG. 29(1), whereby a single mobile communication terminal positioning and application service integrated-request (2902) is transmitted (Step 2901).

Next, a mobile communication server processing 2907 of the mobile communication server 400, which is a characteristic configuration of this embodiment, is described. In the mobile communication server processing 2907, the following processing is newly carries out in place of the application client processing 319 of the first embodiment of FIG. 29(1).

(1) First, an application token is issued, which is the step of issuing a transaction identifier (Step 2902).

(2) Next, the content of the received terminal positioning and application service integrated-request 2902 is analyzed, and this request is split into the positioning request 122 and the application service request 121 (Step 2903).

(3) One of the split requests, i.e., the positioning request, is transmitted as the carrier positioning request (Step 2904).

(4) The other one. i.e., the service request, is transmitted as the carrier application service request (Step 2905).

As described above, in the fifth embodiment, because the client side requests transmitted from the mobile communication terminal are integrated into one as the (positioning and application service) integrated-request 2902, the number of times of communication of the mobile communication terminal can be reduced from two to one. Furthermore, in the fifth embodiment, the step of issuing a transaction identifier, which is carried out in the application client processing 319 in the mobile communication terminal 300 in the first embodiment, is loaded off to the mobile communication server processing 2907 in the mobile communication server 400, and therefore the processing load of the mobile communication terminal 300 is advantageously reduced, thereby achieving a reduction of the execution time of the application service. Now the description of the fifth embodiment is completed.

### Embodiment 6

The configuration of a position ID management method in a positioning system which is a sixth embodiment of the present application is described with reference to FIG. 30. The sixth embodiment is characterized in that as the management information on a place where the positioning information transmitter 200 is installed, a company ID is added in addition to the large area position ID and the local position ID. The addition of the company ID makes it possible to assign an independent local position ID for each company even when a plurality of companies share and manage an area designated by the same large area position ID. Hereinafter, the sixth embodiment is described with reference to FIG. 30.

As described in the first embodiment, in FIG. 30(1) in order to designate ABC Life Insurance Marunouchi Building (location: Marunouchi 1-6-6, Central Ward, Tokyo), the large area position ID “10000” is assigned. Here, as shown in the position ID management table 820 of FIG. 30(1), in order to designate the entrance on the Iroha Manufacturing Co., Ltd. side of the building, the local position ID “0001” is assigned, and in order to designate the entrance on the ABC Mutual Life Insurance Company side, the local ID “0002” is assigned, and so on. That is, different local position ID's need to be assigned within the same large area position ID.

In contrast, in the sixth embodiment, as shown in FIG. 30(2), a data element indicative of a company ID is introduced in a position ID management table 3020 and a transmitter activation ID management table 3010. Specifically, as the company ID, the enterprise codes in Tokyo Stock Exchange can be used, for example. For example, in the position ID management table 3020, for the entrance on the Iroha Manufacturing Co., Ltd. side shown by a record 3007, “6501” can be used as the company ID while for the entrance on the ABC Mutual Life Insurance Company side shown by a record 3008, “6271” can be used as the company ID. Alternatively, the standard enterprise codes managed by Electronic Commerce Promotion Center, Japan Information Processing Development Center may be used. In this manner, the introduction of the company ID makes it possible to independently assign a local position ID for each company even when different companies manage two areas belonging to the same large area position ID. That is, in the sixth embodiment of FIG. 30, the same local ID “0001” can be independently assigned to the record 3007 and the record 3008.

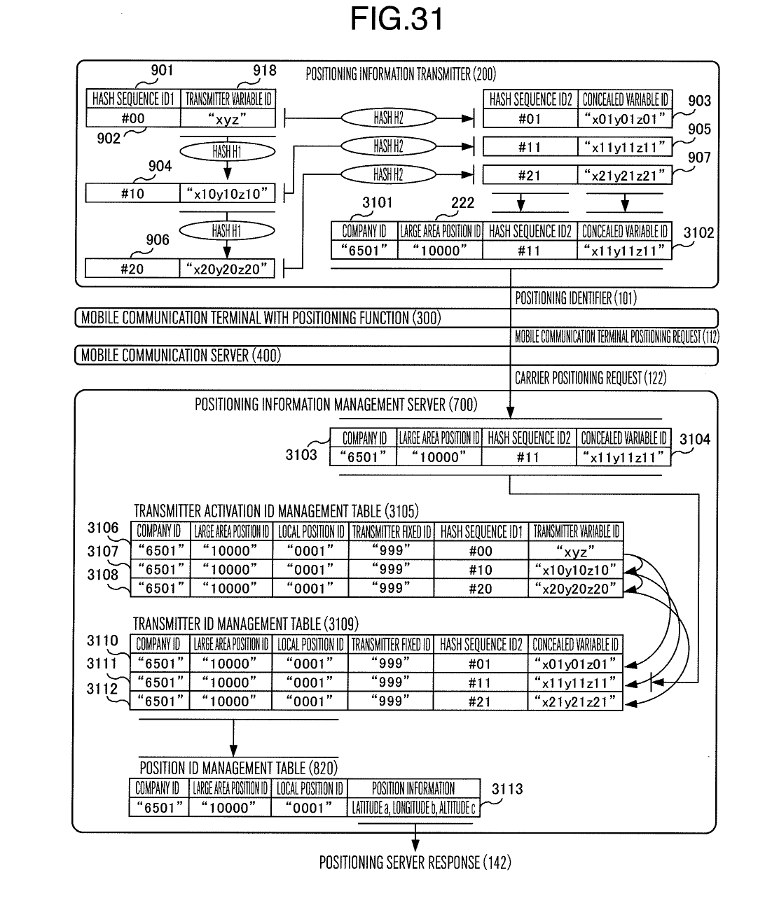

Furthermore, the configuration of a concealing and decoding process in the sixth embodiment is described with reference to FIG. 31. In the following description, the difference from the first embodiment shown in FIG. 9 is mainly described. First, in a positioning identifier 3102 in the positioning information transmitter 200, a company ID 3101 other than the large area position ID 222 is added as a constituent element. Furthermore, similarly also in a transmitter activation ID management table 3105, a transmitter ID management table 3109, and the position ID management table 820 in the positioning information management server, the company ID 3101 other than the large area position ID 222 is added as a constituent element. Actually, “6501” is stored into the data element 3101, records 3106-08, and records 3110-3112. The positioning identifier 3102 sent by the positioning information transmitter 200 is received by the positioning information management server 700 (as a positioning identifier 3104). The transmitter ID management table 3109 is searched with the “company ID”, “large area position ID”, “hash sequence ID”, and “concealed variable ID”, which are data elements 3103 of the received record, as a search key, and the record 3111 matching the search key is obtained as the search result. The position ID management table 820 is searched with the data element “company ID”, “large area position ID”, and “local position ID” of the search result record 3111 as a search key, and a positioning information record 3113 matching the search key can be obtained as the search result.

As described above, by adding a company ID in addition to the large area position ID and local position ID as the method of describing the installation place of the positioning information transmitter 200, there is no need to manage the consistency in numbering across the companies, so that an efficient ID management is possible. Now the description of the sixth embodiment of the present invention is completed.

### Embodiment 7

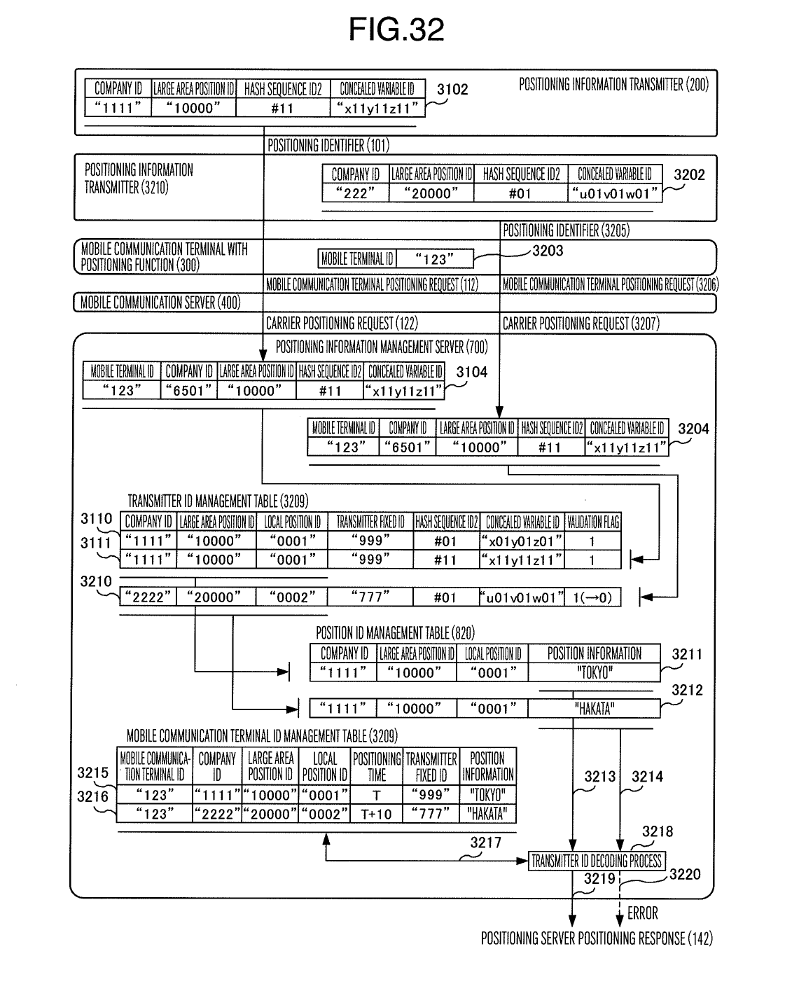

The configuration of the transmitter variable ID concealing and decoding process in a positioning system which is a seventh embodiment of the present application is described referring to FIG. 32. The seventh embodiment is characterized in that a method comprising the steps of: detecting the illegality when an installed positioning information transmitter 3210 is stolen and installed at a different place; and invalidating the positioning transmission information of the stolen transmitter 3210 is provided to improve the security of the positioning system. For this reason, a data element called a “valid flag” is added to the transmitter ID management table to manage the validity or invalidity of each of the transmitter fixed ID and concealed variable ID. Hereinafter, the seventh embodiment is described referring to FIG. 32.

In FIG. 32, assume that the positioning information transmitter 200 is installed in Tokyo and the positioning information transmitter 3210 is installed in Hakata. Assume, thereafter, a malicious third party stole the positioning information transmitter 3210 in Hakata and mischievously installed this in an area adjacent to the positioning information transmitter 200 in Tokyo. Suppose that under this circumstance, a person holding the mobile communication terminal provided with a positioning function 300 stays in Tokyo, and passes through the vicinity of the positioning information transmitter 200 at any time “T”, and passes through the vicinity of the positioning information transmitter 3210 at 10 seconds later, “T+10”. Suppose the mobile communication terminal 300 has the mobile communication terminal ID “123” (3203) and this communication terminal ID is added to communication information.

In the following, in the above-described state, a method of how the positioning information management server 700 detects an illegally installed terminal 3210 and treats the decoding process of the positioning identifier as an error is described.

First, the positioning information transmitter 200 transmits the positioning identifier 3102 at the time point “T”. The communication terminal 300 having received this information transmits the positioning request 112, and the positioning information management server 700 receives this request (as a record 3104). Here, note that the record 3104 includes the mobile communication terminal ID “123” which is the ID of the mobile communication terminal having sent this request. A transmitter ID decoding process 3218 starts a decoding process according to the process flow (FIG. 18, 19) of the first embodiment of the transmitter ID decoding process 710. First, in the decoding process 3218, a transmitter ID management table 3209 is searched with the record 3104 as a search key, and a search result record 3111 is obtained. At this time, when a data element “valid flag” specific to this embodiment is referred to, this flag is “1 (valid)”, and therefore it is determined that the positioning identifier transmitted by the positioning information transmitter 200 is valid, and the decoding process is continued.

Next, in the decoding process 3218, the position ID management table 820 is searched with the search result record 3111 as a search key, and a search result record 3211 is obtained. In the decoding process 3218, the position information of the record 3211 is read (Step 3213).

Next, in the decoding process 3218, with the mobile communication terminal ID “123”, which the positioning request 3104 includes, as the major key, a record 3215 is stored into a mobile communication terminal ID management table 3209 as a record of transaction of the above-described positioning request. This record expresses the fact that “the mobile communication terminal 123 requested to decode the positioning identifier transmitted at the time point T by a positioning information transmitter of the transmitter fixed ID 999, which is installed at a place of the large area position ID 10000 and the local position ID 0001 by a company of the company ID 1111.”

Finally, in the decoding process 3218, a validity check of the positioning information transmitter installation position is performed. That is, in the decoding process 3218, the mobile communication terminal ID management table (3209) is searched to see if there is any record, which includes the mobile terminal ID “123” and also the positioning time of which is immediately before “T”. At this time point, since there is only a record 3215, the search result is zero. Therefore, the validity check of the positioning information transmitter installation position described later is not performed. Finally, in the decoding process 3218, the read location information 3211 is sent to the outside as a positioning server positioning response 142 (Step 3219). Now the positioning request processing with regard to the positioning information transmitter 200 is completed.

Next, with regard to the positioning identifier sent at 10 seconds after the time point T by the illegally installed positioning information transmitter 3210, the illegality detection process in the positioning information management server 700 is described in detail. The positioning information transmitter 200 transmits a positioning identifier 3202 at a time point “T+10”. The communication terminal 300 having received this information transmits a positioning request 3207, and the positioning information management server 700 receives this request (as a record 3204). Here, again note that the record 3204 includes the mobile communication terminal ID “123” which is the ID of the mobile communication terminal having sent this request. In the transmitter ID decoding process 3218, the decoding process is started as described above. First, in the decoding process 321, the transmitter ID management table 3209 is searched with the record 3204 as a search key, and the search result record 3210 is obtained. Then, when the data element “valid flag” specific to this embodiment is referred to, this flag is “1 (valid)”, and therefore it is determined that the positioning identifier transmitted by the positioning information transmitter 200 is valid, and the decoding process is continued.

Next, in the decoding process 3218, the position ID management table 820 is searched with the search result record 3210 as a search key, and a search result record 3212 is obtained. In the decoding process 3218, the position information of the record 3212 is read (Step 3214).

Next, in the decoding process 3218, with the mobile communication terminal ID “123”, which the positioning request 3204 includes, as the major key, a record 3216 is stored into the mobile communication terminal ID management table 3209 as a record of transaction of the above-described positioning request. This record expresses the fact that “the mobile communication terminal 123 requested to decode a positioning identifier transmitted at the time point T+10 by a positioning information transmitter with a transmitter fixed ID 777, which is installed at a place of the large area position ID 20000 and the local position ID 0002 by a company of the company ID 2222.”

Finally, in the decoding process 3218, a validity check of the positioning information transmitter installation position is performed. That is, in the decoding process 3218, the mobile communication terminal ID management table (3209) is searched to see if there is any record, which includes the mobile terminal ID “123” and also the positioning time of which is immediately before “T+10”. As a result of this search, the record 3215 is read. In the transmitter ID decoding process 3218, “Hakata” of the read location information 3212 is compared with “Tokyo” of the position information of the record 3215. The time difference of two positioning requests is a difference between “T+10” and “T”, i.e., “10” seconds. It is impossible for the mobile communication terminal 300 to move from the positioning information transmitter 200 installed in “Tokyo” to the positioning information transmitter 3210 installed in “Hakata” within this time interval. Then, the transmitter ID decoding process 3218 determines that the positioning request 3204 at this time is due to the positioning identifier transmitted by an illegal positioning information transmitter, and determines the position information “Hakata” read from the record 3212 as invalid, and sends error information to the outside as the positioning server positioning response 142 (Step 3220). Furthermore, the valid flag of the record 3210 is changed from “1”(valid) to “0” (invalid). Moreover, the transmitter ID decoding process 3218 invalidates a subsequent record including a concealed variable ID (not illustrated in FIG. 32) of the record 3210 (for example, all subsequent records may be invalidated). Accordingly, a positioning information transmitter with the transmitter fixed ID “777” is treated as the transmitter which is invalidated due to the illegal state, and an error is returned in response to the subsequent mobile terminal positioning request, and the validity as the whole system can be secured.

Now the description of the positioning request decoding process with regard to the positioning information transmitter 200 is completed. Now the description of the configuration of the transmitter variable ID concealing and decoding process in the positioning system which is the seventh embodiment of the present application is completed.

The above description has been made on the embodiments, however, it is apparent to those skilled in the art that the present invention is not limited thereto, and various changes and modifications may be made within the spirit of the present invention and the scope of the appended claims.

### INDUSTRIAL APPLICABILITY

As shown in the above-described embodiments, it is apparent that the present invention can be applicable to the mobile communication system represented by a mobile phone and to the position information service (LBS) provided using this mobile communication system. Specifically, the third generation mobile phone service and the Internet information service on the third generation mobile phone service can be achieved. Various application services, such as navigation, watching, advertisement providing, and operator arrangement control, have been realized, as the LBS. The present invention realizes a common infrastructure function, i.e., the infrastructure service, to support in the realization of these various application services. Accordingly, the present invention can be applicable to a wide range of application fields, such as daily life and amusement, including the office work using IT equipments or the field operation.

1. A position information system for managing position information in an area having a predetermined extent where installation points for a plurality of positioning information transmitters are set, the position information system comprising: the positioning information transmitter being installed at the each set installation point and transmitting a specific positioning identifier; and a positioning information management server receiving the transmitted positioning identifier and converting the same into position information representing the predetermined installation point, wherein the positioning information management server
assigns to a predetermined area a large area position identifier specific thereto,
assigns to the predetermined installation point a local position identifier specific thereto,
assigns to the positioning information transmitter a transmitter fixed identifier specific thereto,
assigns to the positioning information transmitter a transmitter variable identifier which is specific to the transmitter and is a variable value, and
stores the assigned large area identifier, local position identifier, transmitter identifier, and transmitter variable identifier into a storage device, wherein the positioning information transmitter
stores its own transmitter fixed identifier, its own transmitter variable identifier, and a large area position identifier assigned to an area in which an installation point of the transmitter itself is located, into a storage unit,
performs a transmitter variable identifier concealing process on the transmitter variable identifier to conceal the transmitter variable identifier stored therein, and generates the positioning identifier comprising the concealed variable identifier and the large area position identifier and transmits the same to the positioning information management server, wherein the positioning information management server
stores into the storage device a transmitter activation identifier management table for managing a correlation among initial values of the transmitter fixed identifier and transmitter variable identifier of the positioning information transmitter and the large area position identifier and local position identifier of an installation point,
performs a concealing process on the transmitter variable identifier and stores into the storage device a transmitter identifier management table for managing a correlation among the generated concealed variable identifier and the large area position identifier and local position identifier of an installation point,
stores into the storage device a position identifier management table for managing a correlation among the large area position identifier and local position identifier of an installation point and the position information of the installation point,
extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table, and
with regard to the converted large area position identifier and local position identifier of an installation point, with reference to the position identifier management table and with these two positioning identifiers as a key, converts these two positioning identifiers into position information.

2. A position information system installed at a predetermined installation point, the position information system comprising a positioning information transmitter transmitting a positioning identifier and a positioning information management server converting the positioning identifier into position information of the predetermined installation point, wherein the positioning information management server
assigns a large area position identifier to an area in which a positioning information transmitter is installed, and stores the same, and
assigns a local position identifier to the installation point of the positioning information transmitter in this area and stores the same, wherein the positioning information transmitter
by itself performs a predetermined transmitter variable identifier concealing process to generate a concealed variable identifier from a specific transmitter variable identifier, and
transmits the concealed variable identifier and the large area position identifier to the positioning information management server.

3. A position information system installed at a predetermined installation point, the position information system comprising a positioning information transmitter transmitting a positioning identifier and a positioning information management server converting the positioning identifier into position information of the predetermined installation point, wherein the positioning information management server
assigns a large area position identifier to an area in which a positioning information transmitter is installed,
assigns a local position identifier to an installation point of the positioning information transmitter in this area and stores the assigned large area position identifier and the local position identifier into a storage device,
stores into the storage device a transmitter identifier management table for managing a correlation among a concealed variable identifier generated by performing a predetermined transmitter variable identifier concealing process and the large area position identifier and local position identifier of an installation point,
stores into the storage device a position identifier management table for managing a correlation among the large area position identifier and local position identifier of an installation point and the position information of the installation point,
extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table, and
with regard to the converted large area position identifier and local position identifier of an installation point, converts the two position identifiers into position information with the two position identifiers as a key and with reference to the position identifier management table.

4. The position information system according to claim 1, wherein the transmitter variable identifier concealing process comprises the step of:
calculating a first hash value by hashing a transmitter variable identifier stored by the positioning information transmitter, with a first hash function and further repeatedly hashing the calculated hash value with the first hash function and generating a first hash information sequence comprising a plurality of hash values obtained by this repetition;
calculating a second hash value by hashing each element of the first hash information sequence with a second hash function and generating a second hash information sequence comprising a plurality of the calculated hash values; and
treating the generated second hash information sequence as a concealed variable identifier, wherein the step of generating the positioning identifier comprising the steps of:
firstly extracting a top hash value from each element of the second hash information sequence,
combining the extracted hash value with a large area position identifier stored therein and generating the positioning identifier;
repeatedly transmitting the generated positioning identifier a predetermined first number of times at a predetermined first time interval; and
extracting a next hash value of the second hash information sequence and repeatedly performing the steps of generating and transmitting the positioning identifier.

5. The position information system according to claim 4, wherein the predetermined transmitter identifier concealing process comprises the steps of:
assigning a unique hash sequence identifier to each element of the second hash information sequence which is generated based on the transmitter variable identifier stored by the positioning information transmitter, and generating a hash-sequence-identifier sequence comprising the assigned hash sequence identifier; and
extracting a corresponding hash sequence identifier from the generated hash-sequence-identifier sequence in extracting a hash value which is each element of the second hash-sequence-identifier sequence, and generating the positioning identifier by combining the extracted hash value and hash sequence identifier with a large area position identifier stored therein.

6. The position information system according to claim 1, wherein the predetermined transmitter identifier concealing process comprises the steps of:
storing a predetermined encryption processing unit, a predetermined encryption key, and a encryption key identifier uniquely assigned to the cryptographic key into the positioning information transmitter; and
combining a transmitter variable identifier, a large area position identifier, and a random number stored by the positioning information transmitter, and encrypting the combined information with the predetermined encryption key to generate a concealed variable identifier, wherein the step of generating the positioning identifier comprises the steps of:
generating the positioning identifier by combining the generated concealed variable identifier with a large area position identifier stored by the positioning information transmitter;
repeatedly transmitting the generated positioning identifier a predetermined first number of times at a predetermined first time interval; and
regenerating the random number and generating a concealed variable identifier again, and repeatedly performing the steps of generating and transmitting the positioning identifier.

7. A position information system for managing position information in an area having a predetermined extent where installation points for a plurality of positioning information transmitters are set, the position information system comprising:
the positioning information transmitter being installed at the each set installation point and transmitting a specific positioning identifier;
a mobile communication terminal provided with a positioning function including a positioning identifier receiving unit configured to receive the transmitted positioning identifier, a program execution unit configured to execute a client program of a position information application, and a wireless communication unit for mobile communications;
a mobile communication server including a wireless communication unit for mobile communication with the mobile communication terminal, and a network communication unit configured to communicate with a network;
an application server including a network communication unit configured to communicate with the network and a program execution unit configured to execute a server program of a position information application; and
a positioning information management server including a network communication unit configured to communicate with the network for receiving the transmitted positioning identifier via the mobile communication terminal provided with a positioning function and the mobile communication server, and a positioning information transmitter identifier decoding unit configured to convert the received positioning identifier into position information representing the predetermined installation point, wherein the positioning information management server assigns to the predetermined area a large area position identifier specific thereto,
assigns to the predetermined installation point a local position identifier specific thereto,
assigns to the positioning information transmitter a transmitter fixed identifier specific thereto,
assigns to the positioning information transmitter a transmitter variable identifier which is specific to the transmitter and is a variable value, and
stores the assigned large area identifier, local position identifier, transmitter identifier, and transmitter variable identifier into a storage device, wherein the positioning information transmitter
stores its own transmitter fixed identifier, its own transmitter variable identifier, and a large area position identifier assigned to an area in which an installation point of the transmitter itself is located, into a storage unit,
performs a predetermined transmitter variable identifier concealing process to conceal the transmitter variable identifier stored therein, and generates the positioning identifier comprising the concealed variable identifier and the large area position identifier and transmits the same to the mobile communication terminal provided with a positioning function, wherein the mobile communication terminal provided with a positioning function
receives the transmitted positioning identifier and generates a mobile terminal positioning request to request the positioning information management server to convert the received positioning identifier into position information,
executes a client program of the stored position information application, and generates a mobile communication terminal application service request which is a request to a server program within the positioning information management server,
generates two transaction identifiers having an equal value indicating that the generated two requests were generated in the executed client program of a single position information application,
adds the generated first transaction identifier to the generated mobile terminal positioning request, and transmits the resultant request to the positioning information management server via the mobile communication server,
adds the generated second transaction identifier to the generated mobile communication terminal application service request, and transmits the resultant request to the application server via the mobile communication server, wherein the mobile communication server
transmits the received mobile terminal positioning request to the positioning information management server, and
transmits the received mobile communication terminal application service request to the application server, wherein the positioning information management server
stores into the storage device a transmitter activation identifier management table for managing a correlation among initial values of the transmitter fixed identifier and transmitter variable identifier of the positioning information transmitter and the large area position identifier and local position identifier of an installation point,
stores into the storage device a transmitter identifier management table for managing a correlation among a concealed variable identifier generated by performing the predetermined transmitter variable identifier concealing process and the large area position identifier and local position identifier of an installation point,
stores into the storage device a position identifier management table for managing a correlation among the large area position identifier and local position identifier of an installation point and the position information of the installation point,
extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table,
converts the converted large area position identifier and local position identifier of an installation point into position information, with the two position identifiers as a key and with reference to the position identifier management table, and
transmits the converted position information to the application server as a positioning server positioning response via a network, and wherein the application server
receives the transmitted mobile communication terminal application service request and extracts the first transaction identifier from the received mobile communication terminal application service request,
receives the transmitted positioning server positioning response and extracts the second transaction identifier from the received positioning server positioning response and
determines whether or not the extracted first and second transaction identifiers are identical, and if these are identical, then the application server performs an application server processing, with position information included in the positioning server positioning response and generation information of a client side program included in the mobile communication terminal application service request as inputs, and transmits the executed result information to the mobile communication terminal via the mobile communication server as an application server application service response.

8. A position information system for managing position information in an area having a predetermined extent where installation points for a plurality of positioning information transmitters are set, the position information system comprising:
the positioning information transmitter being installed at the each set installation point and transmitting a specific positioning identifier;
a mobile communication terminal provided with a positioning function including a positioning identifier receiving unit configured to receive the transmitted positioning identifier, a program execution unit configured to execute a client program of a position information application, and a wireless communication unit for mobile communications;
a mobile communication server including a wireless communication unit for mobile communication with the mobile communication terminal, and a network communication unit configured to communicate with the network;
an application server including a network communication unit configured to communicate with the network and a program execution unit configured to execute a server program of a position information application; and
a positioning information management server including a network communication unit configured to communicate with the network for receiving the transmitted positioning identifier via the mobile communication terminal provided with a positioning function and the mobile communication server, and a positioning information transmitter identifier decoding unit configured to convert the received positioning identifier into position information representing the predetermined installation point, wherein the positioning information management server
assigns to the predetermined area a large area position identifier specific thereto,
assigns to the predetermined installation point a local position identifier specific thereto,
assigns to the positioning information transmitter a transmitter fixed identifier specific thereto,
assigns to the positioning information transmitter a transmitter variable identifier which is specific to the transmitter and is a variable value, and
stores the assigned large area identifier, local position identifier, transmitter identifier, and transmitter variable identifier into a storage device, wherein the positioning information transmitter
stores its own transmitter fixed identifier, its own transmitter variable identifier, and a large area position identifier assigned to an area in which an installation point of the transmitter itself is located, into a storage unit,
performs a predetermined transmitter variable identifier concealing process to conceal the transmitter variable identifier stored therein, and generates the positioning identifier comprising the concealed variable identifier and the large area position identifier and transmits the same to the mobile communication terminal provided with a positioning function, wherein the mobile communication terminal provided with a positioning function
receives the transmitted positioning identifier and generates a mobile terminal positioning request to request the positioning information management server to convert the received positioning identifier into position information,
executes a client program of the stored position information application, and generates a mobile communication terminal application service request which is a request to a server program within the positioning information management server,
adds an address of the positioning information management server to the generated mobile terminal positioning request as destination information, adds an address of the application server to the mobile communication terminal application service request as destination information, and combines these two requests and transmits the same to the mobile communication server as a single mobile communication integrated-request, wherein the mobile communication server
receives the transmitted single mobile communication integrated-request and analyzes the received integration request, and
as a result of the analysis, splits the received integration request into a mobile terminal positioning request and a mobile communication terminal application service request,
generate two transaction identifiers having an equal value indicating that the split two requests were generated in the executed client program of a single position information application,
adds the first transaction identifier and an address of the positioning information management server which is destination information, to the mobile terminal positioning request which is one of the split results, and transmits the resultant request to the positioning information management server, and
adds the second transaction identifier and an address of the application server which is destination information, to the mobile communication terminal application service request which is the other one of the split results, and transmits the resultant request to the application server, wherein the positioning information management server
stores into the storage device a transmitter activation identifier management table for managing a correlation among initial values of the transmitter fixed identifier and transmitter variable identifier of the positioning information transmitter and the large area position identifier and local position identifier of an installation point,
stores into the storage device a transmitter identifier management table for managing a correlation among a concealed variable identifier generated by performing the predetermined transmitter variable identifier concealing process and the large area position identifier and local position identifier of an installation point,
stores into the storage device a position identifier management table for managing a correlation among the large area position identifier and local position identifier of an installation point and the position information of the installation point,
extracts a concealed variable identifier from the positioning identifier received from the positioning information transmitter, and converts the received positioning identifier into the large area position identifier and the local position identifier of an installation point, with the extracted identifier as a key and with reference to the transmitter identifier management table,
converts the converted large area position identifier and local position identifier of an installation point into position information, with the two position identifiers as a key and with reference to the position identifier management table, and
transmits the converted position information to the application server as a positioning server positioning response via the network, wherein the application server
receives the transmitted mobile communication terminal application service request and extracts the first transaction identifier from the received mobile communication terminal application service request,
receives the transmitted positioning server positioning response and extracts the second transaction identifier from the received positioning server positioning response, and
determines whether or not the extracted first and second transaction identifiers are identical, and if these are identical, then the application server performs an application server processing, with position information included in the positioning server positioning response and generation information of a client side program included in the mobile communication terminal application service request as inputs, and transmits the executed result information to the mobile communication terminal via the mobile communication server as an application server application service response.

9. The position information system according to claim 7, wherein the positioning information management server, wherein
for each of the positioning information transmitters installed at the predetermined points, a charge information record of a set of information group consisting of a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created and a charge information management table for storing the record is retained in the storage device,
performs a positioning charge process comprising the steps of:
every time the mobile terminal positioning request is received and converted and decoded into position information, searching the charge information management table, with the large area position identifier extracted through the conversion and decoding, the transmitter fixed identification number, the mobile communication company identification number, and the service company identification number as a search key;
if there is a charge information record matching the search key, creating a charge information record wherein the number of times of positioning of the charge information record is incremented by one, and writing back the charge information record to the charge information management table;
if there is no charge information record matching the search key, newly creating the charge information record, and setting the number of times of positioning of the created charge information record to one and storing the created charge information record into the charge information management table;
reading each record of the charge information management table at a predetermined time interval;
for the each large area position identifier, summing a total of the number of times of positioning of the read record to calculate the number of times of positioning for each large area position, and applying a predetermined charge function to the calculated number of times of positioning and transmitting a positioning charge request for an area owner;
for the each mobile communication company identifier, summing a total of the number of times of positioning of the read record to calculate the number of times of positioning for each mobile communication company, and applying a predetermined charge function to the calculated number of times of positioning and transmitting a positioning charge request for a mobile communication company; and
for the each application service company identifier, summing a total of the number of times of positioning of the read record to calculate the number of times of positioning for each application service company, and applying a predetermined charge function to the calculated number of times of positioning, and transmitting a positioning charge request for a service company.

10. The position information system according to claim 7, wherein the predetermined transmitter variable information concealing process comprises the steps of:
calculating a third hash value by hashing a transmitter variable identifier stored by the positioning information transmitter, with a third hash function and further repeatedly hashing the calculated hash value with the third hash function and generating a third hash information sequence comprising a plurality of hash values obtained by this repetition;
extracting a top element of the third hash information sequence as a transmitter variable identifier, and hashing the extracted transmitter variable identifier with the first hash function and calculating the first hash value and further repeatedly hashing the calculated hash value with the first hash function and generating a first hash information sequence comprising a plurality of hash values obtained by this repetition;
calculating a second hash value by hashing each element of the first hash information sequence with a second hash function and generating a second hash information sequence comprising a plurality of the calculated hash values; and
treating the generated second hash information sequence as a concealed variable identifier, wherein the step of generating the positioning identifier comprises the steps of:
firstly extracting a top hash value from each element of the second hash information sequence;
combining the extracted hash value with a large area position identifier stored therein and generating the positioning identifier;
repeatedly transmitting the generated positioning identifier a predetermined first number of times at a predetermined first time interval;
extracting a next hash value of the second hash information sequence and repeatedly performing the steps of generating and transmitting the positioning identifier; and
if the step of transmitting the positioning identifier is repeated a predetermined second number of times, extracting a next element of the third hash information sequence and treating the next element as the transmitter variable identifier, and repeatedly performing the steps of generating and transmitting the positioning identifier, and wherein the positioning information management server
generates the third hash information sequence and downloads a part of element data of the generated third hash information sequence to the mobile communication terminal provided with a positioning function, as the transmitter variable identifier, wherein the mobile communication terminal provided with a positioning function
performs a positioning information transmitter identifier decoding process comprising the steps of:
based on the downloaded transmitter variable identifier, performing a predetermined transmitter variable identifier concealing process to generate a concealed variable identifier;
storing a transmitter identifier management table for managing a correlation among the generated concealed variable identifier and the large area position identifier and local position identifier of an installation point;
storing a position identifier management table for managing a correlation among the large area position identifier and local position identifier of an installation point and position information of the installation point;
extracting a concealed variable identifier from a positioning identifier received from the positioning information transmitter;
with regard to the extracted concealed variable identifier, with reference to the transmitter identifier management table and with the identifier as a key, converting the identifier into the large area position identifier and local position identifier of an installation point; and
with regard to the converted large area position identifier and local position identifier of an installation point, converting the two position identifiers into position information with the two position identifiers as a key and with reference to the position identifier management table.

11. The position information system according to claim 10, wherein the transmitter variable identifier decoding process, wherein
for each of the positioning information transmitters installed at the predetermined points, a charge information record of a set of information group consisting of a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created and a charge information management table for storing the charge information record is stored,
comprises the steps of:
performing a positioning charging representation process comprising the steps of:
every time the mobile terminal positioning request is received and converted and decoded into position information, searching the charge information management table with the large area position identifier, the transmitter fixed identification number, the mobile communication company identification number, and the service company identification number which are extracted through the conversion and decoding, as a search key;
if there is a charge information record matching the search key, then creating a charge information record wherein the number of times of positioning of the charge information record is incremented by one, and writing back the charge information record to the charge information management table;
if there is no charge information record matching the search key, then newly creating the charge information record, and setting the number of times of positioning of the created charge information record to one, and storing the created charge information record into the charge information management table; and
performing a positioning charge fee notification process of transmitting a content of the stored charge information management table to the positioning information management server at a predetermined time interval; wherein the positioning information management server includes a positioning charge process comprising the steps of:
summing a content of the charge information management table transmitted through the positioning charge fee notification process of the mobile communication terminal, and reading each record of the summed charge information management table at a predetermined time interval,
for the each large area position identifier, summing a total of the number of times of positioning of the read record, and calculating the number of times of positioning for each large area position, and applying a predetermined charge function to the calculated number of times of positioning, and transmitting a positioning charge request for an area owner;
for the each mobile communication company identifier, summing a total of the number of times of positioning of the read record, and calculating the number of times of positioning for each mobile communication company, and applying a predetermined charge function to the calculated number of times of positioning, and transmitting a positioning charge request for a mobile communication company; and
for the each application service company identifier, summing a total of the number of times of positioning of the read record to calculate the number of times of positioning for each application service company, and applying a predetermined charge function to the calculated number of times of positioning, and transmitting a positioning charge request for a service company.

12. The position information system according to claim 7, wherein in the predetermined transmitter variable information concealing process, the positioning information transmitter
stores a predetermined key encryption key,
repeats the steps of: encrypting the encryption key stored by the positioning information transmitter, with the stored key encryption key to calculate an encryption key; and encrypting the calculated encryption key with the key encryption key, thereby generating a first encryption key sequence comprising encryption keys obtained by this repetition; and
extracts a top element of the first encryption key sequence, combines a transmitter variable identifier, a large area position identifier, and a random number stored by the positioning information transmitter, and encrypts the combined information with the extracted encryption key to generate a concealed variable identifier, wherein the step of generating the positioning identifier comprises the steps of:
generating the positioning identifier by combining the generated concealed variable identifier with a large area position identifier stored by the positioning information transmitter;
repeatedly transmitting the generated positioning identifier a predetermined first number of times at a predetermined first time interval;
regenerating the random number and generating a concealed variable identifier again, and repeatedly performing the steps of generating and transmitting the positioning identifier,
if the step of transmitting the positioning identifier is repeated a predetermined second number of times, then extracting a next element of the second encryption key sequence and treating the next element as the transmitter variable identifier, and repeatedly performing the steps of generating and transmitting the positioning identifier, wherein
the positioning information management server generates the first encryption key sequence and downloads a part of element data of the generated encryption key sequence to the mobile communication terminal provided with a positioning function, as the encryption key, wherein
the mobile communication terminal provided with a positioning function performs a positioning information transmitter identifier decoding process comprising the steps of:
storing a transmitter activation identifier management table for managing a correlation among initial values of the transmitter fixed identifier and transmitter variable identifier of the positioning information transmitter and the large area position identifier and local position identifier of an installation point;
storing a position identifier management table for managing a correlation among the large area position identifier and local position identifier of an installation point and position information of the installation point;
extracting a concealed variable identifier from a positioning identifier received from the positioning information transmitter;
decoding the extracted concealed variable identifier with the downloaded encryption key to calculate a transmitter variable identifier;
with reference to the transmitter activation identifier management table and with the calculated transmitter variable identifier as a key, converting the identifier into the large area position identifier and local position identifier of an installation point; and
with regard to the converted large area position identifier and local position identifier of an installation point, with reference to the position identifier management table and with these two positioning identifiers as a key, converting these two positioning identifiers into position information.

13. The position information system according to claim 12, wherein the transmitter variable identifier decoding process, which the mobile communication terminal provided with a positioning function includes, wherein
for each of the positioning information transmitters installed at the predetermined points, a charge information record of a set of information group consisting of: a large area position identifier of the installation point, a transmitter fixed identification number of the installed positioning information transmitter, an identification number of a mobile communication company operating the mobile communication system, an identification number of a service company of the application, and a number of times of positioning, which is a number of times of the conversion of a positioning identifier transmitted by the positioning information transmitter into position information, is created and a charge information management table for storing the charge information record is stored,
comprises a positioning charging representation process comprising the steps of:
every time the mobile terminal positioning request is received and converted and decoded into position information, searching the charge information management table, with the large area position identifier, the transmitter fixed identification number, the mobile communication company identification number, and the service company identification number which are extracted through the conversion and decoding, as a search key;
if there is a charge information record matching the search key, then creating a charge information record wherein the number of times of positioning of the charge information record is incremented by one, and writing back the charge information record to the charge information management table; and
if there is no charge information record matching the search key, then newly creating the charge information record, and setting the number of times of positioning of the created charge information record to one, and storing the created charge information record into the charge information management table; and
furthermore comprises the step of performing a positioning charge fee notification process of transmitting a content of the stored charge information management table to the positioning information management server at a predetermined time interval; wherein the positioning information management server performs a positioning charge process comprising the steps of:
summing a content of the charge information management table transmitted through the positioning charge fee notification process of the mobile communication terminal, and reading each record of the summed charge information management table at a predetermined time interval,
for the each large area position identifier, summing a total of the number of times of positioning of the read record, and calculating the number of times of positioning for each large area position, and applying a predetermined charge function to the calculated number of times of positioning, and transmitting a positioning charge request for an area owner;
for the each mobile communication company identifier, summing a total of the number of times of positioning of the read record, and calculating the number of times of positioning for each mobile communication company, and applying a predetermined charge function to the calculated number of times of positioning, and transmitting a positioning charge request for a mobile communication company; and
for the each application service company identifier, summing a total of the number of times of positioning of the read record to calculate the number of times of positioning for each application service company, and applying a predetermined charge function to the calculated number of times of positioning, and transmitting a positioning charge request for a service company.

14. The position information system according to claim 1, wherein
the positioning information management server stores a specific positioning information transmitter owning company identifier assigned to a transmitter owning company which owns, and operates or manages the positioning information transmitter, wherein
the transmitter activation identifier management table includes the assigned positioning information transmitter owning company identifier as a new data element for each record which is stored with respect to the installed positioning information transmitter, wherein
the position identifier management table includes the assigned positioning information transmitter owning company identifier as a new data element for each record which is stored with respect to the large area position identifier and local position identifier of the installation position, and wherein
the positioning information transmitter includes the assigned positioning information transmitter owning company identifier as a new data element of the positioning identifier, wherein
the positioning information management server, based on the received positioning identifier, uses the positioning information transmitter owning company identifier as a search key in searching the transmitter activation identifier management table, or based on the received positioning identifier, uses the positioning information transmitter owning company identifier as a search key in searching the transmitter identifier management table.

15. The position information system according to claim 1, wherein the positioning information management server
stores, for the each mobile communication terminal, a mobile communication terminal identifier management table for storing a result of a transmitter identifier decoding process, which is performed in response to a mobile terminal positioning request transmitted by the mobile communication terminal, into the storage device,
stores a record comprising a mobile communication terminal identifier, a mobile communication company identifier, a large area position identifier, a local position identifier, the positioning request occurrence time, a transmitter fixed identifier, and position information into the mobile communication terminal identifier management table, and
every time the positioning information management server receives the mobile terminal positioning request and starts a transmitter identifier decoding process, with reference to the mobile communication terminal identifier management table, and with the identifier of a mobile communication terminal which transmitted the positioning request, as a search key, the positioning information management server obtains a decoding result of a mobile terminal positioning request, which the communication terminal issues immediately before, as a search result, and extracts a positioning request occurrence time of the immediately preceding positioning request, and position information, and
compares the positioning request occurrence time, which is a result of the decoding process of the received new positioning request, with the position information, and if a change in the position information, the change being equal to or greater than a predetermined distance, is detected with a predetermined time difference, then with regard to a positioning information transmitter which transmitted a concealed variable identifier included in the received new positioning request, the positioning information management server invalidates a record in the transmitter identifier management table in which the positioning information transmitter is registered.
